(19) United States
(12) Patent Application Publication
(10) Pub. No.: US 2026/0120326 A1
(43) Pub. Date: Apr. 30, 2026

(54) THREE-DIMENSIONAL RECONSTRUCTION (3DR) MESH COMPRESSION FOR EXTENDED REALITY (XR) SYSTEMS

(71) Applicant: QUALCOMM Incorporated, San Diego, CA (US)

(72) Inventors: Nikhil KRISHNAN, Bangalore (IN); Ankit ANAND, Jamalpur (IN); Vinay MELKOTE KRISHNAPRASAD, Bangalore (IN); Gerhard REITMAYR, Del Mar, CA (US); Sriram AJAYKUMAR, BANGALORE (IN)

(21) Appl. No.: 19/193,797

(22) Filed: Apr. 29, 2025

Related U.S. Application Data
(60) Provisional application No. 63/714,040, filed on Oct. 30, 2024.

(51) Int. Cl. G06T 9/00; G06T 17/20

(52) U.S. Cl. CPC G06T 9/001; G06T 17/20

(57) ABSTRACT

Systems and techniques are described herein for determining three-dimensional (3D) data. For instance, a method for determining three-dimensional (3D) data is provided. The method may include determining a difference mesh and a triangle map based on a comparison of a first mesh with a second mesh, wherein the difference mesh includes 3D points of the second mesh that are different from 3D points of the first mesh, and wherein the triangle map indicates triangles that are similar in the second mesh and in the first mesh; encoding the difference mesh using a first encoder to generate an encoded difference mesh; encoding the triangle map using a second encoder to generate an encoded triangle map; and transmitting, to a computing device, the encoded difference mesh and the encoded triangle map.

### CROSS-REFERENCE TO RELATED APPLICATIONS

This application claims the benefit of U.S. Provisional Application No. 63/714,040, filed Oct. 30, 2024, which is incorporated herein by reference in its entirety.

### TECHNICAL FIELD

The present disclosure generally relates to three-dimensional (3D) data. For example, aspects of the present disclosure include systems and techniques for processing (e.g., generating, compressing, encoding, decoding, decompressing, updating, reconstructing, and/or otherwise processing) 3D data.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment. For example, an XR head-mounted device (HMD) may include a display that allows a user to view the user's real-world environment through a display of the HMD (e.g., a transparent display). The XR HMD may display virtual content at the display in the user's field of view overlaying the user's view of their real-world environment. Such an implementation may be referred to as “see-through” XR. As another example, an XR HMD may include a scene-facing camera that may capture images of the user's real-world environment. The XR HMD may modify or augment the images (e.g., adding virtual content) and display the modified images to the user. Such an implementation may be referred to as “pass through” XR or as “video see through (VST).” The user can generally change their view of the environment interactively, for example by tilting or moving the XR HMD.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for determining three-dimensional (3D) data. According to at least one example, a method is provided for determining three-dimensional (3D) data. The method includes: determining a difference mesh and a triangle map based on a comparison of a first mesh with a second mesh, wherein the difference mesh includes 3D points of the second mesh that are different from 3D points of the first mesh, and wherein the triangle map indicates triangles that are similar in the second mesh and in the first mesh; encoding the difference mesh using a first encoder to generate an encoded difference mesh; encoding the triangle map using a second encoder to generate an encoded triangle map; and transmitting, to a computing device, the encoded difference mesh and the encoded triangle map.

In another example, an apparatus for determining three-dimensional (3D) data is provided that includes at least one memory and at least one processor (e.g., configured in circuitry) coupled to the at least one memory. The at least one processor configured to: determine a difference mesh and a triangle map based on a comparison of a first mesh with a second mesh, wherein the difference mesh includes 3D points of the second mesh that are different from 3D points of the first mesh, and wherein the triangle map indicates triangles that are similar in the second mesh and in the first mesh; encode the difference mesh using a first encoder to generate an encoded difference mesh; encode the triangle map using a second encoder to generate an encoded triangle map; and cause at least one transmitter to transmit, to a computing device, the encoded difference mesh and the encoded triangle map.

In another example, a non-transitory computer-readable medium is provided that has stored thereon instructions that, when executed by one or more processors, cause the one or more processors to: determine a difference mesh and a triangle map based on a comparison of a first mesh with a second mesh, wherein the difference mesh includes 3D points of the second mesh that are different from 3D points of the first mesh, and wherein the triangle map indicates triangles that are similar in the second mesh and in the first mesh; encode the difference mesh using a first encoder to generate an encoded difference mesh; encode the triangle map using a second encoder to generate an encoded triangle map; and cause at least one transmitter to transmit, to a computing device, the encoded difference mesh and the encoded triangle map.

In another example, an apparatus for determining three-dimensional (3D) data is provided. The apparatus includes: means for determining a difference mesh and a triangle map based on a comparison of a first mesh with a second mesh, wherein the difference mesh includes 3D points of the second mesh that are different from 3D points of the first mesh, and wherein the triangle map indicates triangles that are similar in the second mesh and in the first mesh; means for encoding the difference mesh using a first encoder to generate an encoded difference mesh; means for encoding the triangle map using a second encoder to generate an encoded triangle map; and means for transmitting, to a computing device, the encoded difference mesh and the encoded triangle map.

In another example, a method is provided for determining three-dimensional (3D) data. The method includes: decoding an encoded difference mesh to generate a difference mesh; decoding an encoded triangle map to generate a triangle map; and generating a reconstructed mesh based on a first mesh, the difference mesh, and the triangle map.

In another example, an apparatus for determining three-dimensional (3D) data is provided that includes at least one memory and at least one processor (e.g., configured in circuitry) coupled to the at least one memory. The at least one processor configured to: decode an encoded difference mesh to generate a difference mesh; decode an encoded triangle map to generate a triangle map; and generate a reconstructed mesh based on a first mesh, the difference mesh, and the triangle map.

In another example, a non-transitory computer-readable medium is provided that has stored thereon instructions that, when executed by one or more processors, cause the one or more processors to: decode an encoded difference mesh to generate a difference mesh; decode an encoded triangle map to generate a triangle map; and generate a reconstructed mesh based on a first mesh, the difference mesh, and the triangle map.

In another example, an apparatus for determining three-dimensional (3D) data is provided. The apparatus includes: means for decoding an encoded difference mesh to generate a difference mesh; means for decoding an encoded triangle map to generate a triangle map; and means for generating a reconstructed mesh based on a first mesh, the difference mesh, and the triangle map.

In another example, a method is provided for determining three-dimensional (3D) data. The method includes: determining different 3D points and a 3D-point map based on a comparison of 3D points of a first mesh with 3D points of a second mesh, wherein the different 3D points are different in the second mesh than in the first mesh and wherein the 3D-point map indicates 3D points that are similar in the second mesh and in the first mesh; determining different triangles and a triangle map based on a comparison of triangles of the second mesh with triangles of the first mesh, wherein the different triangles are different in the second mesh than in the first mesh and wherein the triangle map indicates triangles that are similar in the second mesh and in the first mesh; encoding the different 3D points to generate an encoded different 3D points; encoding the 3D-point map using second encoder to generate an encoded 3D-point map; encoding the different triangles to generate an encoded different triangles; encoding the triangle map using second encoder to generate an encoded triangle map; and transmitting, to a computing device, the encoded different 3D points, the encoded 3D-point map, the encoded different triangles, and the encoded triangle map.

In another example, an apparatus for determining three-dimensional (3D) data is provided that includes at least one memory and at least one processor (e.g., configured in circuitry) coupled to the at least one memory. The at least one processor configured to: determine different 3D points and a 3D-point map based on a comparison of 3D points of a first mesh with 3D points of a second mesh, wherein the different 3D points are different in the second mesh than in the first mesh and wherein the 3D-point map indicates 3D points that are similar in the second mesh and in the first mesh; determine different triangles and a triangle map based on a comparison of triangles of the second mesh with triangles of the first mesh, wherein the different triangles are different in the second mesh than in the first mesh and wherein the triangle map indicates triangles that are similar in the second mesh and in the first mesh; encode the different 3D points to generate an encoded different 3D points; encode the 3D-point map using second encoder to generate an encoded 3D-point map; encode the different triangles to generate an encoded different triangles; encode the triangle map using second encoder to generate an encoded triangle map; and cause at least one transmitter to transmit, to a computing device, the encoded different 3D points, the encoded 3D-point map, the encoded different triangles, and the encoded triangle map.

In another example, a non-transitory computer-readable medium is provided that has stored thereon instructions that, when executed by one or more processors, cause the one or more processors to: determine different 3D points and a 3D-point map based on a comparison of 3D points of a first mesh with 3D points of a second mesh, wherein the different 3D points are different in the second mesh than in the first mesh and wherein the 3D-point map indicates 3D points that are similar in the second mesh and in the first mesh; determine different triangles and a triangle map based on a comparison of triangles of the second mesh with triangles of the first mesh, wherein the different triangles are different in the second mesh than in the first mesh and wherein the triangle map indicates triangles that are similar in the second mesh and in the first mesh; encode the different 3D points to generate an encoded different 3D points; encode the 3D-point map using second encoder to generate an encoded 3D-point map; encode the different triangles to generate an encoded different triangles; encode the triangle map using second encoder to generate an encoded triangle map; and cause at least one transmitter to transmit, to a computing device, the encoded different 3D points, the encoded 3D-point map, the encoded different triangles, and the encoded triangle map.

In another example, an apparatus for determining three-dimensional (3D) data is provided. The apparatus includes: means for determining different 3D points and a 3D-point map based on a comparison of 3D points of a first mesh with 3D points of a second mesh, wherein the different 3D points are different in the second mesh than in the first mesh and wherein the 3D-point map indicates 3D points that are similar in the second mesh and in the first mesh; means for determining different triangles and a triangle map based on a comparison of triangles of the second mesh with triangles of the first mesh, wherein the different triangles are different in the second mesh than in the first mesh and wherein the triangle map indicates triangles that are similar in the second mesh and in the first mesh; means for encoding the different 3D points to generate an encoded different 3D points; means for encoding the 3D-point map using second encoder to generate an encoded 3D-point map; means for encoding the different triangles to generate an encoded different triangles; means for encoding the triangle map using second encoder to generate an encoded triangle map; and means for transmitting, to a computing device, the encoded different 3D points, the encoded 3D-point map, the encoded different triangles, and the encoded triangle map.

In another example, a method is provided for determining three-dimensional (3D) data. The method includes: decoding encoded different 3D points to generate different 3D points; decoding an encoded 3D-point map to generate a 3D-point map; decoding encoded different triangles to generate different triangles; decoding an encoded triangle map to generate a triangle map; and generating a reconstructed mesh based on a first mesh, the different 3D points, the 3D-point map, the different triangles, and the triangle map.

In another example, an apparatus for determining three-dimensional (3D) data is provided that includes at least one memory and at least one processor (e.g., configured in circuitry) coupled to the at least one memory. The at least one processor configured to: decode encoded different 3D points to generate different 3D points; decode an encoded 3D-point map to generate a 3D-point map; decode encoded different triangles to generate different triangles; decode an encoded triangle map to generate a triangle map; and generate a reconstructed mesh based on a first mesh, the different 3D points, the 3D-point map, the different triangles, and the triangle map.

In another example, a non-transitory computer-readable medium is provided that has stored thereon instructions that, when executed by one or more processors, cause the one or more processors to: decode encoded different 3D points to generate different 3D points; decode an encoded 3D-point map to generate a 3D-point map; decode encoded different triangles to generate different triangles; decode an encoded triangle map to generate a triangle map; and generate a reconstructed mesh based on a first mesh, the different 3D points, the 3D-point map, the different triangles, and the triangle map.

In another example, an apparatus for determining three-dimensional (3D) data is provided. The apparatus includes: means for decoding encoded different 3D points to generate different 3D points; means for decoding an encoded 3D-point map to generate a 3D-point map; means for decoding encoded different triangles to generate different triangles; means for decoding an encoded triangle map to generate a triangle map; and means for generating a reconstructed mesh based on a first mesh, the different 3D points, the 3D-point map, the different triangles, and the triangle map.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a diagram illustrating another example extended reality (XR) system, according to aspects of the disclosure;

FIG. 3 is a block diagram illustrating an architecture of an example extended reality (XR) system, in accordance with some aspects of the disclosure;

FIG. 4 is a diagram illustrating an example of a scene that has been modeled as a 3D sparse volumetric representation for 3DR;

FIG. 5 is a diagram illustrating an example of a hash map lookup type of volume block representation;

FIG. 6 is a diagram illustrating an example of a volume block (e.g., a voxel block);

FIG. 7 is a diagram illustrating an example of a truncated sign distance function (TSDF) volume reconstruction;

FIG. 8 is a diagram of an example voxel block selection algorithm for 3DR of a scene;

FIG. 9 is a block diagram illustrating an example system for extended reality, according to various aspects of the present disclosure;

FIG. 10 is a block diagram illustrating an example system for processing, compressing, encoding, and/or transmitting 3D data, according to various aspects of the present disclosure;

FIG. 11 is a block diagram illustrating an example system for decompressing, decoding, processing, and/or reconstructing 3D data, according to various aspects of the present disclosure;

FIG. 12 is a block diagram illustrating another example system for processing, compressing, encoding, and/or transmitting 3D data, according to various aspects of the present disclosure;

FIG. 13 is a block diagram illustrating another example system for decompressing, decoding, processing, and/or reconstructing 3D data, according to various aspects of the present disclosure;

FIG. 14 is a block diagram illustrating another example system for processing, compressing, encoding, and/or transmitting 3D data, according to various aspects of the present disclosure;

FIG. 15 is a block diagram illustrating another example system for decompressing, decoding, processing, and/or reconstructing 3D data, according to various aspects of the present disclosure;

FIG. 16A is a hybrid system-flowchart diagram illustrating algorithms and operations that may be performed to generate a difference mesh and metadata, according to various aspects of the present disclosure;

FIG. 16B is a diagram illustrating a triangle to provide context for a description of example operations of the system of FIG. 16A;

FIG. 16C is a hybrid system-flowchart diagram illustrating algorithms and operations that may be performed to generate a difference mesh and metadata, according to various aspects of the present disclosure;

FIG. 16D is a diagram illustrating a triangle to provide context for a description of example operations of the system of FIG. 16C;

FIG. 17 is a diagram illustrating a step in an example process of generating a difference mesh and metadata, according to various aspects of the present disclosure;

FIG. 18 is a diagram illustrating another step in the example process of generating a difference mesh and metadata, according to various aspects of the present disclosure;

FIG. 19 is a diagram illustrating yet another step in the example process of generating a difference mesh and metadata, according to various aspects of the present disclosure;

FIG. 20 is a diagram illustrating yet another step in the example process of generating a difference mesh and metadata, according to various aspects of the present disclosure;

FIG. 21 is a diagram illustrating yet another step in the example process of generating a difference mesh and metadata, according to various aspects of the present disclosure;

FIG. 22 is a diagram illustrating yet another step in the example process of generating a difference mesh and metadata, according to various aspects of the present disclosure;

FIG. 23 is a diagram illustrating yet another step in the example process of generating a difference mesh and metadata, according to various aspects of the present disclosure;

FIG. 24 is a diagram illustrating yet another step in the example process of generating a difference mesh and metadata, according to various aspects of the present disclosure;

FIG. 25 is a diagram illustrating yet another step in the example process of generating a difference mesh and metadata, according to various aspects of the present disclosure;

FIG. 26 is a diagram illustrating yet another step in the example process of generating a difference mesh and metadata, according to various aspects of the present disclosure;

FIG. 27 is a diagram illustrating yet another step in the example process of generating a difference mesh and metadata, according to various aspects of the present disclosure;

FIG. 28 is a diagram illustrating yet another step in the example process of generating a difference mesh and metadata, according to various aspects of the present disclosure;

FIG. 29 is a diagram illustrating yet another step in the example process of generating a difference mesh and metadata, according to various aspects of the present disclosure;

FIG. 30 is a diagram illustrating yet another step in the example process of generating a difference mesh and metadata, according to various aspects of the present disclosure;

FIG. 31 is a diagram illustrating a step in an example process of reconstructing a mesh based on a previous mesh, a difference mesh, and metadata, according to various aspects of the present disclosure;

FIG. 32 is a diagram illustrating another step in an example process of reconstructing a mesh based on a previous mesh, a difference mesh, and metadata, according to various aspects of the present disclosure;

FIG. 33 is a diagram illustrating yet another step in an example process of reconstructing a mesh based on a previous mesh, a difference mesh, and metadata, according to various aspects of the present disclosure;

FIG. 34 is a diagram illustrating yet another step in an example process of reconstructing a mesh based on a previous mesh, a difference mesh, and metadata, according to various aspects of the present disclosure;

FIG. 35 is a diagram illustrating yet another step in an example process of reconstructing a mesh based on a previous mesh, a difference mesh, and metadata, according to various aspects of the present disclosure;

FIG. 36 is a diagram illustrating yet another step in an example process of reconstructing a mesh based on a previous mesh, a difference mesh, and metadata, according to various aspects of the present disclosure;

FIG. 37 is a block diagram illustrating another example system for processing, compressing, encoding, and/or transmitting 3D data, according to various aspects of the present disclosure;

FIG. 38 is a block diagram illustrating another example system for decompressing, decoding, processing, and/or reconstructing 3D data, according to various aspects of the present disclosure;

FIG. 39 is a diagram of a 3DR space subdivided into blocks;

FIG. 40 is a diagram of an example system for preprocessing 3D data, according to various aspects of the present disclosure;

FIG. 41 is a block diagram illustrating another example system for processing, compressing, encoding, and/or transmitting 3D data, according to various aspects of the present disclosure;

FIG. 42 is a flow diagram illustrating an example process for processing, compressing, encoding, and/or transmitting, in accordance with aspects of the present disclosure;

FIG. 43 is a flow diagram illustrating an example process for decompressing, decoding, processing, and/or reconstructing, in accordance with aspects of the present disclosure;

FIG. 44 is a flow diagram illustrating an example process for processing, compressing, encoding, and/or transmitting, in accordance with aspects of the present disclosure;

FIG. 45 is a flow diagram illustrating an example process for decompressing, decoding, processing, and/or reconstructing, in accordance with aspects of the present disclosure;

FIG. 46 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

A system may generate a three-dimensional (3D) map of an environment of the system based on images of the environment. For example, volume blocks (e.g., “voxels” or “voxel blocks”) can be utilized to reconstruct a 3D scene from two-dimensional (2D) images, such as stereoscopically paired images obtained from a stereoscopic pair of cameras. A voxel block represents a value on a regular grid in 3D space. As with pixels in a 2D bitmap, voxel blocks do not have their position (e.g., coordinates) explicitly encoded within their values. Instead, rendering systems infer the position of a voxel block based upon its position relative to other voxel blocks (e.g., its position in the data structure that makes up a single volumetric image).

In some examples, a system can perform 3D reconstruction (3DR) using depth frames and an associated live camera pose estimate for 3D scene reconstruction. In some cases, when performing 3D surface reconstruction, the system can model the scene as a 3D sparse volumetric representation (e.g., referred to as a volume grid). The volume grid can contain a set of voxel blocks, which are each indexed by their position in space with a sparse data representation (e.g., only storing blocks that surround an object and/or obstacle). In some cases, the scene can be divided into a dense volumetric representation (as opposed to a sparse volumetric representation).

In one illustrative example, a system can perform 3DR to reconstruct a 3D scene from 2D depth frames and color frames. The system can divide the scene into 3D blocks (e.g., voxel blocks or volume blocks, as noted previously). For example, the system may project each voxel block onto a 2D depth frame and a 2D image to determine the depth and/or color of the voxel block. Once all of the voxel blocks that refer to (e.g., are associated with) this depth frame and color frame are updated accordingly, the process can repeat for a new depth frame and color frame pair or set. In some cases, color integration may not be needed. For instance, some 3DR systems may operate on depth and not color. The systems and techniques described herein can apply to depth only 3DR systems and to 3DR systems that operate on depth and color. In the present disclosure, the term “3DR,” “3D reconstruction understanding,” and “3DRU,” may refer to 3D reconstruction algorithms, techniques, systems, modules, etc.

As previously mentioned, in 3DR, 3D scenes are represented using a 3D volume of points called voxel blocks, where each voxel block typically carries implicit surface information, such as in the form of a truncated Signed Distance Function (TSDF) value and a weight for depth integration. The TSDF value is a measure of distance of the voxel block from a surface, and the weight is a measure of the reliability of the TSDF value. A TSDF weight can be estimated using various approaches, such as a simple counter (e.g., a binary weight of “1” or “0”), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to “1.”

A 3DR system may use a sequence of depth maps of a scene with their corresponding six (6) degrees of freedom (DoF) poses as an input. The depth maps can be generated using deep learning (DL) algorithms, non-DL algorithms, and/or other depth estimation methods. A 3D space of the scene can be uniformly sampled along the X, Y, and Z directions. The 3D space can be divided into fixed size volumes (e.g., block volumes with a fixed number of samples).

A 3DR system may include three stages, including block selection, depth integration, and surface extraction. During block selection, blocks that have surfaces or are located close to a surface can be selected. These blocks can then be allocated into memory. In depth integration (also referred to as block integration), all voxel blocks within a block volume can be iterated over and an updated TSDF value weight can be calculated. In surface extraction, marching cubes can be used to determine triangular surfaces in the blocks.

In block selection, depth pixels can be iterated over to unproject them to a 3D space and determine where they lie within the 3D space using intrinsic and extrinsic camera parameters. Typically, a hash map is employed for block selection. A hash map is an unordered map that includes a listing of blocks (e.g., including block indices of the blocks) that have a surface. The hash map can include a corresponding counter for each of the blocks that maintains a count of the number of times depth pixels lie within the particular block. A threshold (e.g., threshold value or number) can be used to select all the blocks that have depth pixels lie within them for more than the threshold number of times. The selected blocks can then be integrated. The cache size (e.g., size of the hardware for the cache memory, which can be used to store the hash map) can depend upon the depth range, sample distances, block size, etc.

Systems, apparatuses, methods (also referred to as processes), and computer-readable media (collectively referred to herein as “systems and techniques”) are described herein for generating, processing, compressing, encoding, decoding, decompressing, updating, and/or reconstructing, 3D data (e.g., 3D mesh data). For example, the systems and techniques described herein may efficiently encode and compress 3DR-mesh data for split-rendering by exploiting temporal correlation.

In some aspects, the systems and techniques may determine and use a difference mesh data from a 3DRU module to reduce bandwidth in mesh transmission.

In other aspects, the systems and techniques may use a mesh-difference framework to reduce bandwidth in mesh transmission. The systems and techniques may take advantage of the limited update in 3DR mesh at limited frames rates.

For example, the systems and techniques may create a difference mesh by matching triangles from incoming latest mesh with triangles from previous reconstructed mesh at encoder. Further the systems and techniques may use a mesh-compression encoder and/or a mesh-compression decoder for better compression factor and speed. In the present disclosure, meshes are described as including triangles as an example. The systems and techniques may operate on meshes including any suitable polygon (e.g., triangles, quadrilaterals, pentagons, etc.). Thus, all references to “triangles” may be refer to any polygon.

The systems and techniques may create a mapping of triangles (e.g., a binary mapping) to be retained from the previous reconstructed mesh at encoder. The systems and techniques may use lossless encoding for the binary mapping of triangles for low overhead transmission.

The difference mesh and the binary mapping along with the previous reconstructed mesh are used to reconstruct the incoming mesh at the decoder. The difference mesh is used as the base and triangles from the previous reconstructed mesh based on binary mapping are appended to reconstruct the full mesh. Additionally, a copy of the decoder is present at client side to ensure reconstruction at server and client are in sync.

Additionally or alternatively, the systems and techniques may use block-level processing to accelerate difference-mesh compression when 3DR block-level metadata is available.

In some aspects, the systems and techniques may use independent 3D coordinate differencing and triangle differencing for achieving lower bit rate for mesh transmission. The independent 3D coordinate differencing and triangle differencing may result in data that can be compressed using a mesh-compression algorithm, transmitted at an acceptable bit rate, and reconstructed at a receiver.

Additionally or alternatively, the systems and techniques may use mesh-preprocessing to remove isolated 3D points, degenerate triangles, duplicate 3D points, and/or duplicate triangles.

The systems and techniques may use adaptive processing to achieve a target distortion metric with lowest bit rate.

Various aspects of the application will be described with respect to the figures below.

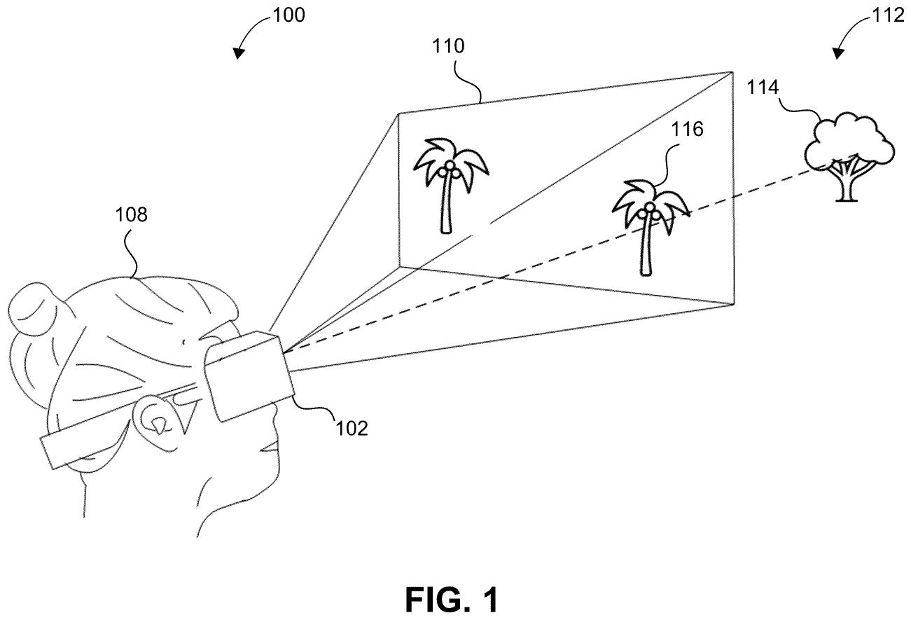

FIG. 1 is a diagram illustrating an example extended-reality (XR) system 100, according to aspects of the disclosure. As shown, XR system 100 includes an XR device 102. XR device 102 may implement, as examples, image-capture, object-detection, object-tracking, gaze-tracking, view-tracking, localization (e.g., determining a location of XR device 102), pose-tracking (e.g., tracking a pose of XR device 102 and/or a pose of one or more objects in scene 112), content-generation, content-rendering, computational, communicational, and/or display aspects of extended reality, including virtual reality (VR), augmented reality (AR), and/or mixed reality (MR).

For example, XR device 102 may include one or more scene-facing cameras that may capture images of a scene 112 in which a user 108 uses XR device 102. XR device 102 may detect and/or track objects (e.g., object 114) in scene 112 based on the images of scene 112. In some aspects, XR device 102 may include one or more user-facing cameras that may capture images of eyes of user 108. XR device 102 may determine a gaze of user 108 based on the images of user 108. In some aspects, XR device 102 may determine an object of interest (e.g., object 114) in scene 112 (e.g., based on the gaze of user 108, based on object recognition, and/or based on a received indication regarding object 114). XR device 102 may obtain and/or render XR content 116 (e.g., text, images, and/or video) for display at XR device 102. XR device 102 may display XR content 116 to user 108 (e.g., within a field of view 110 of user 108). In some aspects, XR content 116 may be based on the object of interest. For example, XR content 116 may be an altered version of object 114. In some aspects, XR device 102 may display XR content 116 in relation to the view of user 108 of the object of interest. For example, XR device 102 may overlay XR content 116 onto object 114 in field of view 110. In any case, XR device 102 may overlay XR content 116 (whether related to object 114 or not) onto the view of user 108 of scene 112.

In a “see-through” or “transparent” configuration, XR device 102 may include a transparent surface (e.g., optical glass) such that XR content 116 may be displayed on (e.g., by being projected onto) the transparent surface to overlay the view of user 108 of scene 112 as viewed through the transparent surface. In a “pass-through” configuration or a “video see-through” configuration, XR device 102 may include a scene-facing camera that may capture images of scene 112. XR device 102 may display images or video of scene 112, as captured by the scene-facing camera, and XR content 116 overlaid on the images or video of scene 112.

In various examples, XR device 102 may be, or may include, a head-mounted device (HMD), a virtual reality headset, and/or smart glasses. XR device 102 may include one or more cameras, including scene-facing cameras and/or user-facing cameras, a CPU, a GPU, an NPU or other hardware accelerators, one or more sensors (e.g., such as one or more inertial measurement units (IMUs), image sensors, and/or microphones), one or more communication units (e.g., wireless communication units), and/or one or more output devices (e.g., such as speakers, headphones, display, and/or smart glass).

In some aspects, XR device 102 may be, or may include, two or more devices. For example, XR device 102 may include a display device and a processing device. The display device may capture and/or generate data, such as image data (e.g., from user-facing cameras and/or scene-facing cameras) and/or motion data (from an inertial measurement unit (IMU)). The display device may provide the data to the processing device, for example, through a wireless connection between the display device and the processing device. The processing device may process the data and/or other data (e.g., data received from another source). Further, the processing unit may generate (or obtain) XR content 116 to be displayed at the display device. The processing device may provide the generated XR content 116 to the display device, for example, through the wireless connection. And the display device may display XR content 116 in field of view 110 of user 108.

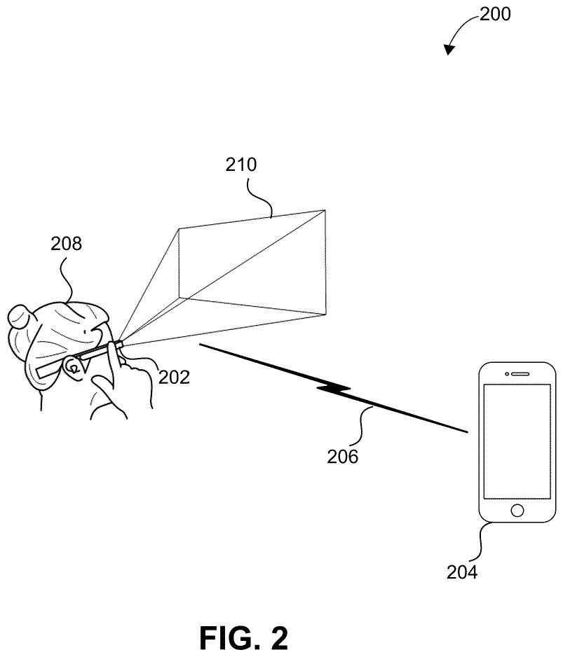

FIG. 2 is a diagram illustrating an example extended reality (XR) system 200, according to aspects of the disclosure. As shown, XR system 200 includes an XR device 202, a companion device 204, and a communication link 206 between XR device 202 and companion device 204. XR device 202 may implement, as examples, image-capture, view-tracking, and/or display aspects of extended reality, including virtual reality (VR), augmented reality (AR), and/or mixed reality (MR). For example, XR device 202 may include one or more scene-facing cameras that may capture images of a scene in which a user 208 uses XR device 202. Further, XR device 202 may include one or more user-facing cameras that may capture images of eyes of user 208. XR device 202 may provide the images of the scene and/or the images of user 208 to companion device 204 (e.g., via communication link 206). Additionally, XR device 202 may include one or more inertial measurement units (IMUs) that may measure inertial data. XR device 202 may provide the inertial data to companion device 204.

Companion device 204 may implement computing aspects of extended reality, including, as examples, object detection, gaze tracking, localization, mapping, information gathering and/or information generation. For example, companion device 204 may receive images of the scene and/or of the eyes of user 208. Companion device 204 may detect objects in the scene based on received images of the scene. Further, companion device 204 may determine the gaze of user 208 based on received images of user 208 (e.g., of eyes of user 208). In some aspects, companion device 204 may obtain inertial data and determine a location and/or pose of XR device 202 based on the inertial data. Additionally or alternatively, companion device 204 may determine a location and/or pose of XR device 202 based on images captured by scene-facing cameras of XR device 202 (e.g., using simultaneous localization and mapping (SLAM) techniques). Companion device 204 may obtain and/or render information (e.g., text, images, and/or video based on the object of interest). Companion device 204 may provide the information to XR device 202 (e.g., via communication link 206). XR device 202 may display the information to a user 208 (e.g., within a field of view 210 of user 208).

XR device 202 may display the information to be viewed by a user 208 in field of view 210 of user 208. For example, in a “see-through” configuration, XR device 202 may include a transparent surface (e.g., optical glass) such that information may be displayed on (e.g., by being projected onto) the transparent surface to overlay the information onto the scene as viewed through the transparent surface. In a “pass-through” configuration or a “video see-through” (VST) configuration, XR device 202 may include a scene-facing camera that may capture images of the scene of user 208. XR device 202 may display images or video of the scene, as captured by the scene-facing camera, and information overlaid on the images or video of the scene.

In various examples, XR device 202 may be, or may include, a head-mounted display (HMD), a virtual reality headset, and/or smart glasses. XR device 202 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, display, and/or smart glass). Companion device 204 may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof. Communication link 206 may be a wireless connection according to any suitable wireless protocol, such as, for example, Institute of Electrical and Electronics Engineers (IEEE) 802.11 (Wi-Fi), IEEE 802.15, or Bluetooth®. In some cases, communication link 206 may be a direct wireless connection between XR device 202 and companion device 204. In other cases, communication link 206 may be through one or more intermediary devices, such as, for example, routers or switches and/or across a network.

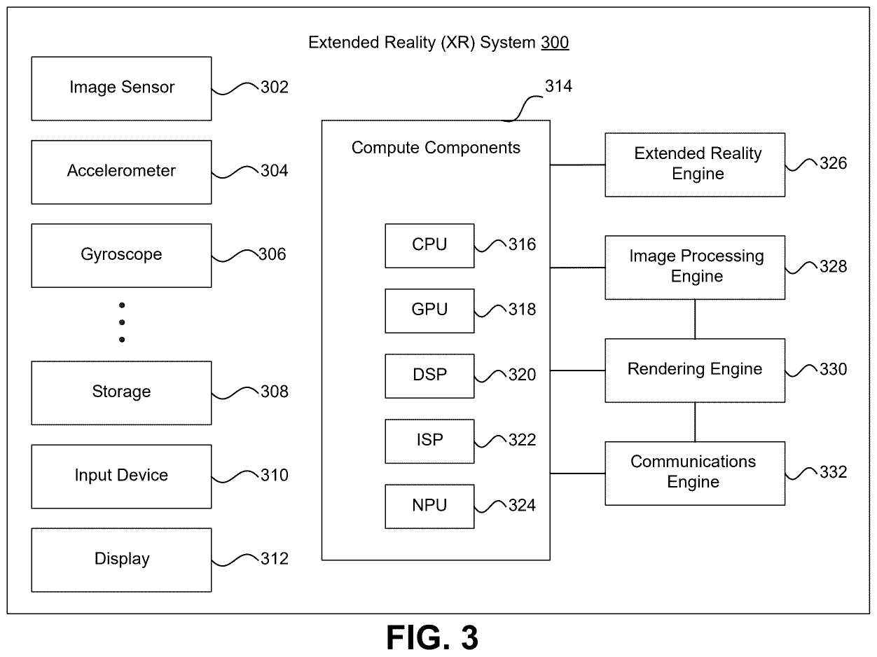

FIG. 3 is a diagram illustrating an architecture of an example extended reality (XR) system 300, in accordance with some aspects of the disclosure. XR system 300 may execute XR applications and implement XR operations.

In this illustrative example, XR system 300 includes one or more image sensors 302, an accelerometer 304, a gyroscope 306, storage 308, an input device 310, a display 312, Compute components 314, an XR engine 326, an image processing engine 328, a rendering engine 330, and a communications engine 332. It should be noted that the components 302-332 shown in FIG. 3 are non-limiting examples provided for illustrative and explanation purposes, and other examples may include more, fewer, or different components than those shown in FIG. 3. For example, in some cases, XR system 300 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 3. While various components of XR system 300, such as image sensor 302, may be referenced in the singular form herein, it should be understood that XR system 300 may include multiple of any component discussed herein (e.g., multiple image sensors 302).

Display 312 may be, or may include, a glass, a screen, a lens, a projector, and/or other display mechanism that allows a user to see the real-world environment and also allows XR content to be overlaid, overlapped, blended with, or otherwise displayed thereon.

XR system 300 may include, or may be in communication with, (wired or wirelessly) an input device 310. Input device 310 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 302 may capture images that may be processed for interpreting gesture commands.

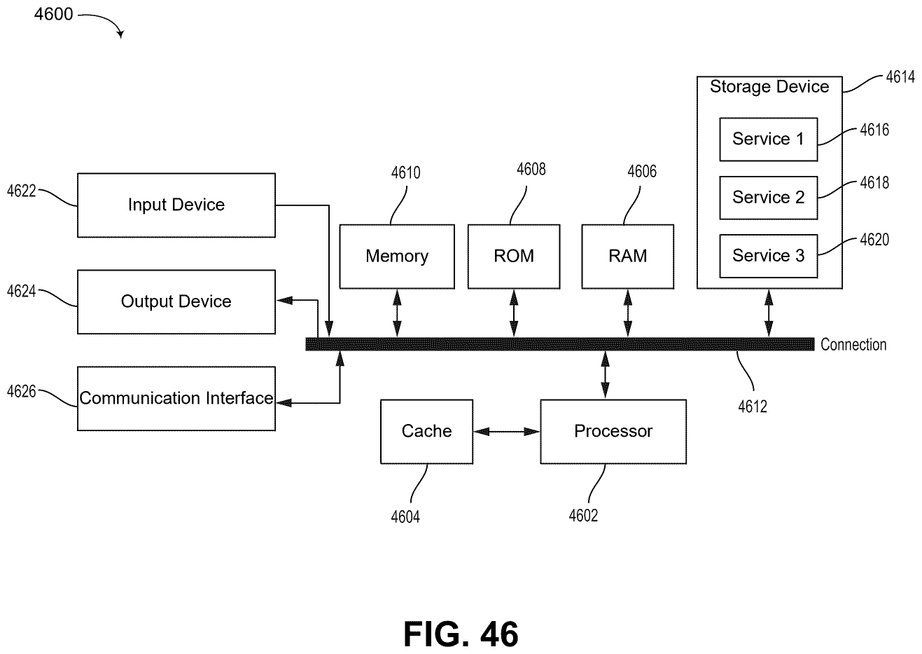

XR system 300 may also communicate with one or more other electronic devices (wired or wirelessly). For example, communications engine 332 may be configured to manage connections and communicate with one or more electronic devices. In some cases, communications engine 332 may correspond to communication interface 4626 of FIG. 46.

In some implementations, image sensors 302, accelerometer 304, gyroscope 306, storage 308, display 312, compute components 314, XR engine 326, image processing engine 328, and rendering engine 330 may be part of the same computing device. For example, in some cases, image sensors 302, accelerometer 304, gyroscope 306, storage 308, display 312, compute components 314, XR engine 326, image processing engine 328, and rendering engine 330 may be integrated into an HMD, extended reality glasses, smartphone, laptop, tablet computer, gaming system, and/or any other computing device. However, in some implementations, image sensors 302, accelerometer 304, gyroscope 306, storage 308, display 312, compute components 314, XR engine 326, image processing engine 328, and rendering engine 330 may be part of two or more separate computing devices. For instance, in some cases, some of the components 302-332 may be part of, or implemented by, one computing device and the remaining components may be part of, or implemented by, one or more other computing devices. For example, such as in a split perception XR system, XR system 300 may include a first device (e.g., an HMD), including display 312, image sensor 302, accelerometer 304, gyroscope 306, and/or one or more compute components 314. XR system 300 may also include a second device including additional compute components 314 (e.g., implementing XR engine 326, image processing engine 328, rendering engine 330, and/or communications engine 332). In such an example, the second device may generate virtual content based on information or data (e.g., images, sensor data such as measurements from accelerometer 304 and gyroscope 306) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 308 may be any storage device(s) for storing data. Moreover, storage 308 may store data from any of the components of XR system 300. For example, storage 308 may store data from image sensor 302 (e.g., image or video data), data from accelerometer 304 (e.g., measurements), data from gyroscope 306 (e.g., measurements), data from compute components 314 (e.g., processing parameters, preferences, virtual content, rendering content, scene maps, tracking and localization data, object detection data, privacy data, XR application data, face recognition data, occlusion data, etc.), data from XR engine 326, data from image processing engine 328, and/or data from rendering engine 330 (e.g., output frames). In some examples, storage 308 may include a buffer for storing frames for processing by compute components 314.

Compute components 314 may be, or may include, a central processing unit (CPU) 316, a graphics processing unit (GPU) 318, a digital signal processor (DSP) 320, an image signal processor (ISP) 322, a neural processing unit (NPU) 324, which may implement one or more trained neural networks, and/or other processors. Compute components 314 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 314 may implement (e.g., control, operate, etc.) XR engine 326, image processing engine 328, and rendering engine 330. In other examples, compute components 314 may also implement one or more other processing engines.

Image sensor 302 may include any image and/or video sensors or capturing devices. In some examples, image sensor 302 may be part of a multiple-camera assembly, such as a dual-camera assembly. Image sensor 302 may capture image and/or video content (e.g., raw image and/or video data), which may then be processed by compute components 314, XR engine 326, image processing engine 328, and/or rendering engine 330 as described herein.

In some examples, image sensor 302 may capture image data and may generate images (also referred to as frames) based on the image data and/or may provide the image data or frames to XR engine 326, image processing engine 328, and/or rendering engine 330 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 302 (and/or other camera of XR system 300) may be configured to also capture depth information. For example, in some implementations, image sensor 302 (and/or other camera) may include an RGB-depth (RGB-D) camera. In some cases, XR system 300 may include one or more depth sensors (not shown) that are separate from image sensor 302 (and/or other camera) and that may capture depth information. For instance, such a depth sensor may obtain depth information independently from image sensor 302. In some examples, a depth sensor may be physically installed in the same general location or position as image sensor 302 but may operate at a different frequency or frame rate from image sensor 302. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 300 may also include other sensors in its one or more sensors. The one or more sensors may include one or more accelerometers (e.g., accelerometer 304), one or more gyroscopes (e.g., gyroscope 306), and/or other sensors. The one or more sensors may provide velocity, orientation, and/or other position-related information to compute components 314. For example, accelerometer 304 may detect acceleration by XR system 300 and may generate acceleration measurements based on the detected acceleration. In some cases, accelerometer 304 may provide one or more translational vectors (e.g., up/down, left/right, forward/back) that may be used for determining a position or pose of XR system 300. Gyroscope 306 may detect and measure the orientation and angular velocity of XR system 300. For example, gyroscope 306 may be used to measure the pitch, roll, and yaw of XR system 300. In some cases, gyroscope 306 may provide one or more rotational vectors (e.g., pitch, yaw, roll). In some examples, image sensor 302 and/or XR engine 326 may use measurements obtained by accelerometer 304 (e.g., one or more translational vectors) and/or gyroscope 306 (e.g., one or more rotational vectors) to calculate the pose of XR system 300. As previously noted, in other examples, XR system 300 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 300, using a combination of one or more accelerometers, one or more gyroscopes, and/or one or more magnetometers. In some examples, the one or more sensors may output measured information associated with the capture of an image captured by image sensor 302 (and/or other camera of XR system 300) and/or depth information obtained using one or more depth sensors of XR system 300.

The output of one or more sensors (e.g., accelerometer 304, gyroscope 306, one or more IMUs, and/or other sensors) can be used by XR engine 326 to determine a pose of XR system 300 (also referred to as the head pose) and/or the pose of image sensor 302 (or other camera of XR system 300). In some cases, the pose of XR system 300 and the pose of image sensor 302 (or other camera) can be the same. The pose of image sensor 302 refers to the position and orientation of image sensor 302 relative to a frame of reference (e.g., with respect to a field of view 210 of FIG. 2). In some implementations, the camera pose can be determined for 6-Degrees of Freedom (6DoF), which refers to three translational components (e.g., which can be given by X (horizontal), Y (vertical), and Z (depth) coordinates relative to a frame of reference, such as the image plane) and three angular components (e.g., roll, pitch, and yaw relative to the same frame of reference). In some implementations, the camera pose can be determined for 3-Degrees of Freedom (3DoF), which refers to the three angular components (e.g., roll, pitch, and yaw).

In some cases, a device tracker (not shown) can use the measurements from the one or more sensors and image data from image sensor 302 to track a pose (e.g., a 6DoF pose) of XR system 300. For example, the device tracker can fuse visual data (e.g., using a visual tracking solution) from the image data with inertial data from the measurements to determine a position and motion of XR system 300 relative to the physical world (e.g., the scene) and a map of the physical world. As described below, in some examples, when tracking the pose of XR system 300, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 300 within the scene and the 3D map of the scene, etc. The 3D map can provide a digital representation of a scene in the real/physical world. In some examples, the 3D map can anchor position-based objects and/or content to real-world coordinates and/or objects. XR system 300 can use a mapped scene (e.g., a scene in the physical world represented by, and/or associated with, a 3D map) to merge the physical and virtual worlds and/or merge virtual content or objects with the physical environment.

In some aspects, the pose of image sensor 302 and/or XR system 300 as a whole can be determined and/or tracked by compute components 314 using a visual tracking solution based on images captured by image sensor 302 (and/or other camera of XR system 300). For instance, in some examples, compute components 314 can perform tracking using computer vision-based tracking, model-based tracking, and/or simultaneous localization and mapping (SLAM) techniques. For instance, compute components 314 can perform SLAM or can be in communication (wired or wireless) with a SLAM system (not shown). SLAM refers to a class of techniques where a map of an environment (e.g., a map of an environment being modeled by XR system 300) is created while simultaneously tracking the pose of a camera (e.g., image sensor 302) and/or XR system 300 relative to that map. The map can be referred to as a SLAM map which can be three-dimensional (3D). The SLAM techniques can be performed using color or grayscale image data captured by image sensor 302 (and/or other camera of XR system 300) and can be used to generate estimates of 6DoF pose measurements of image sensor 302 and/or XR system 300. Such a SLAM technique configured to perform 6DoF tracking can be referred to as 6DoF SLAM. In some cases, the output of the one or more sensors (e.g., accelerometer 304, gyroscope 306, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 302 (and/or other camera) to the SLAM map. For example, 6DoF SLAM can use feature point associations from an input image to determine the pose (position and orientation) of the image sensor 302 and/or XR system 300 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 302 and/or the XR system 300 can be determined by projecting features from the 3D SLAM map into an image or video frame and updating the camera pose from verified 2D-3D correspondences.

In one illustrative example, the compute components 314 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 314 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 300 can also track the hand and/or fingers of the user to allow the user to interact with and/or control virtual content in a virtual environment. For example, the XR system 300 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

A system may generate a three-dimensional (3D) map of an environment of the system based on images of the environment. For example, volume blocks (e.g., “voxels” or “voxel blocks”) are often used to reconstruct a 3D scene from 2D images (e.g., stereoscopically-paired images obtained from a stereoscopic pair of cameras). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

A 3D reconstruction technique (“3DR”) utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four-centimeter block dimension. In some examples, for this room, the occupied voxel blocks may only be about ten to fifteen percent.

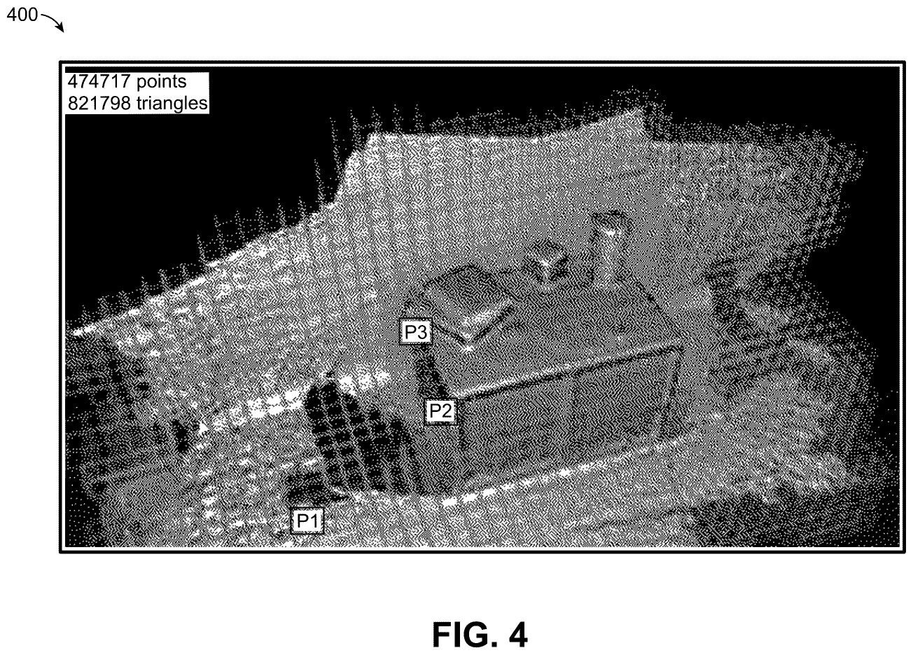

FIG. 4 is a diagram illustrating an example of a scene that has been modeled as a 3D sparse volumetric representation for 3DR. In particular, FIG. 4 is a diagram illustrating an example of a 3D surface reconstruction 400 of a scene modeled with an overlay of a volume grid containing voxel blocks. For 3DR, a camera (e.g., a stereo camera) may take photos of the scene from various different viewpoints and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel block) located at point P2 within the scene may be taken by a camera (e.g., a stereo camera) located at point P1 with a certain camera pose (e.g., at a certain angle). The camera can capture depth and, in some cases, can also capture color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel block). An integrate process can occur where all of the blocks within the scene are passed through an integrate function. The integrate function can determine depth information for each of the blocks from the depth frame and can update each block to indicate whether the block has a surface or not. In cases where the 3DR algorithm or system integrates color, the blocks that are determined to have a surface can then be updated with a color. In other cases, for 3DR systems that operate on depth (without color), color may not be added to or integrated with the blocks.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxel blocks), instead of using a large memory lookup table, various different volume block representations may be used to index the blocks in the 3D scene to store data where the measurements are observed. Volume block representations that may be employed can include, but are not limited to, a hash map lookup, an octree, and a large blocks implementation.

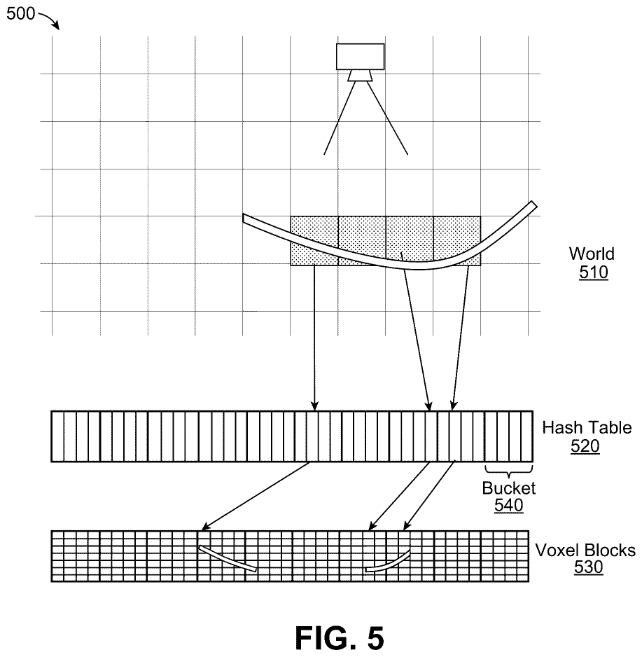

FIG. 5 is a diagram illustrating an example of a hash map lookup type of volume block representation. In particular, FIG. 5 is a diagram illustrating an example of a hash-mapping function 500 for indexing voxel blocks 530 in a volume grid. In FIG. 5, a volume grid is shown with world coordinates 510. Also shown in FIG. 5 are a hash table 520 and voxel blocks 530. In one or more examples, a hash function can be used to map the integer world coordinates 510 into hash buckets 540 within the hash table 520. The hash buckets 540 can each store a small array of points to regular grid voxel blocks 530. Each voxel block 530 contains data that can be used for depth integration.

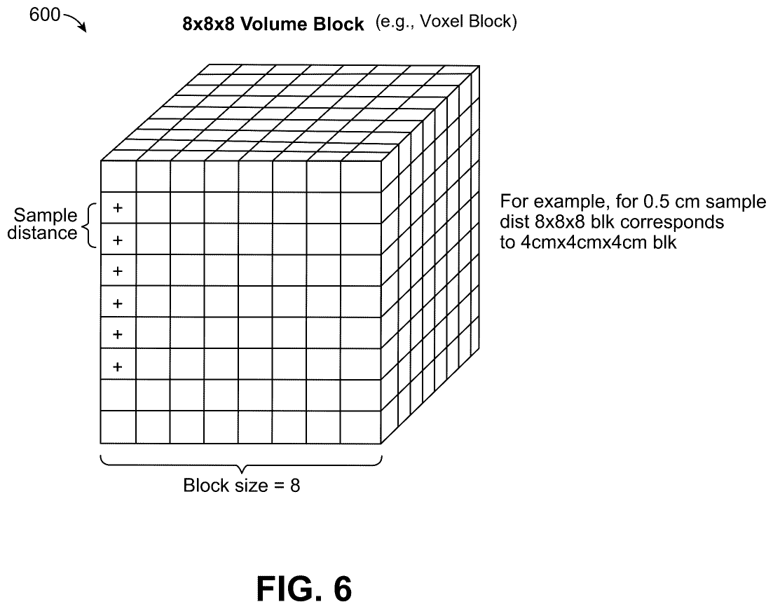

FIG. 6 is a diagram illustrating an example of a volume block (e.g., a voxel block) 600. In FIG. 6, the voxel block 600 is shown to have a block size of eight. For example, a 0.5-centimeter (cm) sample distance for an eight by eight-by-eight voxel block can correspond to a four cm by four cm by four cm voxel block. That is, the voxel block 600 includes a 3D lattice of 512 voxels, the voxels arranged so that the voxel block 600 has a width of 8 voxels, a length of 8 voxels, and a height of 8 voxels.

In one or more examples, each voxel block (e.g., voxel block 600) can contain or store truncated signed distance function (TSDF) samples and a weight. In some cases, each voxel can also contain or store color values (e.g., red-green-blue (RGB) values). TSDF is a function that measures the distance d of each pixel from the surface of an object to the camera. A voxel block with a positive value for d can indicate that the voxel block is located in front of a surface, a voxel block with a negative value for d can indicate that the voxel block is located inside (or behind) the surface, and a voxel block with a zero value for d can indicate that the voxel block is located on the surface. The distance d is truncated to [−1, 1], for example based on:

$$tsdf = \{ \begin{matrix}- 1 , & if d \leq - ramp \\ \frac{d}{ramp} , & if - ramp < d < ramp \\ 1 , & if d \geq ramp\end{matrix} \}$$

$$sample . tsdf = ( \frac{sample . weight * sample . tsdf + tsdf}{sample . weight + 1} )$$

A TSDF integration or fusion process can be employed that updates the TSDF values and weights with each new observation from the sensor (e.g., camera).

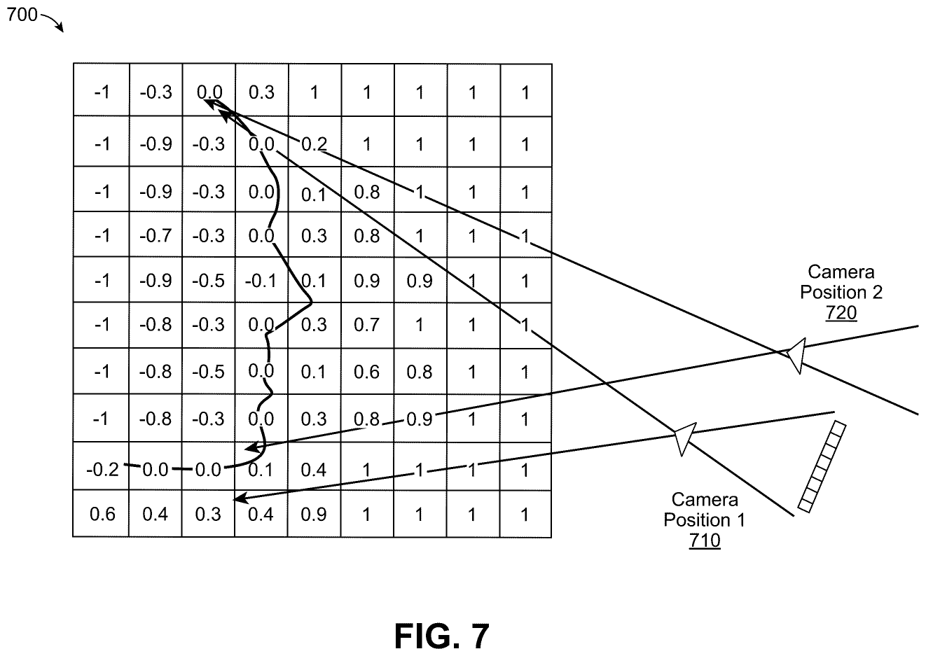

FIG. 7 is a diagram illustrating an example of a TSDF volume reconstruction 700. In FIG. 7, a voxel grid including a plurality of voxel blocks is shown. A camera is shown to be obtaining images of a scene (e.g., person's face) from two different camera positions (e.g., camera position 1 710 and camera position 2 720). During operation for TSDF, for each new observation (e.g., image) from the camera (e.g., for each image taken by the camera at a different camera position), the distance (d) of a corresponding pixel of each voxel block within the voxel grid can be obtained. The distance (d) value can be truncated by comparing a threshold value (e.g., referred to as a ramp) to derive a current TSDF value, and the current TSDF value can be integrated to the TSDF volume, such as by using a weighted averaging (e.g., as shown in equation 1 above). The TSDF values (and in some cases color values) can be updated in the global memory. In FIG. 7, the voxel blocks with positive values are shown to be located in front of the person's face, the voxel blocks with negative values are shown to be located inside of the person's face, and the voxel blocks with zero values are shown to be located on the surface of the person's face.

As previously mentioned, in 3DR, 3D scenes are represented using a 3D volume of points called voxel blocks. Typically, each voxel block carries implicit surface information (e.g., in the form of a TSDF value and a weight for depth integration). The TSDF value is a measure of distance of the voxel block from a surface. The weight is a measure of the reliability of the TSDF value. In some cases, a TSDF weight may be estimated using various approaches, such as a simple counter (e.g., a binary weight, such as “1” or “0”), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to “1.”

A 3DR system can utilize a sequence of depth maps of a scene with their corresponding 6 DoF poses as an input. The depth maps may be generated using deep learning (DL), non-DL, and/or other depth estimation algorithms or methods. A 3D space of the scene may be uniformly sampled along the X, Y, and Z directions. The 3D space may be divided into fixed size volumes (e.g., block volumes with a fixed number of samples).

A 3DR system generally consists of three stages, which include block selection, integration, and surface extraction. During block selection, all of the blocks that have surfaces or are located close to a surface may be selected. These blocks may then be allocated into memory. In block integration, all voxel blocks within a block volume may be iterated over and an updated TSDF value weight can be calculated. In surface extraction, marching cubes may be used to determine triangular surfaces in the blocks.

In block selection, depth pixels may be iterated over to unproject them to a 3D space and determine where they lie within the 3D space using intrinsic and extrinsic camera parameters. Usually, a hash map is employed for block selection. A hash map is an unordered map, which includes a listing of blocks (e.g., including block indices of the blocks) that have a surface. The hash map may include a corresponding counter for each of the blocks that maintains a count of the number of times depth pixels lie within the particular block. A threshold (e.g., threshold value or number) may be used to select all the blocks that have depth pixels lie within them for more than the threshold number of times. The selected blocks may then be integrated.

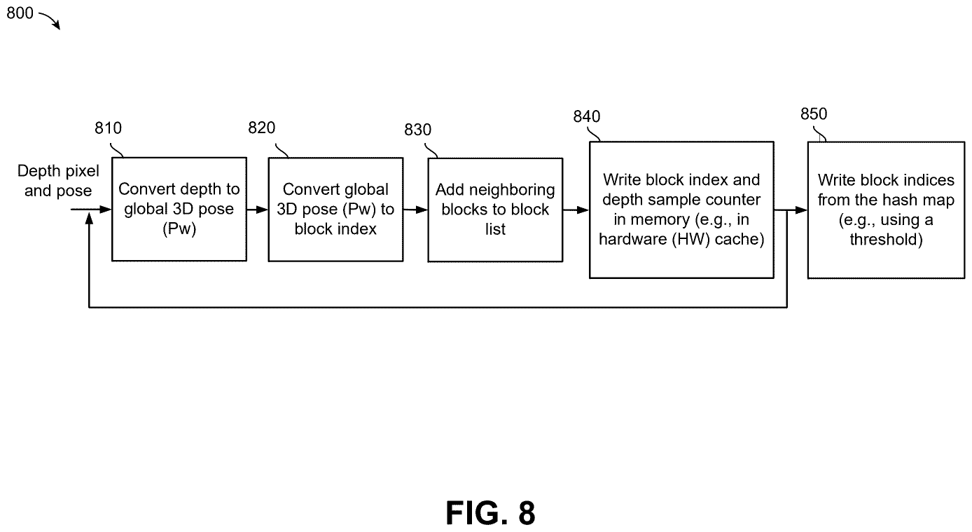

FIG. 8 is a diagram of an example voxel block selection algorithm for 3DR of a scene. In particular, FIG. 8 is a diagram illustrating an example of a voxel-block-selection algorithm 800. In FIG. 8, for operation of the voxel-block-selection algorithm 800, a plurality of depth pixels associated with a plurality of depth maps of the scene can be obtained by one or more processors. In one or more examples, each depth map of the plurality of depth maps is associated with a respective pose (e.g., 6 DoF pose) of an image sensor (e.g., a scene-facing camera of XR device 202 of FIG. 2). In some examples, each depth pixel of the plurality of depth pixels is associated with a depth value. The one or more processors can iterate the voxel-block-selection algorithm 800 over every depth value in the depth maps.

During operation of the voxel-block-selection algorithm 800, at operation 810, the one or more processors can convert the depth values of the plurality of depth pixels to a plurality of global three-dimensional (3D) points in a global coordinate system. In one or more examples, the converting of the depth values of the plurality of depth pixels to the plurality of global 3D points in the global coordinate system can be achieved by the one or more processors unprojecting the depth values to a 3D space.

At operation 820, the one or more processors can determine indices of blocks (e.g., voxel blocks) associated with the plurality of global 3D points. At operation 830, the one or more processors can generate a listing of blocks including the indices of the blocks associated with the plurality of global 3D points and indices of neighboring blocks adjacent (e.g., next to or close) to the blocks associated with the plurality of global 3D points.

The one or more processors can then select the plurality of blocks of the scene from the listing of blocks based on a number of depth pixels of the plurality of depth pixels being located within the plurality of blocks. For example, at operation 840, the one or more processors can increment a counter for each block in the listing of blocks each time a depth pixel of the plurality of depth pixels is located within each block. The one or more processors can write the indices and the corresponding counter values of the blocks in the listing of the blocks in memory (e.g., a hardware cache).

At operation 850, the one or more processors can determine blocks in the listing of blocks with a counter value greater than a threshold value (e.g., a threshold number). The one or more processors can then select the plurality of blocks of the scene based on the blocks in the listing of blocks with the counter value greater than the threshold value. The one or more processors can write the indices of the selected plurality of blocks of the scene in memory (e.g., the hardware cache).

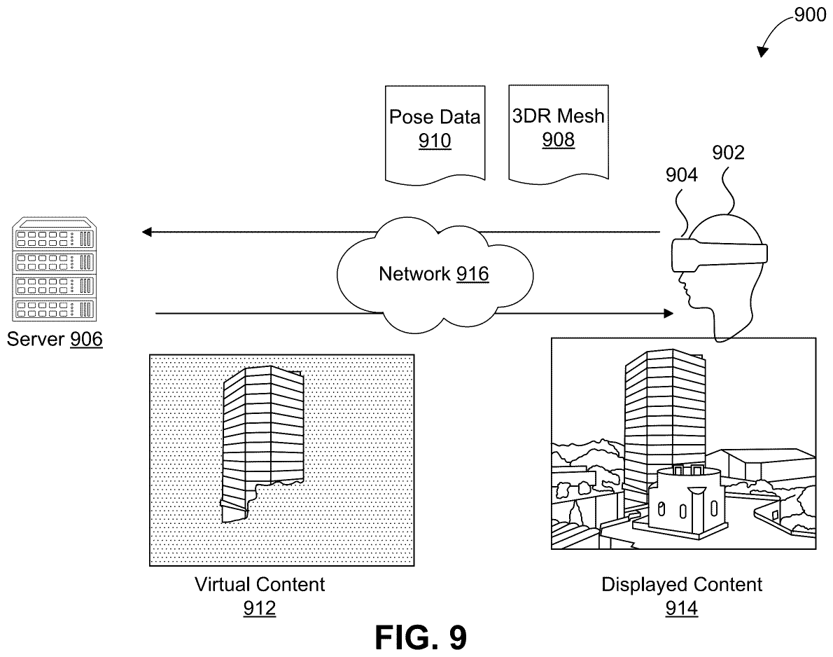

FIG. 9 is a block diagram illustrating an example system 900 for extended reality, according to various aspects of the present disclosure. In general, an XR device 904 of user 902 may determine a 3DR mesh 908 and pose data 910 and transmit 3DR mesh 908 and pose data 910 to server 906 (e.g., via a network 916). Server 906 may determine virtual content 912 based on pose data 910 and 3DR mesh 908 and transmit virtual content 912 to XR device 904. XR device 904 may display displayed content 914, including virtual content 912, to user 902.

XR device 904 may be any suitable XR device. XR device 904 may be an example of XR device 102 of FIG. 1, XR device 202 and/or companion device 204 of FIG. 2 and/or XR system 300 of FIG. 3. XR device 904 may implement AR or MR by displaying virtual content in a field of view of user 902 (e.g., as described with regard to FIG. 2). XR device 904 may be, or may include, an HMD or a handheld device that may display virtual content in a field of view of user 902.

Server 906 may be any suitable computing device. Server 906 may be a local computing device (e.g., a mobile device of user 902). Companion device 204 of FIG. 2 is an example of server 906. Additionally or alternatively, server 906 may be, or may include, a remote computing device, such as a server computer at a remote location connected to user 902 via network 916.

XR device 904 may determine pose data 910 which may be, or may include, a 6DoF pose of XR device 904 (e.g., based on inertial data from one or more IMUs of XR device 904 and/or based on visual odometry, such as SLAM such as described with regard to XR system 300 of FIG. 3.

XR device 904 may determine 3DR mesh 908 which may be, or may include, a 3D representation of a scene of XR device 904. XR device 904 may determine 3DR mesh 908 as described with regard to FIG. 4, FIG. 5, FIG. 6, FIG. 7, and FIG. 8.

XR device 904 may transmit 3DR mesh 908 and pose data 910 to server 906 according to any suitable wireless communication standard, such as Institute of Electrical and Electronics Engineers (IEEE) 802.11ax/11ac. XR device 904 may transmit 3DR mesh 908 and server 906 to server 906 via network 916.

Server 906 may generate virtual content 912 with alpha channel based on 3DR mesh 908, pose data 910. For example, server 906 may generate virtual content 912 such that virtual content 912 may be displayed to user 902 in the field of view of user 902 such that virtual content 912 fits in the scene in field of view of user 902. For example, server 906 may generate virtual content 912 such that virtual content 912 may be anchored to a point in the scene such that as user 902 moves and/or reorients their head, virtual content 912 stays anchored to the point. To anchor virtual content 912 in the scene, server 906 may generate virtual content 912 based on pose data 910.

Additionally, server 906 may generate virtual content 912 based on 3DR mesh 908, for example, such that virtual content 912 interacts realistically with the scene. For example, server 906 may generate virtual content 912 based on occlusions for example, to account for real-world objects in the scene that will occlude virtual content 912 from the field of view of user 902. For example, as illustrated in FIG. 9, server 906 may generate virtual content 912 without a lower portion of a building because when virtual content 912 is displayed at XR device 904, the lower portion of the building may be occluded by real-world buildings in the scene. Additionally or alternatively, server 906 may generate virtual content 912 based on physics-based rendering such that virtual content 912 interacts with real-world objects realistically. For example, server 906 may generate virtual content 912 such that virtual content 912 is anchored to the ground. As another example, server 906 may generate a virtual ball that bounces off real-world surfaces in the scene.

Server 906 may compress virtual content 912 and transmit virtual content 912 to XR device 904. XR device 904 may decompress virtual content 912 and include virtual content 912 in displayed content 914 and display displayed content 914 to user 902. XR device 904 may implement video see-through (VST) and may integrate virtual content 912 into images or video captured live of the scene of user 902. Alternatively, XR device 904 may include a transparent display and may display virtual content 912 at the transparent display of XR device 904.

One challenge of system 900 is in transmitting 3DR mesh 908 from XR device 904 to server 906. Uncompressed, 3DR mesh 908 may be large and may be transmitted repeatedly. For example, in some aspects, transmitting 3DR mesh 908 may use 200 megabits per second (Mbps) when 3DR mesh 908 is transmitted at a rate of once per second. Transmitting 200 Mbps from an XR device, such as XR device 904, may consume significant power.

In some aspects, rather than transmitting an entire 3DR mesh describing an entirety of the scene mapped by XR device 904, XR device 904 may determine changes to the 3DR mesh since the last time the 3DR mesh was transmitted to server 906 and transmit updates to the 3DR mesh. For example, XR device 904 may store and use a 3DR mesh locally and server 906 may store and use a corresponding 3DR mesh. XR device 904 may determine updates to its local 3DR mesh and transmit the updates to server 906. XR device 904 and server 906 may update their local 3DR meshes to keep the meshes in sync. Then, server 906 may generate virtual content 912 based on its local, synched 3DR mesh.

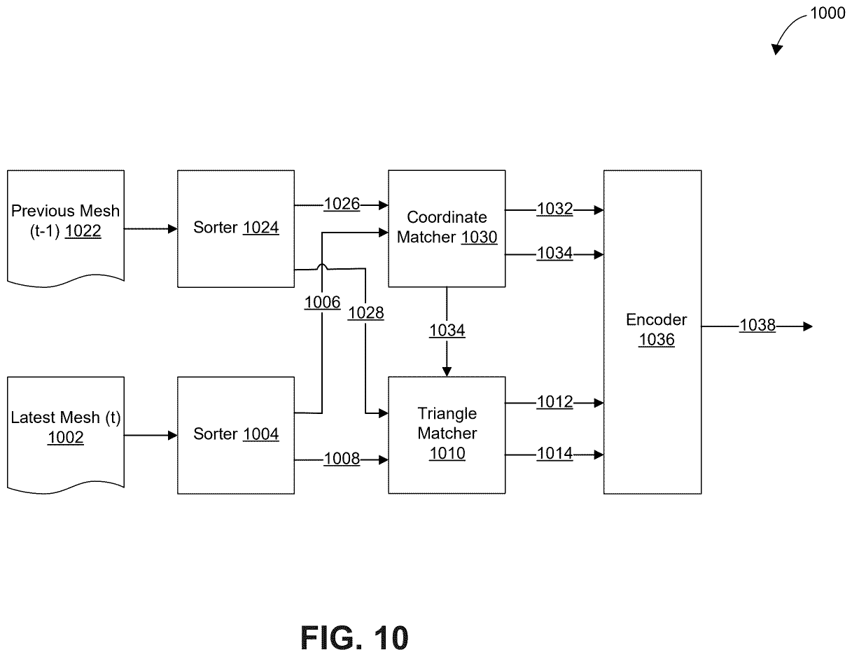

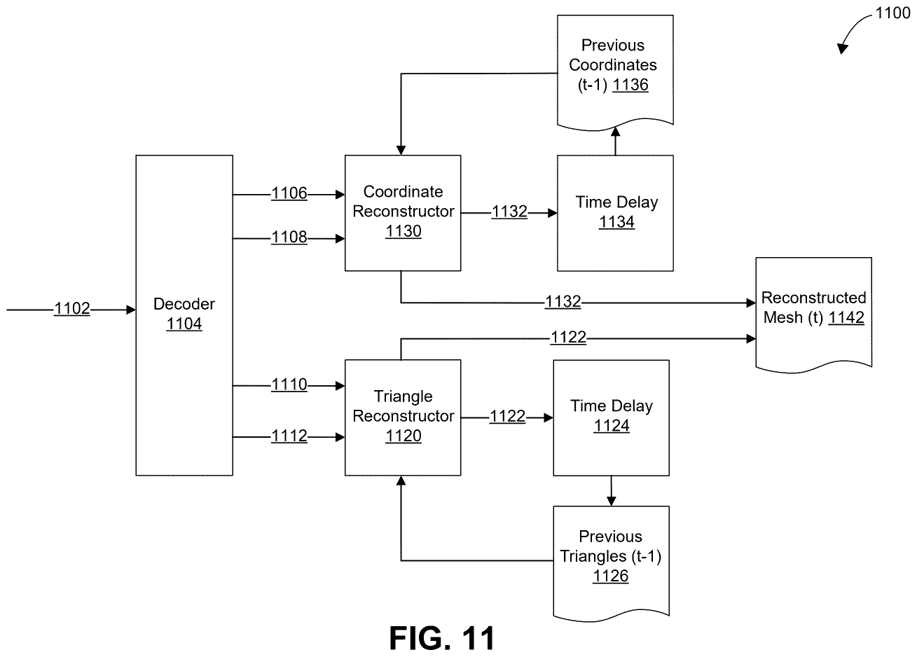

For example, FIG. 10 is a block diagram illustrating an example system 1000 for processing, compressing, encoding, and/or transmitting 3D data, according to various aspects of the present disclosure. System 1000 may determine updates to a 3D mesh based on a new 3D mesh generated by a 3DRU and a previous 3D mesh generated by the 3DRU. System 1000 may generate data indicative of the updates and compress the data as encoded data 1038 and send encoded data 1038 to a server (such as system 1100 of FIG. 11). System 1000 may be an example of an XR device, such as XR device 904 of FIG. 9.

FIG. 11 may receive encoded data 1038 as encoded data 1102 and decompress encoded data 1102 to obtain the updates to the previous 3D mesh. System 1100 may apply the updates to a local instance of the previous 3D mesh to generate reconstructed mesh 1142. Downstream tasks may perform various operations on reconstructed mesh 1142. System 1100 may be an example of a server, such as server 906 of FIG. 9.

Turning to FIG. 10, in general, a sorter 1004 of system 1000 may sort a latest mesh 1002 and provide latest coordinates 1006 to a coordinate matcher 1030 and latest triangles 1008 to a triangle matcher 1010. Similarly, a sorter 1024 may sort a previous mesh 1022 and provide previous triangles 1028 to triangle matcher 1010 and previous coordinates 1026 to coordinate matcher 1030. Triangle matcher 1010 may generate new triangles 1012 and triangle map 1014 based on latest triangles 1008 and previous triangles 1028. Triangle map 1014 may indicate which of previous triangles 1028 to retain. Triangle matcher may provide new triangles 1012 and triangle map 1014 to an encoder 1036. Similarly, coordinate matcher 1030 may generate new coordinates 1032 and coordinates map 1034 based on latest coordinates 1006 and previous coordinates 1026. Coordinates map may indicate which of previous coordinates 1026 to retain. Coordinate matcher 1030 may provide new coordinates 1032 and coordinates map 1034 to encoder 1036. Encoder 1036 may generate encoded data 1038 based on new coordinates 1032, coordinates map 1034, new triangles 1012, and triangle map 1014.

System 1000 may obtain latest mesh 1002, for example, from a 3DRU component of an XR device. Latest mesh 1002 may be determined as described with regard to FIG. 4, FIG. 5, FIG. 6, FIG. 7, and FIG. 8.

Latest mesh 1002 may include a list of 3D coordinates and a list of triangles. For example, latest mesh 1002 may include a list of sets of x, y, and z coordinates where each set defines a 3D coordinate in a 3D space. Additionally, latest mesh 1002 may include a list of triangles. The triangles may define triangles in the 3D space by referencing points of the list of 3D coordinates. For example, the list of coordinates may include:

| 3D Coordinate Number | x | y | z |
|---|---|---|---|
| 1 | x₁ | y₁ | z₁ |
| 2 | x₂ | y₂ | z₂ |
| 3 | x₃ | y₃ | z₃ |
| 4 | x₄ | y₄ | z₄ |
| 5 | x₅ | y₅ | z₅ |
| 6 | x₆ | y₆ | z₆ |

The list of triangles may include:

| Triangle number | vertex 1 | vertex 2 | vertex 3 |
|---|---|---|---|
| 1 | 1 | 2 | 3 |
| 2 | 4 | 5 | 6 |

In the example, there may be 6 3D coordinates and two triangles. A first triangle may have vertices at the first three 3D coordinates (coordinate numbers 1, 2, and 3) and a second triangle may have vertices at the fourth, fifth, and sixth 3D coordinates (coordinate numbers 4, 5, and 6).

Previous mesh 1022 represents a previously-received mesh. For example, system 1000 is described as operating on a most-recently-received mesh—latest mesh 1002. Previous mesh 1022 may be the mesh received prior to receiving latest mesh 1002. System 1000 may store instances of latest mesh 1002 for future use as instances of previous mesh 1022.

Sorter 1004 may sort latest mesh 1002 to improve a performance of system 1000. For example, sorter 1004 sorting 3D coordinates and triangles will allow system 1000 to do matching in O(nₜ+nₜ₋₁) time, where n is the number of 3D coordinates/triangles. Similarly, sorter 1024 may sort previous mesh 1022 to improve a performance of system 1000. Sorter 1004 and sorter 1024 may be optional in system 1000. For example, in some aspects, system 1000 may not include sorter 1004 and/or sorter 1024.

Coordinate matcher 1030 may match 3D coordinates of latest coordinates 1006 with 3D coordinates of previous coordinates 1026. For example, coordinate matcher 1030 may determine which of latest coordinates 1006 are present in previous coordinates 1026. For each 3D coordinate of latest coordinates 1006 included in previous coordinates 1026 (e.g., for each 3D coordinate of previous coordinates 1026 that is already present in previous coordinates 1026), coordinate matcher 1030 may store a value in coordinates map 1034. Coordinates map 1034 may be a map indicating a correspondence between latest coordinates 1006 and previous coordinates 1026. For example, coordinates map 1034 may be a binary mask including a value for each 3D coordinate of previous coordinates 1026. For each 3D coordinate of latest coordinates 1006 that is present in previous coordinates 1026, coordinate matcher 1030 may store a “1” in coordinates map 1034. For each 3D coordinate of latest coordinates 1006 that is not present in previous coordinates 1026, coordinate matcher 1030 may store a “0” in coordinates map 1034. Additionally, for each 3D coordinate of latest coordinates 1006 that is not present in previous coordinates 1026, coordinate matcher 1030 may store a new 3D coordinate in new coordinates 1032.

Similarly, triangle matcher 1010 may match triangles of latest triangles 1008 with triangles of previous triangles 1028. For example, triangle matcher 1010 may determine which of latest triangles 1008 are present in previous triangles 1028. For each triangle of latest triangles 1008 included in previous triangles 1028 (e.g., for each triangle of latest triangles 1008 that is already present in previous triangles 1028), triangle matcher 1010 may store a value in a triangle map 1014. Triangle map 1014 may be a map indicating a correspondence between latest triangles 1008 and previous triangles 1028. For example, triangle map 1014 may be a binary mask including a value for each triangle of latest triangles 1008. For each triangle of latest triangles 1008 that is present in previous triangles 1028, triangle matcher 1010 may store a “1” in triangle map 1014. For each triangle of latest triangles 1008 that is not present in previous triangles 1028, triangle matcher 1010 may store a “0” in triangle map 1014.

Additionally, for each triangle of latest triangles 1008 that is not in previous triangles 1028, triangle matcher 1010 may store a new triangle in new triangles 1012. New triangles 1012 may reference latest coordinates 1006. For example, new triangles 1012 may include triangles with vertices that reference points of latest coordinates 1006. For example, new triangles 1012 may include a triangle that references 3D coordinates numbers 101, 103, and 107 of latest coordinates 1006.

Encoder 1036 may encode (e.g., compress) new coordinates 1032, coordinates map 1034, new triangles 1012, and triangle map 1014 to generate encoded data 1038. In some aspects, encoder 1036 may be a lossless encoder.

System 1000 may transmit encoded data 1038 to a server. The server may generate virtual content based on the 3D mesh data of latest mesh 1002 (e.g., as compressed and encoded by system 1000 as encoded data 1038). Additionally, system 1000 may use state machines to keep track of last API call from each client application that request for 3DR mesh data.

FIG. 11 is a block diagram illustrating an example system 1100 for decompressing, decoding, processing, and/or reconstructing 3D data, according to various aspects of the present disclosure. As mentioned previously, FIG. 11 may perform operations related to decompressing 3D mesh data to generate reconstructed mesh 1142 to perform operations various operations on the 3D mesh data. System 1100 may be an example of a server, such as server 906 of FIG. 9. System 1000 may transmit encoded data 1038 and system 1100 may receive encoded data 1038 as encoded data 1102 and process encoded data 1102.

For example, in general, system 1100 may receive encoded data 1102, decode encoded data 1102 to generate new coordinates 1106, coordinates map 1108, new triangles 1110, and triangle map 1112. A coordinate reconstructor 1130 may generate reconstructed coordinates 1132 based on new coordinates 1106, coordinates map 1108, and previous coordinates 1136. A triangle reconstructor 1120 may generate reconstructed triangles 1122 based on new triangles 1110, triangle map 1112, and previous triangles 1126. Reconstructed triangles 1122 and reconstructed coordinates 1132 together may be reconstructed mesh 1142. Reconstructed mesh 1142 may be the same as latest mesh 1002 of FIG. 10. A downstream operation may process reconstructed mesh 1142, for example, to generate virtual content based on reconstructed mesh 1142.

Encoded data 1102 may be, or may include, encoded 3D mesh data (e.g., as compressed and encoded by system 1000 as encoded data 1038). Encoded data 1102 may be encoded using a lossless encoder. Decoder 1104 may be a lossless decoder and may decode encoded data 1102 according to a lossless decoding to generate new coordinates 1106, coordinates map 1108, new triangles 1110, and triangle map 1112. As such, new coordinates 1106 may be the same as, or may be substantially similar to, new coordinates 1032 of FIG. 10, coordinates map 1108 may be the same as, or may be substantially similar to, coordinates map 1034 of FIG. 10, new triangles 1110 may be the same as, or may be substantially similar to, new triangles 1012 of FIG. 10, and triangle map 1112 may be the same as, or may be substantially similar to, triangle map 1014 of FIG. 10.

Coordinate reconstructor 1130 may generate reconstructed coordinates 1132 based on new coordinates 1106, coordinates map 1108, and previous coordinates 1136. For example, in some aspects, coordinate reconstructor 1130 may use new coordinates 1106 as a base set of 3D coordinates and add 3D coordinates of previous coordinates 1136 to the base set of 3D coordinates based on coordinates map 1108. For example, coordinate reconstructor 1130 may add 3D coordinates of previous coordinates 1136 that are marked as “1” in coordinates map 1108 to new coordinates 1106 to generate reconstructed coordinates 1132. In other aspects, coordinate reconstructor 1130 may use 3D coordinates of previous coordinates 1136 that are marked as “1” in coordinates map 1108 as a base set of 3D coordinates and add 3D coordinates of new coordinates 1106 to the base set of 3D coordinates. For example, coordinate reconstructor 1130 may add 3D coordinates of new coordinates 1106 to the 3D coordinates of reconstructed coordinates 1132 that are marked as “1” in coordinates map 1108.

Similarly, triangle reconstructor 1120 may reconstructed triangles 1122 based on new triangles 1110, triangle map 1112, and previous triangles 1126. For example, in some aspects, triangle reconstructor 1120 may use new triangles 1110 as a base set of triangles and add triangles of previous triangles 1126 to the base set of triangles based on triangle map 1112. For example, triangle reconstructor 1120 may add triangles of previous triangles 1126 that are marked as “1” in triangle map 1112 to new triangles 1110 to generate reconstructed triangles 1122. In other aspects, triangle reconstructor 1120 may use triangles of previous triangles 1126 that are marked as “1” in triangle map 1112 as a base set of triangles and add triangles of new triangles 1110 to the base set of 3D coordinates. For example, triangle reconstructor 1120 may add triangles of new triangles 1110 to the triangles of previous triangles 1126 that are marked as “1” in triangle map 1112.

Reconstructed triangles 1122 may reference reconstructed coordinates 1132. For example, reconstructed triangles 1122 may include triangles with vertices that reference points of reconstructed coordinates 1132. For example, reconstructed triangles 1122 may include a triangle that references 3D coordinates numbers 201, 203, and 207 of reconstructed coordinates 1132.

Reconstructed mesh 1142 may be, or may include, reconstructed triangles 1122 and reconstructed coordinates 1132. Reconstructed mesh 1142 may be the same as, or may be substantially similar to, latest mesh 1002 of FIG. 10 based on system 1000 compressing and encoding latest mesh 1002 as updates to previous mesh 1022 and based on system 1100 decompressing and decoding encoded data 1102 and applying updates to previous coordinates 1136 and previous triangles 1126.

One or more downstream operations may process reconstructed mesh 1142, for example, to generate virtual content based on reconstructed mesh 1142. For example, a virtual-content generator may anchor virtual content based on reconstructed mesh 1142 and/or perform occlusion-based processing and/or physics-based processing based on reconstructed mesh 1142.

Additionally, system 1100 may store an instance of reconstructed triangles 1122 and an instance of reconstructed coordinates 1132 for further operations. For example, system 1100 may store reconstructed triangles 1122 as previous triangles 1126 and reconstructed coordinates 1132 as previous coordinates 1136 such that when a further instance of encoded data 1102 is received, system 1100 may use the stored instances of reconstructed triangles 1122 and reconstructed coordinates 1132 as previous triangles 1126 and previous coordinates 1136 respectively. Time delay 1124 represents storing reconstructed triangles 1122 in memory for use as previous triangles 1126. Time delay 1134 represents storing reconstructed coordinates 1132 in memory for use as previous coordinates 1136.

Systems and techniques and for compressing and decompressing 3D mesh data are described with regard to FIG. 10 and FIG. 11. In some aspects, the systems and techniques may apply a lossless encoding (e.g., at encoder 1036) and decoding (e.g., at decoder 1104) to the 3D mesh data such that reconstructed mesh 1142 is the same as latest mesh 1002.

The systems and techniques described with regard to FIG. 10 and FIG. 11 may conserve transmission bandwidth and/or power by transmitting updates to previous mesh 1022 rather than re-transmitting all of latest mesh 1002 repeatedly.

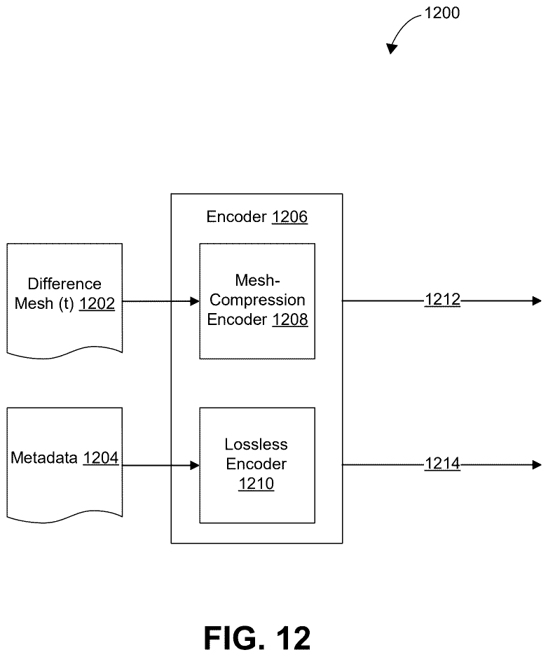

FIG. 12 is a block diagram illustrating an example system 1200 for processing, compressing, encoding, and/or transmitting 3D data, according to various aspects of the present disclosure. Similar to system 1000 of FIG. 10, system 1200 may determine updates to a 3D mesh. System 1200 may generate data indicative of the updates and compress the data as encoded difference mesh 1212 and encoded metadata 1214 and send encoded difference mesh 1212 and encoded metadata 1214 to a server. System 1200 may be another example of an XR device, such as XR device 904 of FIG. 9.

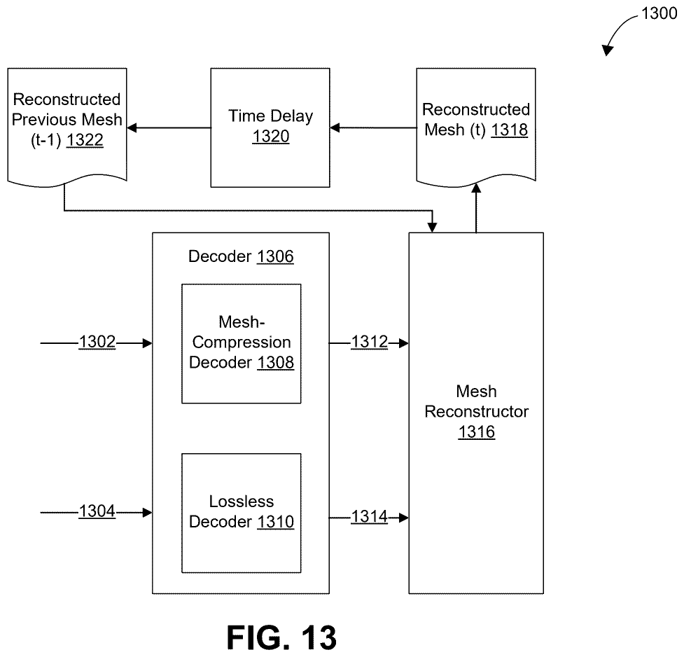

System 1300 of FIG. 13 may receive encoded difference mesh 1212 as encoded difference mesh 1302 and encoded metadata 1214 as encoded metadata 1304. System 1300 may decompress encoded difference mesh 1302 and encoded metadata 1304 to obtain the updates to the previous 3D mesh. Similar to system 1100 of FIG. 11, system 1300 may apply the updates to a local instance of the previous 3D mesh to generate reconstructed mesh 1318. Downstream tasks may perform various operations on reconstructed mesh 1318. System 1300 may be an example of a server, such as server 906 of FIG. 9.

System 1200 of FIG. 12 may be similar to system 1000 of FIG. 10 and system 1300 of FIG. 13 may be similar to system 1100 of FIG. 11. However, whereas system 1000 includes a potentially lossless encoder 1036 and system 1100 includes a potentially lossless decoder 1104, system 1200 may include a mesh-compression encoder and system 1300 may include a mesh-compression decoder. The mesh-compression encoder may be configured to compress 3D meshes and the mesh-compression decoder may be configured to decompress 3D meshes. As such, system 1200 may compress mesh data to a higher compression factor than system 1000 compresses latest mesh 1002 in generating encoded data 1038. However, the mesh-compression encoding of system 1200 may be lossy, whereas the compression of system 1000 may be lossless.

Turning to FIG. 12, in general, system 1200 may obtain a difference mesh 1202 and a metadata 1204 (e.g., from a 3DRU). Encoder 1206 may encode difference mesh 1202 as encoded difference mesh 1212 by using mesh-compression encoder 1208. Additionally, encoder 1206 may encode metadata 1204 as encoded metadata 1214 by using lossless encoder 1210. System 1200 may transmit encoded difference mesh 1212 and encoded metadata 1214 to a server (such as system 1300 of FIG. 13).

Difference mesh 1202 may be, or may include, a 3D mesh including 3D coordinates and triangles that changed since a previous 3D mesh. Similar to latest mesh 1002 of FIG. 10, difference mesh 1202 may include a list of 3D coordinates and a list of triangles that references 3D coordinates as vertices of the triangles. However, dissimilar to latest mesh 1002 of FIG. 10, difference mesh 1202 may include 3D coordinates and triangles that are different between a latest mesh and a previous mesh. For example, a 3DRU, instead of providing latest mesh 1002, may store an instance of previous mesh 1022 and compare a latest mesh 1002 to the stored previous mesh 1022 to determine difference mesh 1202.

Metadata 1204 may be, or may include, a map of 3D coordinates and triangles that are similar, substantially similar to, or the same in the previous 3D mesh and the latest 3D mesh. For example, the 3DRU may generate metadata 1204 to indicate which 3D coordinates and triangles of the previous mesh remain the same in the latest mesh.

In the present disclosure, references to triangles that are the “same” or “similar” in two meshes may indicate that the triangles of both meshes include vertices that are within a search radius one from another. For example, a triangle of a first mesh may include a first vertex at [x₁, y₁, z₁] a second vertex at [x₂, y₂, z₂] and a third vertex at [x₃, y₃, z₃]. A triangle of a second mesh includes a first vertex at [x₁+Δ₁, y₁+Δ₂, z₁+Δ₃] a second vertex at [x₂, y₂, z₂] and a third vertex at [x₃, y₃, z₃]. If [x₁+Δ₁, y₁+Δ₂, z₁+Δ₃] is within the search radius of [x₁, y₁, z₁], then the triangle of the first mesh may be “the same as” or “similar to” the triangle of the second mesh. However, if [x₁+Δ₁, y₁+Δ₂, z₁+Δ₃] is not within the search radius of [x₁, y₁, z₁], then the triangle of the first mesh is not “similar to” or the “same as” the triangle of the second mesh.

Mesh-compression encoder 1208 may encode difference mesh 1202 as encoded difference mesh 1212. Mesh-compression encoder 1208 may be a lossy encoder which may lose some precision in the 3D coordinates. However, mesh-compression encoder 1208 may be able to compress difference mesh 1202 to a higher compression factor than a lossless encoder could compress difference mesh 1202.

Lossless encoder 1210 may compress metadata 1204 as encoded metadata 1214. Lossless encoder 1210 may be lossless. Metadata 1204 may include a map mapping 3D coordinates and/or triangles of a latest mesh to a previous mesh. It may be important that metadata 1204 be encoded in a lossless manner such that relationships between 3D coordinates and/or triangles between the latest mesh and the previous mesh are accurately retained.

System 1200 may transmit encoded difference mesh 1212 and encoded metadata 1214. System 1200 may transmit encoded difference mesh 1212 and encoded metadata 1214 to a server (e.g., system 1300 of FIG. 13) such that the server may decode encoded difference mesh 1212 and encoded metadata 1214, update a local copy of a latest mesh, and perform one or more tasks based on the reconstructed mesh.

FIG. 13 is a block diagram illustrating an example system 1300 for decompressing, decoding, processing, and/or reconstructing 3D data, according to various aspects of the present disclosure. In general, system 1300 may receive encoded difference mesh 1302 and encoded metadata 1304. Decoder 1306 may decompress encoded difference mesh 1302 as difference mesh 1312 using mesh-compression decoder 1308. Decoder 1306 may decompress encoded metadata 1304 as metadata 1314 using lossless decoder 1310. Mesh reconstructor 1316 may apply updates indicated by difference mesh 1312 and metadata 1314 to reconstructed previous mesh 1322 to generate reconstructed mesh 1318.

System 1300 may receive encoded difference mesh 1302. Encoded difference mesh 1302 may be encoded difference mesh 1212 generated by a 3DRU and encoded by mesh-compression encoder 1208 of FIG. 12.

Similarly, system 1300 may receive encoded metadata 1304. Encoded metadata 1304 may be encoded metadata 1214 generated by a 3DRU and encoded by lossless encoder 1210 of FIG. 12.

Mesh-compression decoder 1308 may decode encoded difference mesh 1302 to generate difference mesh 1312. Mesh-compression decoder 1308 may be related to mesh-compression encoder 1208. For example, mesh-compression decoder 1308 may be configured to decode data encoded by mesh-compression encoder 1208. The encoding and decoding may be a lossy process. Difference mesh 1312 may be similar to difference mesh 1202 of FIG. 12. But 3D coordinates of difference mesh 1312 may be different than 3D coordinates of difference mesh 1202 based on the lossy process of encoding and decoding difference mesh 1202.

Lossless decoder 1310 may decode encoded metadata 1304 to generate metadata 1314. Lossless decoder 1310 may be related to lossless encoder 1210 OF FIG. 12. For example, lossless decoder 1310 may be configured to decode data encoded by lossless encoder 1210. The encoding and decoding may be a lossless process. As such, metadata 1314 may be the same as metadata 1204 of FIG. 12.

Mesh reconstructor 1316 may update reconstructed previous mesh 1322 based on updates indicated by difference mesh 1312 and metadata 1314. For example, mesh reconstructor 1316 use 3D coordinates and triangles of reconstructed previous mesh 1322 that are indicated to be the same in the latest mesh as in the previous mesh in encoded metadata 1304 as a base and add 3D coordinates and triangles of encoded difference mesh 1302 to the base. Alternatively, mesh reconstructor 1316 use 3D coordinates and triangles of encoded difference mesh 1302 as a base and add reconstructed previous mesh 1322 that are indicated to be the same in the latest mesh as in the previous mesh in encoded metadata 1304 to the base.

One or more downstream operations may process reconstructed mesh 1318, for example, to generate virtual content based on reconstructed mesh 1318. For example, a virtual-content generator may anchor virtual content based on reconstructed mesh 1318 and/or perform occlusion-based processing and/or physics-based processing based on reconstructed mesh 1318.

Additionally, system 1300 may store an instance of reconstructed mesh 1318 for further operations. For example, system 1300 may store reconstructed mesh 1318 as reconstructed previous mesh 1322 such that when a further instance of encoded difference mesh 1302 and encoded metadata 1304 is received, system 1300 may use the stored instances of reconstructed mesh 1318 as reconstructed previous mesh 1322. Time delay 1320 represents storing reconstructed mesh 1318 (including coordinates and triangles) in memory for use as reconstructed mesh 1322.

Systems and techniques and for compressing and decompressing 3D mesh data are described with regard to FIG. 12 and FIG. 13. The systems and techniques may apply a lossy encoding (e.g., at mesh-compression encoder 1208) and decoding (e.g., at mesh-compression decoder 1308) to the difference mesh such that reconstructed mesh 1318 may not be exactly the same as the latest mesh generated by the 3DRU. Yet, by encoding difference mesh 1202 in a lossy fashion, system 1200 may conserve bandwidth compared with system 1000 of FIG. 10. For example, encoded difference mesh 1212 and encoded metadata 1214 may be smaller to transmit than encoded data 1038.

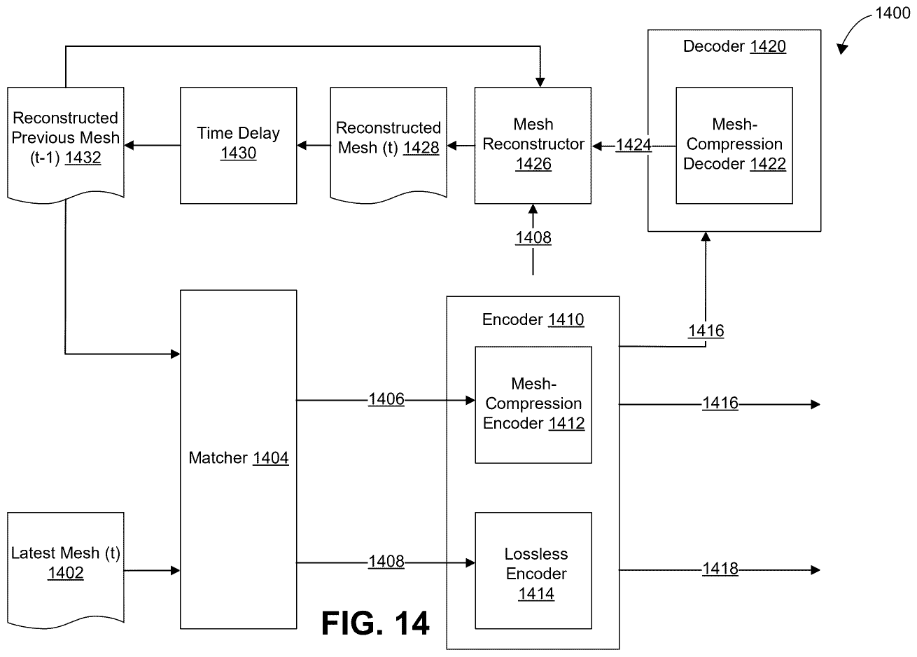

FIG. 14 is a block diagram illustrating an example system 1400 for processing, compressing, encoding, and/or transmitting 3D data, according to various aspects of the present disclosure. Similar to system 1000 of FIG. 10 and system 1200 of FIG. 12, system 1400 may determine updates to a 3D mesh. System 1400 may generate data indicative of the updates and compress the data as encoded difference mesh 1416 and encoded metadata 1418 and send encoded difference mesh 1416 and encoded metadata 1418 to a server. System 1400 may be another example of an XR device, such as XR device 904 of FIG. 9.

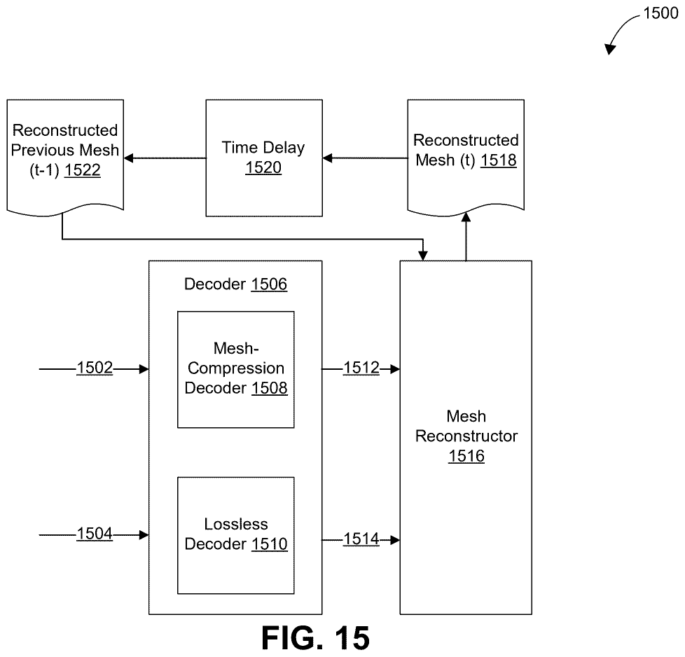

System 1500 of FIG. 15 may receive encoded difference mesh 1416 as encoded difference mesh 1502 and encoded metadata 1418 as encoded metadata 1504. System 1500 may decompress encoded difference mesh 1502 and encoded metadata 1504 to obtain the updates to the previous 3D mesh. Similar to system 1100 of FIG. 11 and system 1300 of FIG. 13, system 1500 may apply the updates to a local instance of the previous 3D mesh to generate reconstructed mesh 1518. Downstream tasks may perform various operations on reconstructed mesh 1518. System 1500 may be an example of a server, such as server 906 of FIG. 9.

System 1400 of FIG. 14 may be similar to system 1000 of FIG. 10 and system 1500 of FIG. 15 may be similar to system 1100 of FIG. 11. However, whereas system 1000 includes a potentially lossless encoder 1036 and system 1100 includes a potentially lossless decoder 1104, system 1400 may include a mesh-compression encoder (e.g., mesh-compression encoder 1412) and system 1500 may include a mesh-compression decoder (e.g., mesh-compression decoder 1508). The mesh-compression encoder may be configured to compress 3D meshes and the mesh-compression decoder may be configured to decompress 3D meshes. As such, system 1400 may compress mesh data to a higher compression factor than system 1000 compresses latest mesh 1002 in generating encoded data 1038. However, the mesh-compression encoding of system 1400 may be lossy, whereas the compression of system 1000 may be lossless.

Additionally, system 1400 of FIG. 14 may be similar to system 1200 of FIG. 12 and system 1500 of FIG. 15 may be similar to system 1300 of FIG. 13. However, whereas system 1200 obtains difference mesh 1202 and metadata 1204 (e.g., from a 3DRU), system 1400 may determine difference mesh 1406 and metadata 1408.

Turning to FIG. 12, in general, system 1400 may obtain a latest mesh 1402 and a matcher 1404 may compare latest mesh 1402 to a reconstructed previous mesh 1432 to determine difference mesh 1406 and metadata 1408. A mesh-compression encoder 1412 of an encoder 1410 may encode difference mesh 1406 as an encoded difference mesh 1416 and a lossless encoder 1414 of encoder 1410 may encode metadata 1408 as encoded metadata 1418. A mesh-compression decoder 1422 of a decoder 1420 may decode encoded difference mesh 1416 as difference mesh 1424. A mesh reconstructor 1426 may generate mesh reconstructor 1426 based on difference mesh 1424, metadata 1408, and reconstructed previous mesh 1432. System 1400 may store reconstructed mesh 1428 as reconstructed previous mesh 1432 for use with a further latest mesh 1402.

Latest mesh 1402 may be the same as, or may be substantially similar to, latest mesh 1002 of FIG. 10. System 1400 may receive latest mesh 1402 from a 3DRU. Latest mesh 1402 may include a list of 3D coordinates and a list of triangles. The list of triangles may reference points of the 3D coordinates.

Matcher 1404 may compare latest mesh 1402 to reconstructed previous mesh 1432 to generate difference mesh 1406 and metadata 1408. For example, matcher 1404 may compare 3D coordinates and triangles of latest mesh 1402 with 3D coordinates and triangles of reconstructed previous mesh 1432 to determine difference mesh 1406 and metadata 1408.

Difference mesh 1406 may be the same as, or may be substantially similar to, difference mesh 1202 of FIG. 12. Similar to latest mesh 1002 of FIG. 10, Difference mesh 1406 may include 3D coordinates and triangles. For example, difference mesh 1406 may include a list of 3D coordinates and a list of triangles that references points of the 3D coordinates. Similar to difference mesh 1202, difference mesh 1406 may include 3D coordinates and triangles that are in latest mesh 1402 and not in reconstructed previous mesh 1432. For example, difference mesh 1406 may include 3D coordinates and triangles that are new in latest mesh 1402.

Metadata 1408 may be the same as, or may be substantially similar to, metadata 1204 of FIG. 12. Metadata 1408 may include indications of triangles that are the same in latest mesh 1402 and reconstructed previous mesh 1432. For example, metadata 1408 may include a map including every triangle in reconstructed previous mesh 1432 and an indication of whether each triangle of reconstructed previous mesh 1432 is in latest mesh 1402. For example, metadata 1408 may include a “1” for each triangle of reconstructed previous mesh 1432 that is in latest mesh 1402 and a “0” for reach triangle of reconstructed previous mesh 1432 that is not in latest mesh 1402.

Mesh-compression encoder 1412 may be the same as, may be substantially similar to, and/or may perform the same, or substantially the same, operations as mesh-compression encoder 1208 of FIG. 12. Mesh-compression encoder 1412 may encode difference mesh 1406 as encoded difference mesh 1416. Mesh-compression encoder 1412 may be a lossy encoder. Additionally, mesh-compression encoder 1412 may be configured for encoding 3D meshes, so mesh-compression encoder 1412 may be able to compress difference mesh 1406 to a higher compression factor than encoder 1036 can compress 3D mesh data.

Lossless encoder 1414 may be the same as, may be substantially similar to, and/or may perform the same, or substantially the same, operations as lossless encoder 1210 of FIG. 12. Lossless encoder 1414 may be a lossless encoder. Lossless encoder 1414 may encode metadata 1408 such that no data is lost.

System 1400 may transmit encoded difference mesh 1416 and encoded metadata 1418 to a server (e.g., system 1500 of FIG. 15). The server may reconstruct latest mesh 1402 based on encoded difference mesh 1416 and encoded metadata 1418 and perform downstream operations on the reconstructed mesh.

Additionally, mesh-compression decoder 1422 may decode encoded difference mesh 1416 to generate difference mesh 1424. Mesh-compression decoder 1422 may be related to mesh-compression encoder 1412. For example, mesh-compression decoder 1422 may be configured to decompress 3D mesh data compressed by mesh-compression encoder 1412. The process of encoding difference mesh 1406 at mesh-compression encoder 1412 and decoding encoded difference mesh 1416 at mesh-compression decoder 1422 may be a lossy process. So, difference mesh 1424 may not be the same as difference mesh 1406. Yet, difference mesh 1424 may be the same as, or may be substantially similar to, encoded difference mesh 1416 as decoded by a decoder of a server (e.g., by mesh-compression decoder 1508 of system 1500).

Mesh reconstructor 1426 may generate reconstructed mesh 1428 based on reconstructed previous mesh 1432, difference mesh 1424, and metadata 1408. For example, mesh reconstructor 1426 may use 3D coordinates and triangles of difference mesh 1424 as a base set of 3D coordinates and triangles. Mesh reconstructor 1426 may add 3D coordinates and triangles of reconstructed previous mesh 1432 that are in latest mesh 1402 based on metadata 1408. For example, mesh reconstructor 1426 may add 3D coordinates and triangles of reconstructed previous mesh 1432 that have a value of “1” in metadata 1408 to the base set of 3D coordinates and triangles. Alternatively, in some aspects, mesh reconstructor 1426 may take the 3D coordinates and triangles of reconstructed previous mesh 1432 that are in latest mesh 1402 (as indicated by metadata 1408) as the base set and add 3D coordinates and triangles of difference mesh 1424 to the base set.

System 1400 may store an instance of reconstructed mesh 1428 for further operations. For example, system 1400 may store reconstructed mesh 1428 as reconstructed previous mesh 1432 such that when a further instance of encoded difference latest mesh 1402 is received, system 1400 may use the stored instances of reconstructed mesh 1428 as reconstructed previous mesh 1432 to determine a further instance of difference mesh 1406 and metadata 1408. Time delay 1430 represents storing reconstructed mesh 1428 (including positions and triangles) in memory for use as reconstructed previous mesh 1432. Additionally, system 1400 may use state machines to keep track of last API call from each client application that request for 3DR mesh data.

FIG. 15 is a block diagram illustrating an example system 1500 for decompressing, decoding, processing, and/or reconstructing 3D data, according to various aspects of the present disclosure. In general, system 1500 may receive encoded difference mesh 1502 and encoded metadata 1504. Decoder 1506 may decompress encoded difference mesh 1502 as difference mesh 1512 using mesh-compression decoder 1508. Decoder 1506 may decompress encoded metadata 1504 as metadata 1514 using lossless decoder 1510. Mesh reconstructor 1516 may apply updates indicated by difference mesh 1512 and metadata 1514 to reconstructed previous mesh 1522 to generate reconstructed mesh 1518.

System 1500 may be the same as, may be substantially similar to, and/or may perform the same, or substantially the same, operations as system 1300 of FIG. 13. For example, encoded difference mesh 1502 may be the same as, or may be substantially similar to, encoded difference mesh 1302, encoded metadata 1504 may be the same as, or may be substantially similar to, encoded metadata 1304, decoder 1506 may be the same as, may be substantially similar to, and/or may perform the same, or substantially the same, operations as decoder 1306, mesh-compression decoder 1508 may be the same as, may be substantially similar to, and/or may perform the same, or substantially the same, operations as mesh-compression decoder 1308, lossless decoder 1510 may be the same as, may be substantially similar to, and/or may perform the same, or substantially the same, operations as lossless decoder 1310, difference mesh 1512 may be the same as, or may be substantially similar to, difference mesh 1312, metadata 1514 may be the same as, or may be substantially similar to, metadata 1314, mesh reconstructor 1516 may be the same as, may be substantially similar to, and/or may perform the same, or substantially the same, operations as mesh reconstructor 1316, reconstructed mesh 1518 may be the same as, or may be substantially similar to, reconstructed mesh 1318, time delay 1520 may be the same as, may be substantially similar to, and/or may perform the same, or substantially the same, operations as time delay 1320, reconstructed previous mesh 1522 may be the same as, or may be substantially similar to, reconstructed previous mesh 1322.

One or more downstream operations may process reconstructed mesh 1518, for example, to generate virtual content based on reconstructed mesh 1518. For example, a virtual-content generator may anchor virtual content based on reconstructed mesh 1518 and/or perform occlusion-based processing and/or physics-based processing based on reconstructed mesh 1518.

Reconstructed mesh 1428 and reconstructed previous mesh 1432 may be the same as, or may be substantially similar to, 3D meshes reconstructed by a server. For example, reconstructed mesh 1428 may be the same as, or may be substantially similar to, reconstructed mesh 1518 of FIG. 15 and reconstructed previous mesh 1432 may be the same as, or may be substantially similar to, reconstructed previous mesh 1522. Reconstructed previous mesh 1432 may be the same as reconstructed previous mesh 1522 based on system 1400 implementing the same decoding and reconstruction operations to generate reconstructed previous mesh 1432 based on encoded difference mesh 1416 and metadata 1408 as system 1500 takes to generate reconstructed previous mesh 1522 based on encoded difference mesh 1502 and metadata 1514. Because reconstructed previous mesh 1432 and reconstructed previous mesh 1522 are the same, system 1400 and system 1500 may be in sync. For example, because reconstructed previous mesh 1432 and reconstructed previous mesh 1522 are the same, matcher 1404 may determine difference mesh 1406 and metadata 1408 based on reconstructed previous mesh 1432 and latest mesh 1402 and mesh reconstructor 1516 may generate reconstructed mesh 1518 to be the same as reconstructed mesh 1428 based on encoded difference mesh 1502 and encoded metadata 1504.

Systems and techniques and for compressing and decompressing 3D mesh data are described with regard to FIG. 14 and FIG. 15. The systems and techniques may apply a lossy encoding (e.g., at mesh-compression encoder 1412) and decoding (e.g., at mesh-compression decoder 1508) to the encoded difference mesh 1416 such that reconstructed mesh 1518 may not be exactly the same as latest mesh 1402. Yet, by encoding encoded difference mesh 1416 in a lossy fashion, system 1400 may conserve bandwidth compared with system 1000 of FIG. 10. For example, encoded difference mesh 1416 and encoded metadata 1418 may be smaller to transmit than encoded data 1038.

System 1400 of FIG. 14 and system 1500 of FIG. 15 may be similar to system 1200 of FIG. 12 and system 1300 of FIG. 13. However, system 1400 may generate difference mesh 1406 and metadata 1408 whereas system 1200 obtains difference mesh 1202 (e.g., system 1200 receives difference mesh 1202 from a 3DRU).

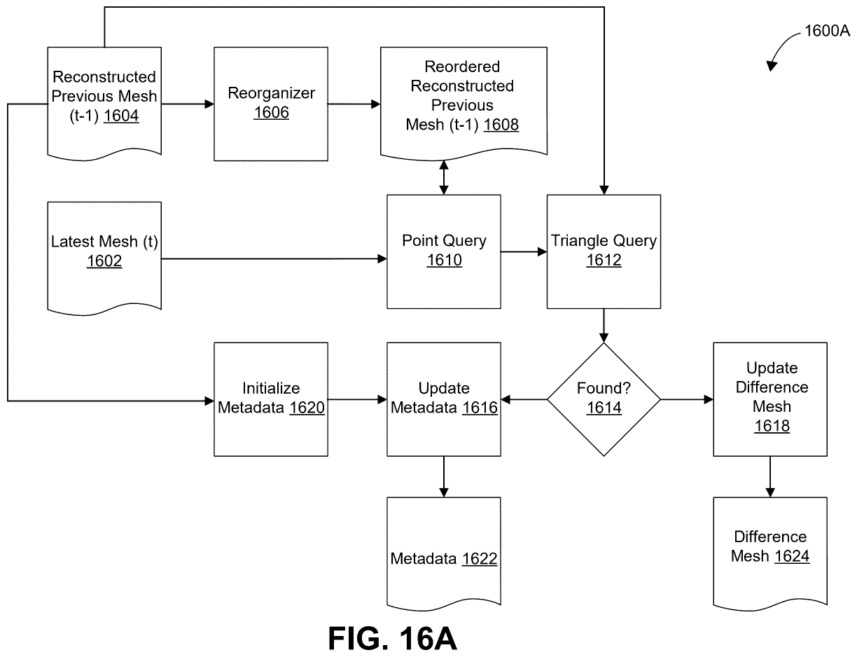

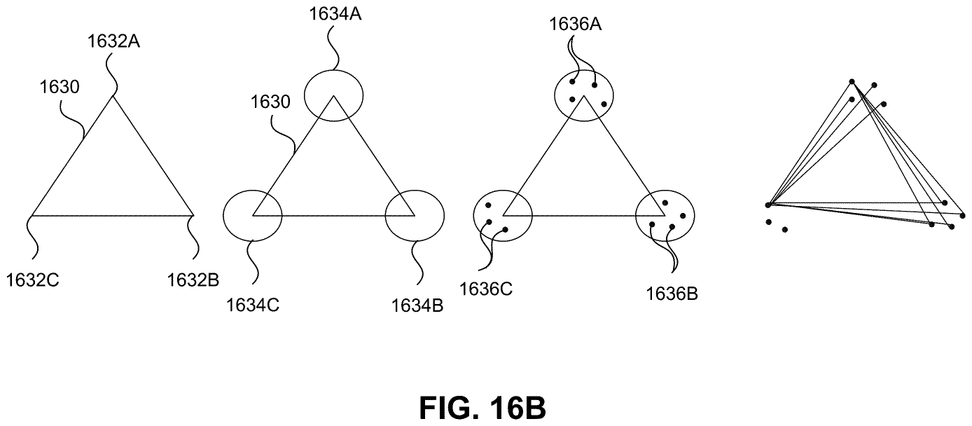

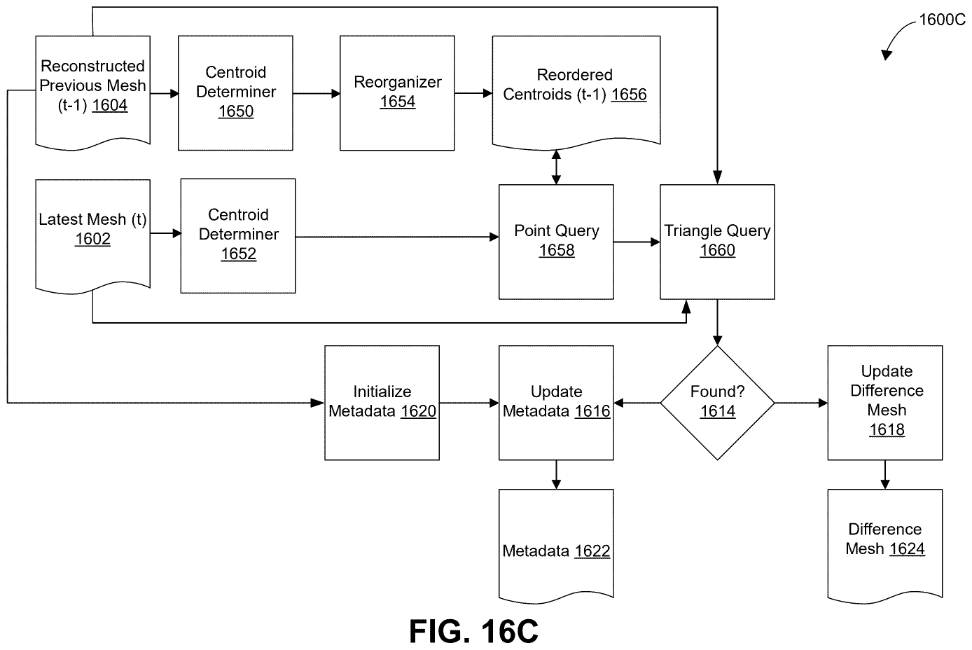

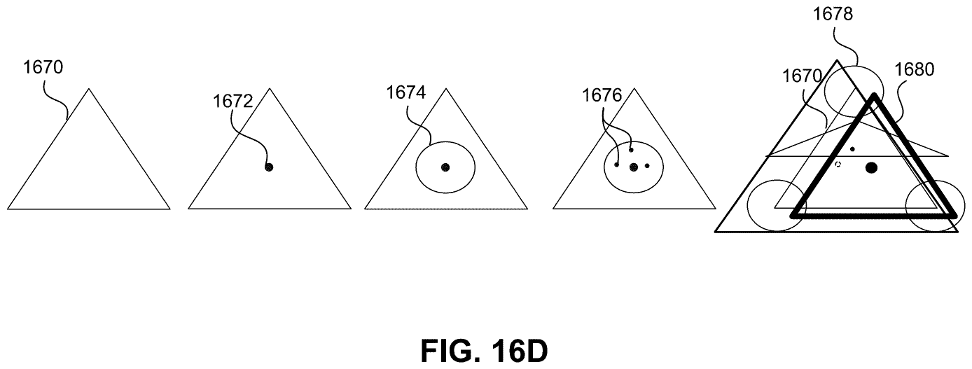

FIG. 16A is a hybrid system-flowchart diagram illustrating example algorithms and operations that may be performed to generate a difference mesh and metadata, according to various aspects of the present disclosure. In some aspects, a 3DRU may perform operations that are the same as, or substantially similar to, the operations described with regard to system 1600A to generate difference mesh 1202 and metadata 1204 of FIG. 12. In some aspects, matcher 1404 of FIG. 14 may perform operations that are the same as, or substantially similar to, the operations described with regard to FIG. 16A.

System 1600A may generate difference mesh 1624 and metadata 1622 by matching triangles from latest mesh 1602 with triangles from reconstructed previous mesh 1604. In some aspects, system 1600A may use K-D tree-based matching to improve system 1600A. System 1600A may align latest mesh 1602 and reconstructed previous mesh 1604 to find triangle correspondences, whose vertices might not perfectly match with each other.

System 1600A may obtain latest mesh 1602 and reconstructed previous mesh 1604. Latest mesh 1602 may be an example of latest mesh 1402 of FIG. 14. Reconstructed previous mesh 1604 may be an example of reconstructed previous mesh 1432 of FIG. 14.

In some aspects, a reorganizer 1606 may reorganize reconstructed previous mesh 1604 to generate reordered reconstructed previous mesh 1608. For example, reorganizer 1606 may reorganize 3D coordinates of reconstructed previous mesh 1604 according to a K-D tree organization to generate reordered reconstructed previous mesh 1608—a K-D tree. Reorganizing reorganizer 1606 into a K-D tree may improve the speed or efficiency of downstream tasks, such as point query 1610. In other aspects, reorganizer 1606 may be omitted and point query 1610 may query reconstructed previous mesh 1604.

Point query 1610 may, for every triangle in latest mesh 1602, query (e.g., perform a K-D tree query) on reordered reconstructed previous mesh 1608 to find a set of closest 3D coordinates based on a search radius. For example, point query 1610 may, for each triangle of latest mesh 1602, determine all 3D coordinates of reordered reconstructed previous mesh 1608 that are within a search radius of each vertex of the triangle. In the present disclosure, 3D coordinates may be referred to as “substantially the same” if the 3D coordinates are within a search radius of one another.

If any 3D coordinates of reordered reconstructed previous mesh 1608 are within the search radius from one or more of the vertices of a given triangle, triangle query 1612 may determine if a triangle of reconstructed previous mesh 1604 matches the given triangle.

For example, triangle 1630 of FIG. 16B is an example of a triangle of latest mesh 1602. Triangle 1630 includes three vertices (e.g., vertex 1632A, vertex 1632B, and vertex 1632C). For each vertex, point query 1610 may determine all 3D coordinates of reordered reconstructed previous mesh 1608 that are within a search radius. For example, point query 1610 may determine all points of previous mesh 1608 that are within search radius 1634A of vertex 1632A (e.g., points 1636A), all points of previous mesh 1608 that are within search radius 1634B of vertex 1632B (e.g., points 1636B), and all points of previous mesh 1608 that are within search radius 1634C of vertex 1632C (e.g., points 1636C).

For instance four 3D coordinates of reordered reconstructed previous mesh 1608 (e.g., points 1636A) may be within search radius 1634A of vertex 1632A. Additionally, four 3D coordinates of reordered reconstructed previous mesh 1608 (e.g. points 1636B) may be within search radius 1634B of vertex 1632B. Additionally, three 3D coordinate of reordered reconstructed previous mesh 1608 (e.g., points 1636C) may be within search radius 1634C of vertex 1632C. Triangle query 1612 may determine if one of the four 3D coordinates related to vertex 1632A (e.g., points 1636A), one of the four 3D coordinates related to vertex 1632B (e.g., points 1636B) and one of the three 3D coordinate related to vertex 1632C (e.g., points 1636C) form a triangle in the triangle list of reordered reconstructed previous mesh 1608. If the vertices of triangle 1630 of latest mesh 1602 match a triangle from the triangle list of reordered reconstructed previous mesh 1608, triangle 1630 of latest mesh 1602 and/or the triangle of the triangle list of reordered reconstructed previous mesh 1608 may be referred to as a “matching triangle” or as “matching triangles.”

To determine whether a given triangle of latest mesh 1602 (e.g., triangle 1630) matches a triangle of previous mesh 1608, triangle query 1612 may, for all vertices in the given triangle (e.g., vertices 1632A, 1632B, and 1632C), query for points in previous mesh within a search radius (e.g., search radii 1634A, 1634B, and 1634C). Further, triangle query 1612 may create all possible combination of triangles based on the output of search query (e.g., all possible triangles including one of points 1636A, one of points 1636B, and one of points 1636C). Then, triangle query 1612 may search for the exact match of triangle 1630 in triangles of reconstructed previous mesh 1604. Create all possible triangles based on the results of search may lead to creating many invalid triangles (e.g., triangles that do not exist in reconstructed previous mesh 1604). The number of possible triangles may be large. Such creation of triangles and comparisons may be computationally expensive.

FIG. 16C is a hybrid system-flowchart diagram illustrating example algorithms and operations that may be performed to generate a difference mesh and metadata, according to various aspects of the present disclosure. System 1600C of FIG. 16C is an alternative to system 1600A of FIG. 16A. In some aspects, a 3DRU may perform operations that are the same as, or substantially similar to, the operations described with regard to system 1600C to generate difference mesh 1202 and metadata 1204 of FIG. 12. In some aspects, matcher 1404 of FIG. 14 may perform operations that are the same as, or substantially similar to, the operations described with regard to FIG. 16C.

System 1600C has many of the same elements as system 1600A. Such elements perform the same, or substantially the same, operations in system 1600C as they do in system 1600A. For example, latest mesh 1602 may be the same in system 1600A and system 1600C. Similarly, reconstructed previous mesh 1604 may be the same in system 1600A and system 1600C.

In contrast, in system 1600C, centroid determiner 1650 may determine a point that is representative of each triangle of reconstructed previous mesh 1604 (e.g., a centroid of each triangle of reconstructed previous mesh 1604). Similarly centroid determiner 1652 may determine a point of each triangle of latest mesh 1602 (e.g., a centroid of each triangle of latest mesh 1602).

Further, reorganizer 1654 may organize centroids determine by centroid determiner 1650 to generate reordered centroids 1656. Point query 1658 may compare centroids of latest mesh 1602 (e.g., as determined by similarly centroid determiner 1652) with centroids determined by centroid determiner 1650. Further, triangle query 1660 may compare triangles of latest mesh 1602 with triangles of reconstructed previous mesh 1604 to find matching triangles.

For instance, FIG. 16D includes an example triangle 1670. Similarly centroid determiner 1652 may determine centroid 1672 of triangle 1670. Point query 1658 may identify a number of centroids 1676 of triangles of reconstructed previous mesh 1604 that are within a search radius 1674 of centroid 1672. For example, point query 1658 may identify centroids from among the centroids of reconstructed previous mesh 1604 (determined by centroid determiner 1650) that are within search radius 1674 of centroid 1672. Triangle query 1660 may evaluate each triangle from the query result to find a triangle with vertices within a search radius of the current triangle (e.g., triangle 1670). and the triangle are close (older matching algorithm's search constraint). For example, for each of centroids 1676 within search radius 1674 of centroid 1672, triangle query 1660 may identify a triangle. Triangle query 1660 may compare the vertices of the corresponding triangles with the vertices of triangle 1670 to determine whether any of the corresponding triangles match triangle 1670. For example, triangle query 1660 may determine that a triangle 1680 matches with triangle 1670 based on triangle 1680 having vertices that are within a search radius 1678 of each of the vertices of triangle 1670.

The remainder of system 1600A and system 1600C may be substantially the same. Therefore, continuing with the description of FIG. 16A and FIG. 16C, at decision block 1614, if a triangle of reconstructed previous mesh 1604 includes 3D coordinates determined to be within the search radius of to the vertices of the triangle of latest mesh 1602 (e.g., as determined by either update metadata 1616 of system 1600A or triangle query 1660 of system 1600C), then at update metadata 1616, metadata 1622 may be updated to include an indication of the triangle of reconstructed previous mesh 1604.

For example, prior to update metadata 1616, initialize metadata 1620 may generate a map based on reconstructed previous mesh 1604. The map may be an initial instance of metadata 1622. Metadata 1622 may be an example of metadata 1408 of FIG. 14. Metadata 1622 may include a value for each triangle of reconstructed previous mesh 1604. Metadata 1622 may, at the end of the operations of system 1600A include an indication whether each triangle of reconstructed previous mesh 1604 is present in latest mesh 1602 or not. For example, metadata 1622 may include a “1” for triangles of reconstructed previous mesh 1604 that are present in latest mesh 1602 and a “0” for triangles of reconstructed previous mesh 1604 that are not present in latest mesh 1602.

At decision block 1614, if no triangle of reconstructed previous mesh 1604 includes 3D coordinates determined to be within the search radius of to the vertices of the triangle of latest mesh 1602 (e.g., as determined by either update metadata 1616 of system 1600A or triangle query 1660 of system 1600C), then at update difference mesh 1618, difference mesh 1624 may be updated to include the 3D coordinates of the vertices of the triangle of latest mesh 1602. If no triangle of reconstructed previous mesh 1604 includes 3D coordinates determined to be within the search radius of to the vertices of the triangle of latest mesh 1602, then the triangle of latest mesh 1602 may be referred to as a “non-matching triangle.” Difference mesh 1624 may include a list of 3D coordinates and a list of triangles that references 3D coordinates as vertices of the triangles. At update difference mesh 1618, the list of 3D coordinates may be updated to include the 3D coordinates of the vertices of the triangle of latest mesh 1602 and the list of triangles may be updated to include the triangle of latest mesh 1602.

Difference mesh 1624 may be an example of difference mesh 1406 of FIG. 14. Difference mesh 1624 may, at the end of the operations of system 1600A, include 3D coordinates and triangles for each 3D coordinates and triangle of latest mesh 1602 that is not present in reconstructed previous mesh 1604.

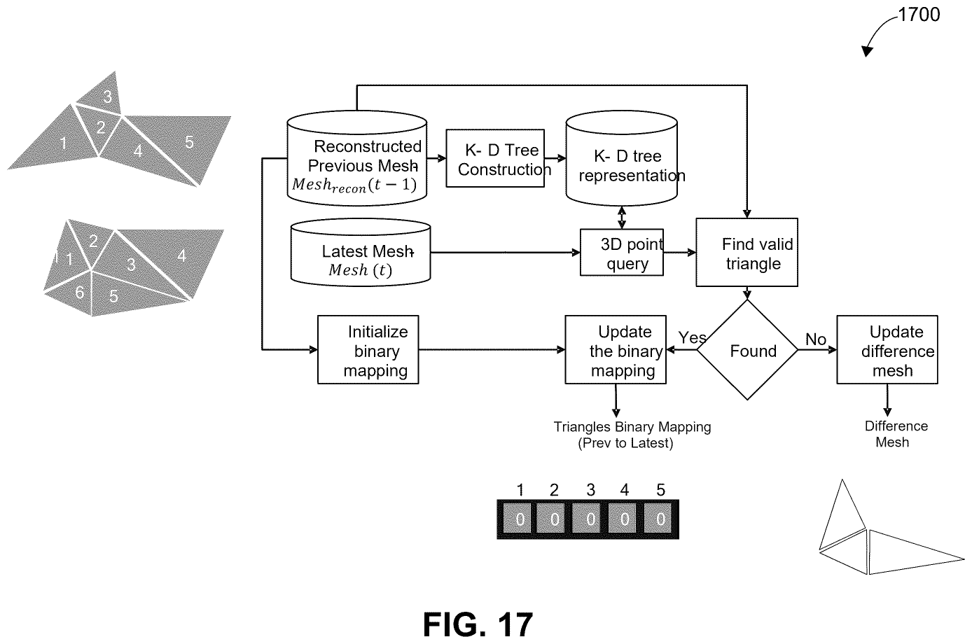

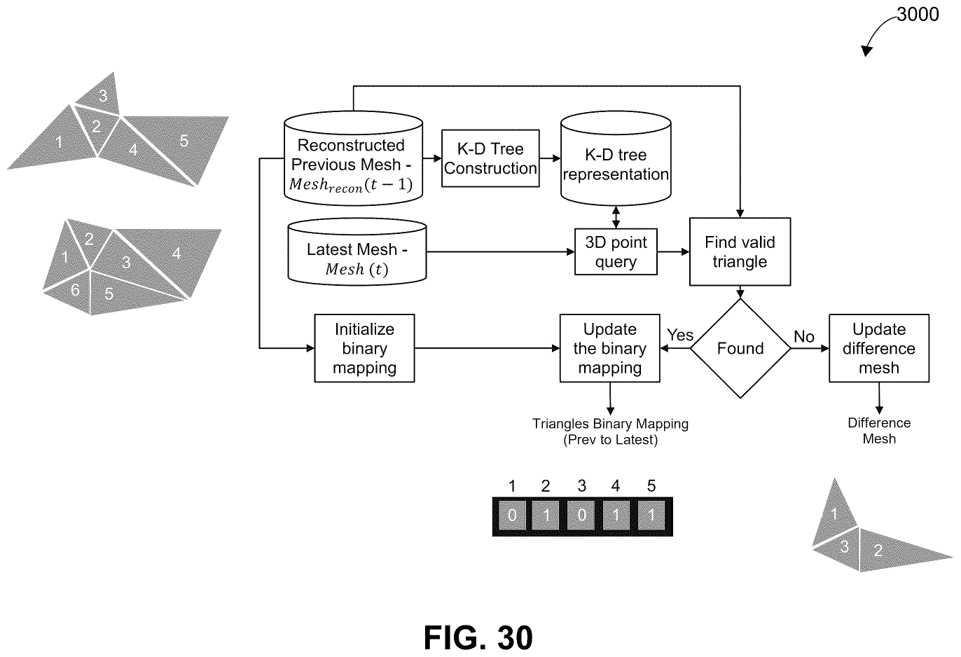

Each of FIG. 17 through FIG. 30 is a diagram illustrating a respective step in an example process of generating a difference mesh and metadata, according to various aspects of the present disclosure. Although FIG. 17 through FIG. 30 includes a representation of system 1600A, the various steps may be respective steps in operations of system 1600A of FIG. 16A and/or a step in operations of system 1600C of FIG. 16C. The descriptions of step 1700 of FIG. 17 through step 3000 of FIG. 30, is provided relative to operations of system 1600A. However, the principles described apply equally to system 1600C. Latest mesh 1602 and reconstructed previous mesh 1604 are depicted in FIG. 17 through FIG. 30 as groups of triangles.

FIG. 17 is a diagram illustrating a step 1700 in an example process of generating a difference mesh and metadata, according to various aspects of the present disclosure. Step 1700 may be a step in operations of system 1600A of FIG. 16A. At step 1700, system 1600A, 1600C, or other system described herein may obtain a latest mesh 1602 and a reconstructed previous mesh 1604.

At step 1700, initialize metadata 1620 may initialize metadata 1622. Metadata 1622 is depicted in in FIG. 17 through FIG. 30 as a binary map including five values corresponding to the five triangles of reconstructed previous mesh 1604.

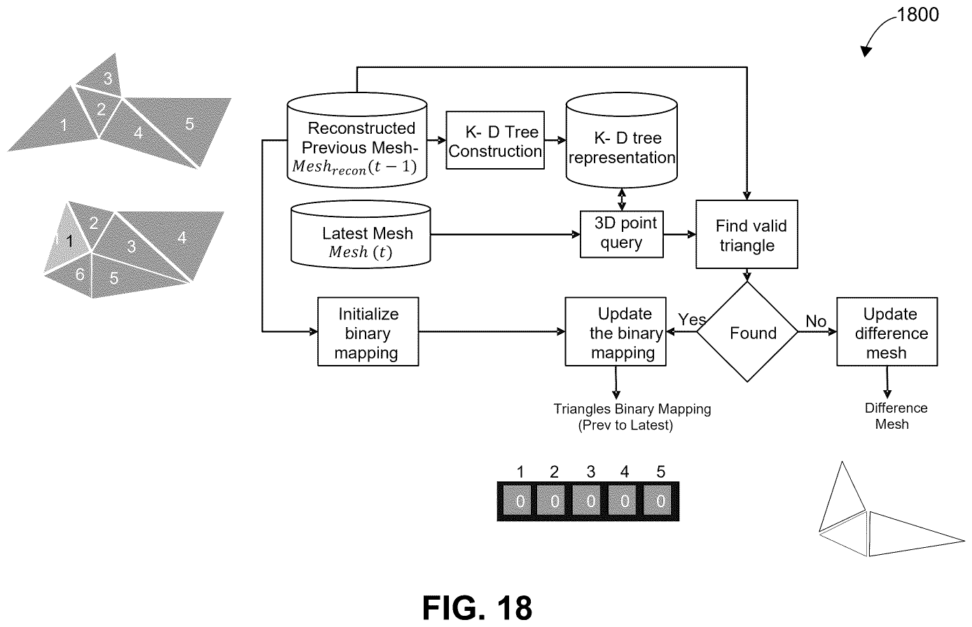

FIG. 18 is a diagram illustrating a step 1800 in an example process of generating a difference mesh and metadata, according to various aspects of the present disclosure. Step 1800 may be a step in operations of system 1600A of FIG. 16A. Step 1800 may follow step 1700 of FIG. 17.

At step 1800, a first triangle (e.g., triangle 1) of latest mesh 1602 may be selected. Point query 1610 may compare each vertex of the selected triangle to 3D coordinates of reordered reconstructed previous mesh 1608 to determine how many, if any, 3D coordinates of reordered reconstructed previous mesh 1608 are within a search radius of the vertices of the selected triangle.

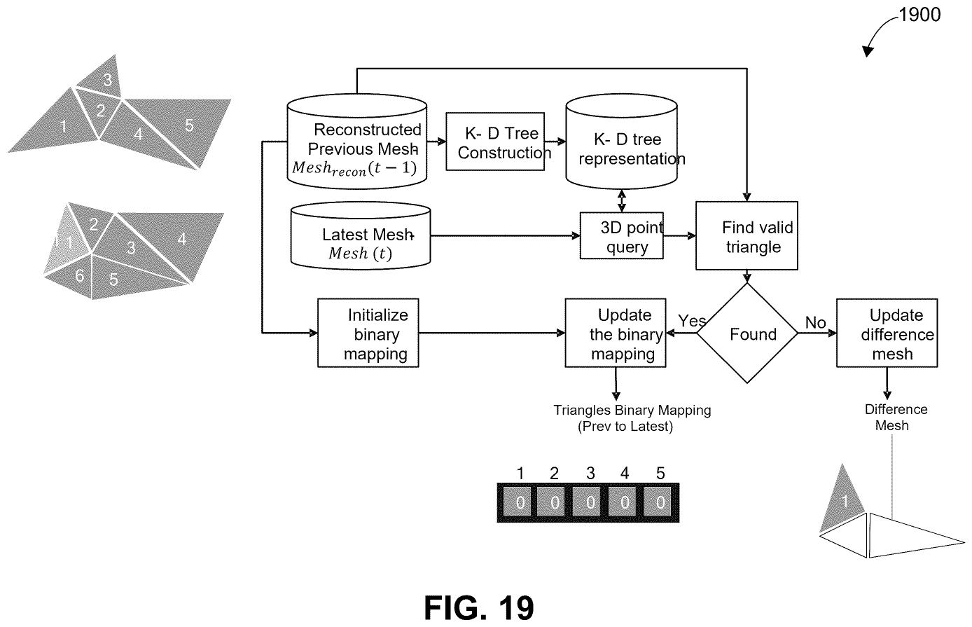

FIG. 19 is a diagram illustrating a step 1900 in an example process of generating a difference mesh and metadata, according to various aspects of the present disclosure. Step 1900 may be a step in operations of system 1600A of FIG. 16A. Step 1900 may follow step 1800 of FIG. 10.

At step 1900, the 3D coordinates of reordered reconstructed previous mesh 1608 that are within the search radius of the vertices of the triangle selected at step 1800 (e.g., triangle 1 of latest mesh 1602) may be compared to the triangles of reconstructed previous mesh 1604 to determine whether the 3D coordinates that are within the search radius of the vertices of the triangle selected at step 1800 (e.g., triangle 1 of latest mesh 1602) match a triangle of reconstructed previous mesh 1604.

According to the example of step 1900, one vertex of triangle 1 of latest mesh 1602 is different from the vertices of the triangles of reconstructed previous mesh 1604. In other words, there is no triangle in the reconstructed previous mesh 1604 that has vertices that correspond to all three vertices of triangle 1 of latest mesh 1602. Thus, no triangle of reconstructed previous mesh 1604 matches the triangle of latest mesh 1602 selected at step 1800 (e.g., triangle 1 of latest mesh 1602). So, update difference mesh 1618 adds the triangle selected at step 1800 (e.g., triangle 1 of latest mesh 1602) to difference mesh 1624. In further detail, update difference mesh 1618 adds the 3D coordinates of the vertex of triangle 1 that does not match with a vertex of a triangle of reconstructed previous mesh 1624 to difference mesh 1624. Further, update difference mesh adds triangle 1 of latest mesh 1602 (e.g., an association between the vertices of triangle 1) to a triangle list of difference mesh 1624. Difference mesh 1624 is depicted in FIG. 17 through FIG. 30 as groups of triangles.

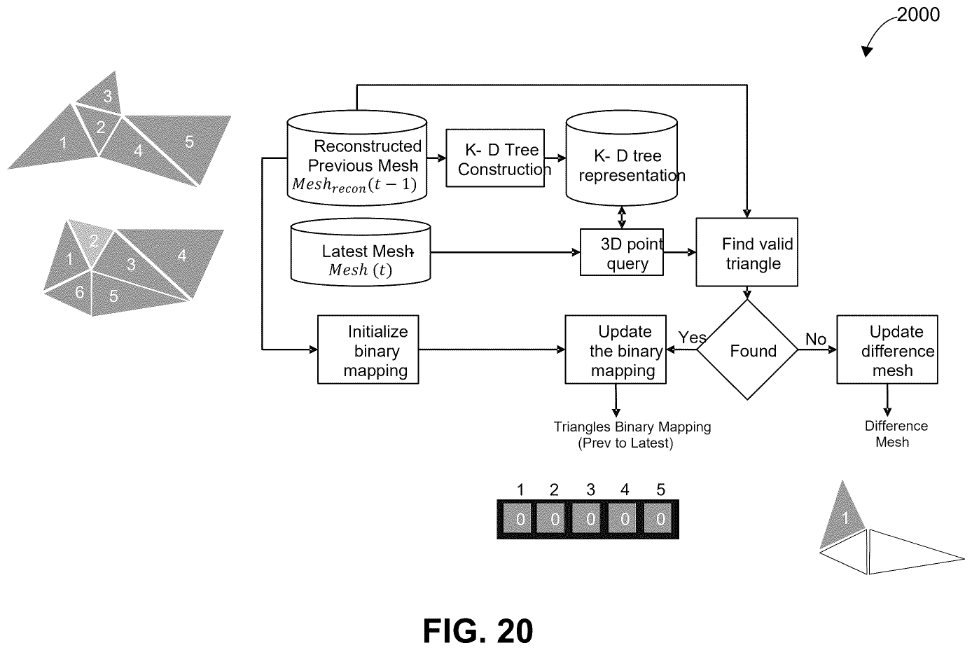

FIG. 20 is a diagram illustrating a step 2000 in an example process of generating a difference mesh and metadata, according to various aspects of the present disclosure. Step 2000 may be a step in operations of system 1600A of FIG. 16A. Step 2000 may follow step 1900 of FIG. 19.

At step 2000, a second triangle (e.g., triangle 2) of latest mesh 1602 may be selected. Point query 1610 may compare each vertex of the selected triangle to 3D coordinates of reordered reconstructed previous mesh 1608 to determine how many, if any, 3D coordinates of reordered reconstructed previous mesh 1608 are within a search radius of the vertices of the selected triangle.

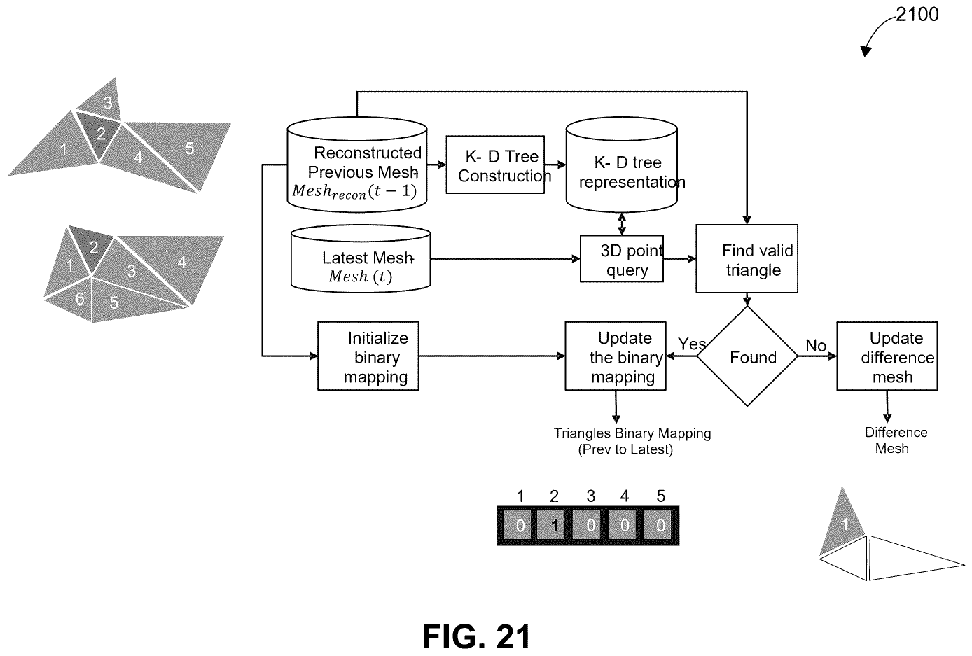

FIG. 21 is a diagram illustrating a step 2100 in an example process of generating a difference mesh and metadata, according to various aspects of the present disclosure. Step 2100 may be a step in operations of system 1600A of FIG. 16A. Step 2100 may follow step 2000 of FIG. 20.

At step 2100, the 3D coordinates of reordered reconstructed previous mesh 1608 that are within the search radius of the vertices of the triangle selected at step 2000 may be compared to the triangles of reconstructed previous mesh 1604 to determine whether the 3D coordinates that are within the search radius of the vertices of the triangle selected at step 2000 match a triangle of reconstructed previous mesh 1604.

According to the example of step 2100, the vertices of triangle 2 of latest mesh 1602 match the vertices of triangle 2 of reconstructed previous mesh 1604. So, update metadata 1616 updates metadata 1622 to include a “1” related to triangle 2 of reconstructed previous mesh 1604 indicating that triangle 2 of reconstructed previous mesh 1604 is included in latest mesh 1602.

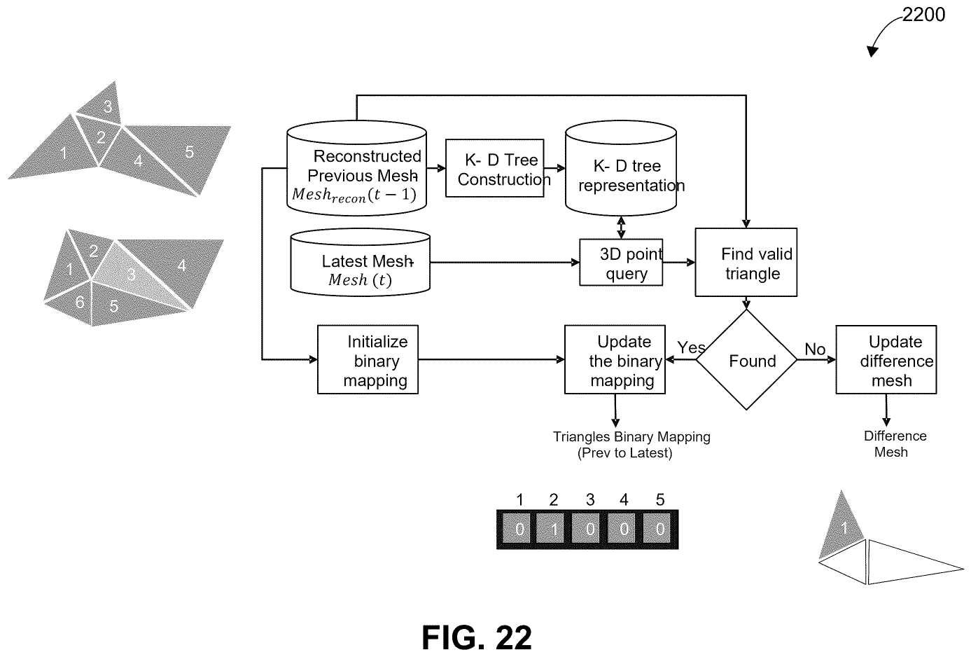

FIG. 22 is a diagram illustrating a step 2200 in an example process of generating a difference mesh and metadata, according to various aspects of the present disclosure. Step 2200 may be a step in operations of system 1600A of FIG. 16A. Step 2200 may follow step 2100 of FIG. 21.

At step 2200, a third triangle (e.g., triangle 3) of latest mesh 1602 may be selected. Point query 1610 may compare each vertex of the selected triangle to 3D coordinates of reordered reconstructed previous mesh 1608 to determine how many, if any, 3D coordinates of reordered reconstructed previous mesh 1608 are within a search radius of the vertices of the selected triangle.

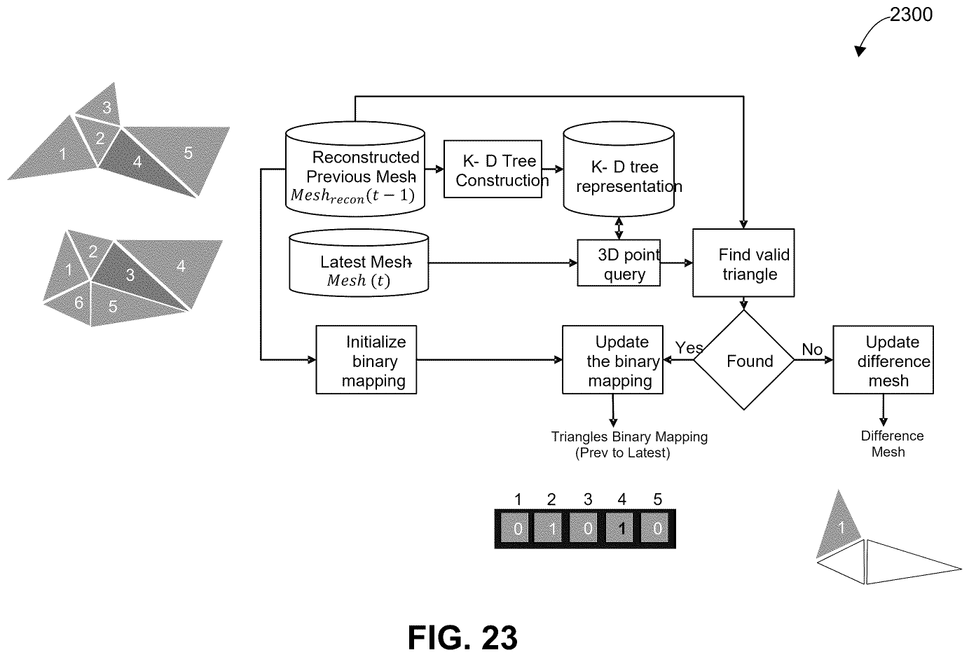

FIG. 23 is a diagram illustrating a step 2300 in an example process of generating a difference mesh and metadata, according to various aspects of the present disclosure. Step 2300 may be a step in operations of system 1600A of FIG. 16A. Step 2300 may follow step 2200 of FIG. 22.

At step 2300, the 3D coordinates of reordered reconstructed previous mesh 1608 that are within the search radius of the vertices of the triangle selected at step 2200 may be compared to the triangles of reconstructed previous mesh 1604 to determine whether the 3D coordinates that are within the search radius of the vertices of the triangle selected at step 2200 match a triangle of reconstructed previous mesh 1604.

According to the example of step 2300, the vertices of triangle 3 of latest mesh 1602 match the vertices of triangle 4 of reconstructed previous mesh 1604. So, update metadata 1616 updates metadata 1622 to include a “1” related to triangle 4 of reconstructed previous mesh 1604 indicating that triangle 4 of reconstructed previous mesh 1604 is included in latest mesh 1602.

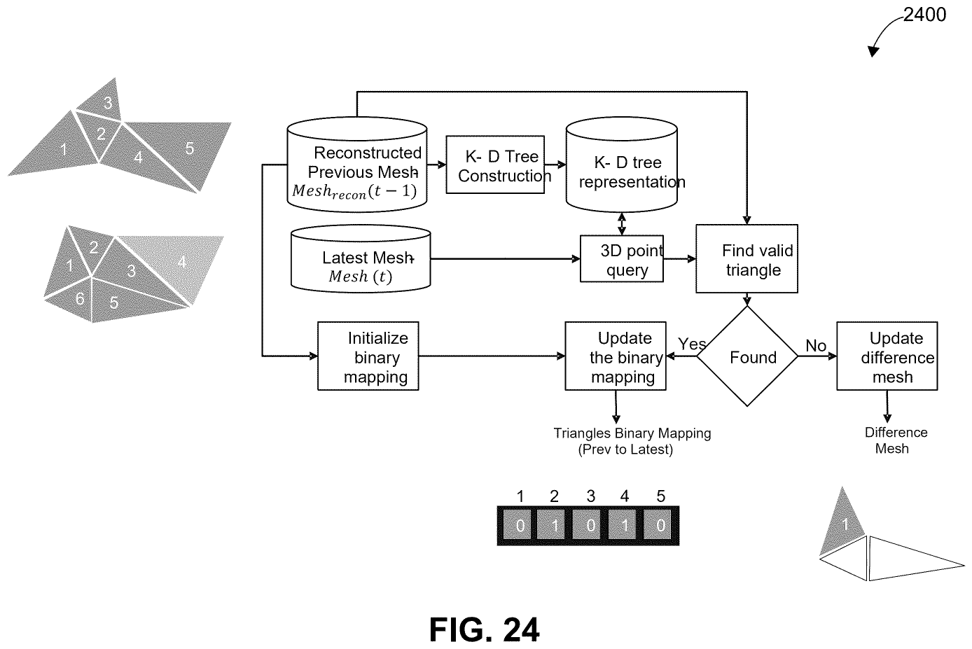

FIG. 24 is a diagram illustrating a step 2400 in an example process of generating a difference mesh and metadata, according to various aspects of the present disclosure. Step 2400 may be a step in operations of system 1600A of FIG. 16A. Step 2400 may follow step 2300 of FIG. 23.

At step 2400, a fourth triangle (e.g., triangle 4) of latest mesh 1602 may be selected. Point query 1610 may compare each vertex of the selected triangle to 3D coordinates of reordered reconstructed previous mesh 1608 to determine how many, if any, 3D coordinates of reordered reconstructed previous mesh 1608 are within a search radius of the vertices of the selected triangle.

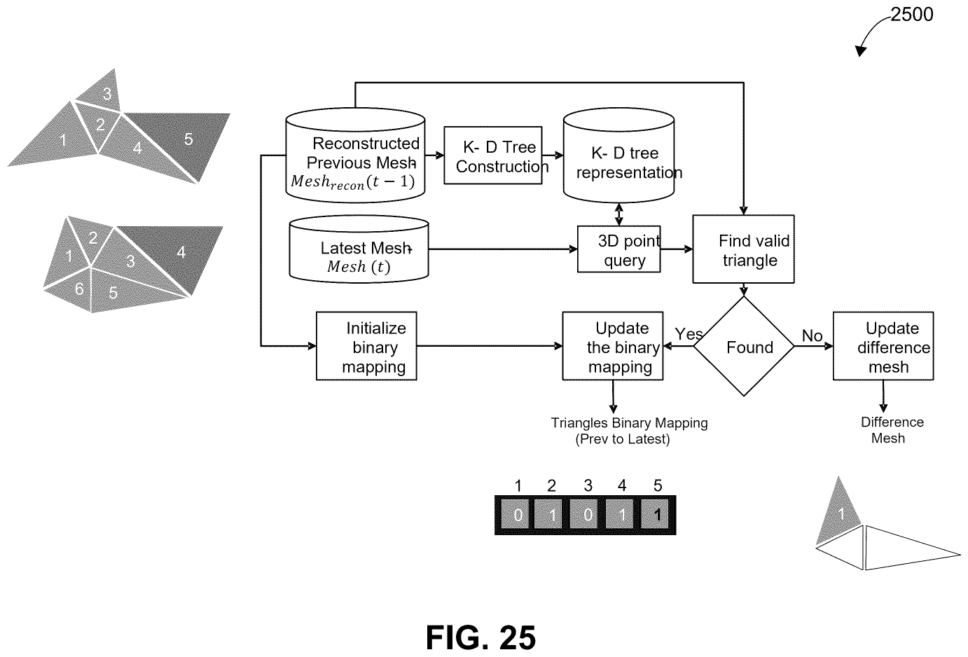

FIG. 25 is a diagram illustrating a step 2500 in an example process of generating a difference mesh and metadata, according to various aspects of the present disclosure. Step 2500 may be a step in operations of system 1600A of FIG. 16A. Step 2500 may follow step 2400 of FIG. 24.

At step 2500, the 3D coordinates of reordered reconstructed previous mesh 1608 that are within the search radius of the vertices of the triangle selected at step 2400 may be compared to the triangles of reconstructed previous mesh 1604 to determine whether the 3D coordinates that are within the search radius of the vertices of the triangle selected at step 2400 match a triangle of reconstructed previous mesh 1604.

According to the example of step 2500, the vertices of triangle 4 of latest mesh 1602 match the vertices of triangle 5 of reconstructed previous mesh 1604. So, update metadata 1616 updates metadata 1622 to include a “1” related to triangle 5 of reconstructed previous mesh 1604 indicating that triangle 5 of reconstructed previous mesh 1604 is included in latest mesh 1602.

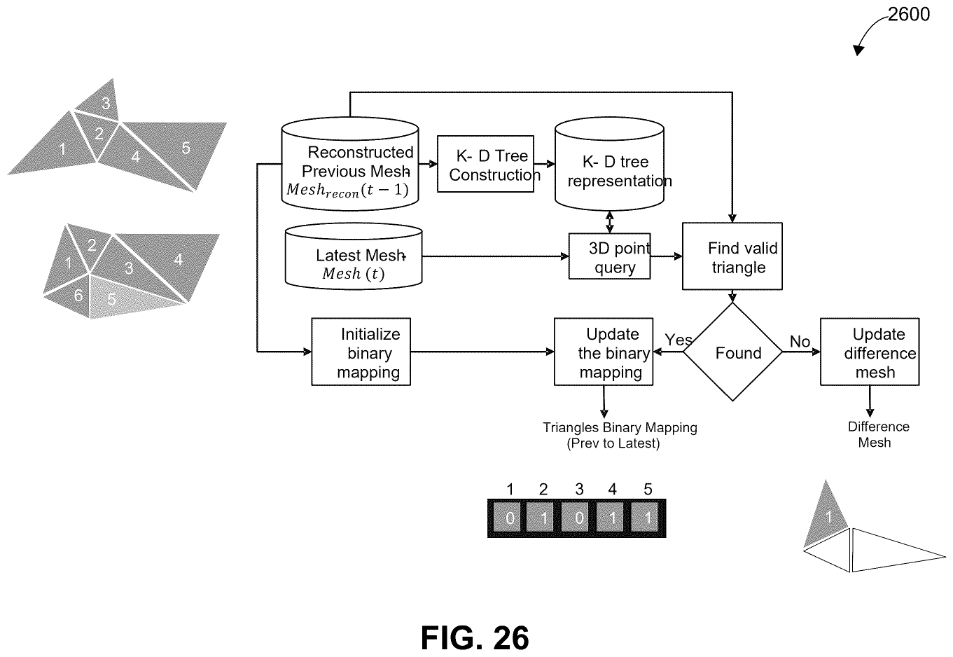

FIG. 26 is a diagram illustrating a step 2600 in an example process of generating a difference mesh and metadata, according to various aspects of the present disclosure. Step 2600 may be a step in operations of system 1600A of FIG. 16A. Step 2600 may follow step 2500 of FIG. 25.

At step 2600, a fifth triangle (e.g., triangle 5) of latest mesh 1602 may be selected. Point query 1610 may compare each vertex of the selected triangle to 3D coordinates of reordered reconstructed previous mesh 1608 to determine how many, if any, 3D coordinates of reordered reconstructed previous mesh 1608 are within a search radius of the vertices of the selected triangle.

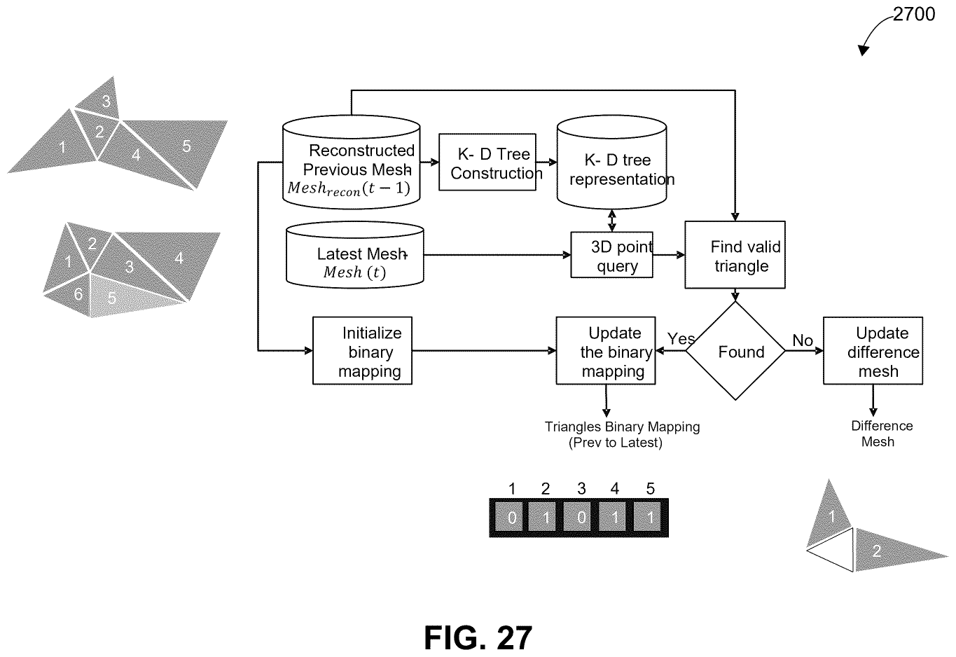

FIG. 27 is a diagram illustrating a step 2700 in an example process of generating a difference mesh and metadata, according to various aspects of the present disclosure. Step 2700 may be a step in operations of system 1600A of FIG. 16A. Step 2700 may follow step 2600 of FIG. 26.

At step 2700, the 3D coordinates of reordered reconstructed previous mesh 1608 that are within the search radius of the vertices of the triangle selected at step 2600 (e.g., triangle 5 of latest mesh 1602) may be compared to the triangles of reconstructed previous mesh 1604 to determine whether the 3D coordinates that are within the search radius of the vertices of the triangle selected at step 2600 (e.g., triangle 5 of latest mesh 1602) match a triangle of reconstructed previous mesh 1604.

According to the example of step 2700, no triangle of reconstructed previous mesh 1604 matches the triangle of latest mesh 1602 selected at step 2600 (e.g., triangle 5 of latest mesh 1602). So, update difference mesh 1618 adds the triangle selected at step 2600 (e.g., triangle 5 of latest mesh 1602) to difference mesh 1624. Triangle 5 of latest mesh 1602 is added as triangle 2 of difference mesh 1624 based on triangle 5 of latest mesh 1602 being added to difference mesh 1624 second.

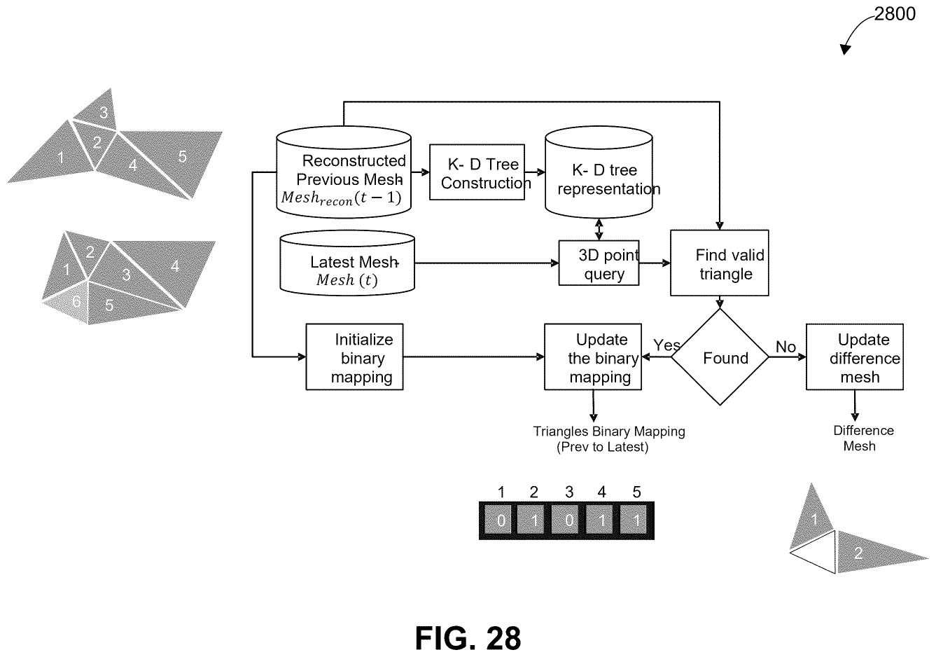

FIG. 28 is a diagram illustrating a step 2800 in an example process of generating a difference mesh and metadata, according to various aspects of the present disclosure. Step 2800 may be a step in operations of system 1600A of FIG. 16A. Step 2800 may follow step 2700 of FIG. 27.

At step 2800, a sixth triangle (e.g., triangle 6) of latest mesh 1602 may be selected. Point query 1610 may compare each vertex of the selected triangle to 3D coordinates of reordered reconstructed previous mesh 1608 to determine how many, if any, 3D coordinates of reordered reconstructed previous mesh 1608 are within a search radius of the vertices of the selected triangle.

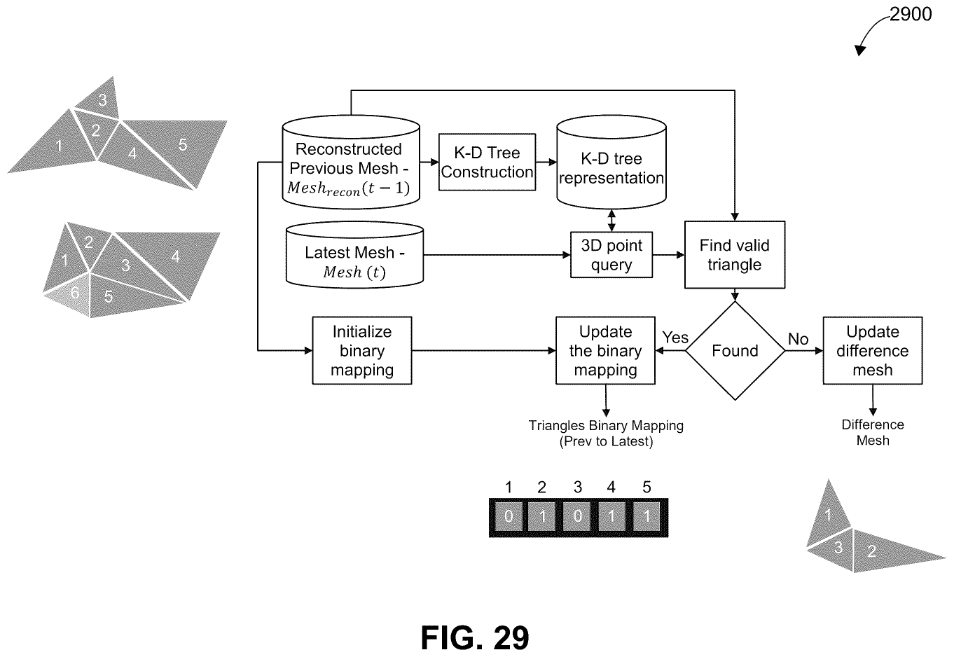

FIG. 29 is a diagram illustrating a step 2900 in an example process of generating a difference mesh and metadata, according to various aspects of the present disclosure. Step 2900 may be a step in operations of system 1600A of FIG. 16A. Step 2900 may follow step 2800 of FIG. 28.

At step 2900, the 3D coordinates of reordered reconstructed previous mesh 1608 that are within the search radius of the vertices of the triangle selected at step 2800 (e.g., triangle 6 of latest mesh 1602) may be compared to the triangles of reconstructed previous mesh 1604 to determine whether the 3D coordinates that are within the search radius of the vertices of the triangle selected at step 2800 (e.g., triangle 6 of latest mesh 1602) match a triangle of reconstructed previous mesh 1604.

According to the example of step 2900, no triangle of reconstructed previous mesh 1604 matches the triangle of latest mesh 1602 selected at step 2800 (e.g., triangle 6 of latest mesh 1602). So, update difference mesh 1618 adds the triangle selected at step 2800 (e.g., triangle 6 of latest mesh 1602) to difference mesh 1624. Triangle 6 of latest mesh 1602 is added as triangle 3 of difference mesh 1624 based on triangle 6 of latest mesh 1602 being added to difference mesh 1624 third.

FIG. 30 is a diagram illustrating a step 3000 in an example process of generating a difference mesh and metadata, according to various aspects of the present disclosure. Step 3000 may be a step in operations of system 1600A of FIG. 16A. Step 3000 may follow step 2900 of FIG. 29. Step 3000 may represent a state of metadata 1622 and difference mesh 1624 at a conclusion of step 1700 through step 2900.

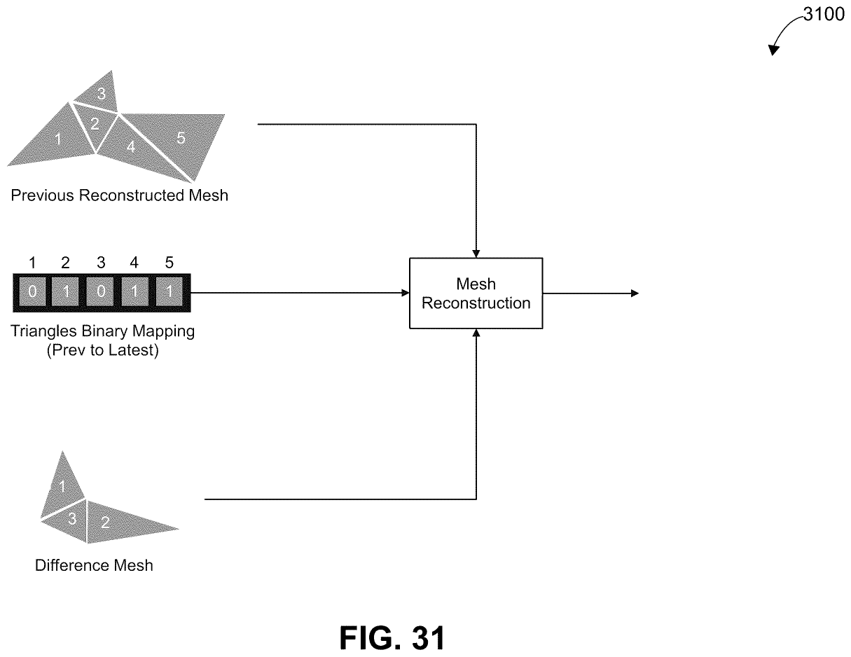

FIG. 31 is a diagram illustrating a step 3100 in an example process of reconstructing a mesh based on a previous mesh, a difference mesh, and metadata, according to various aspects of the present disclosure. Step 3100 may be a step in operations of mesh reconstructor 1426 of FIG. 14 and/or mesh reconstructor 1516 of FIG. 15.

At step 3100, mesh reconstructor 1426 may obtain reconstructed previous mesh 1432, metadata 1408, and difference mesh 1424. Alternatively, at step 3100, mesh reconstructor 1516 may obtain reconstructed previous mesh 1522, metadata 1514, and difference mesh 1512.

Reconstructed previous mesh 1432 and/or reconstructed previous mesh 1522 are illustrated as a group of five triangles in FIG. 31 through FIG. 36. Metadata 1408 and/or metadata 1514 are illustrated as a binary map in FIG. 31 through FIG. 36. Difference mesh 1424 and/or difference mesh 1512 are illustrated as a group of three triangles in FIG. 31 through FIG. 36.

Over the process of step 3100 through step 3600, mesh reconstructor 1426 and may generate reconstructed mesh 1428 or mesh reconstructor 1516 may generate reconstructed mesh 1518. Mesh reconstructor 1426 and/or mesh reconstructor 1516 are illustrated as a box in FIG. 31 through FIG. 36. Reconstructed mesh 1428 and/or reconstructed mesh 1518 are illustrated as a group of triangles in FIG. 31 through FIG. 36.

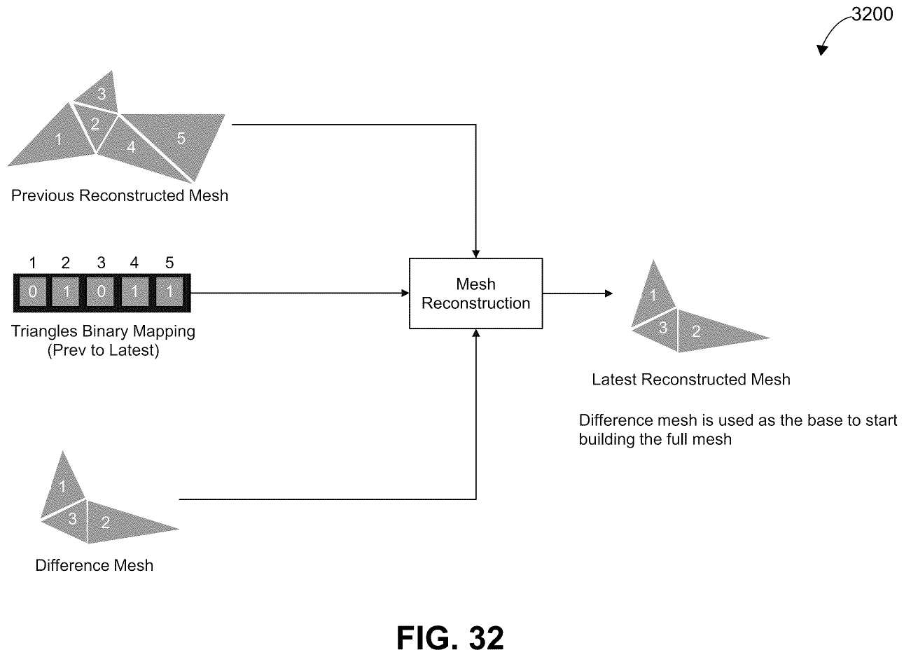

FIG. 32 is a diagram illustrating a step 3200 in an example process of reconstructing a mesh based on a previous mesh, a difference mesh, and metadata, according to various aspects of the present disclosure. Step 3200 may be a step in operations of mesh reconstructor 1426 of FIG. 14 and/or mesh reconstructor 1516 of FIG. 15. Step 3200 may follow step 3100 of FIG. 31.

At step 3200, mesh reconstructor 1426 or mesh reconstructor 1516 generate a base mesh based on difference mesh 1424 or mesh-compression encoder 1412. For example, mesh reconstructor 1426 or mesh reconstructor 1516 may use each 3D coordinate and/or triangle of difference mesh 1424 or difference mesh 1512 as the base mesh. In subsequent steps, the process may add additional 3D coordinates and/or triangles to the base mesh.

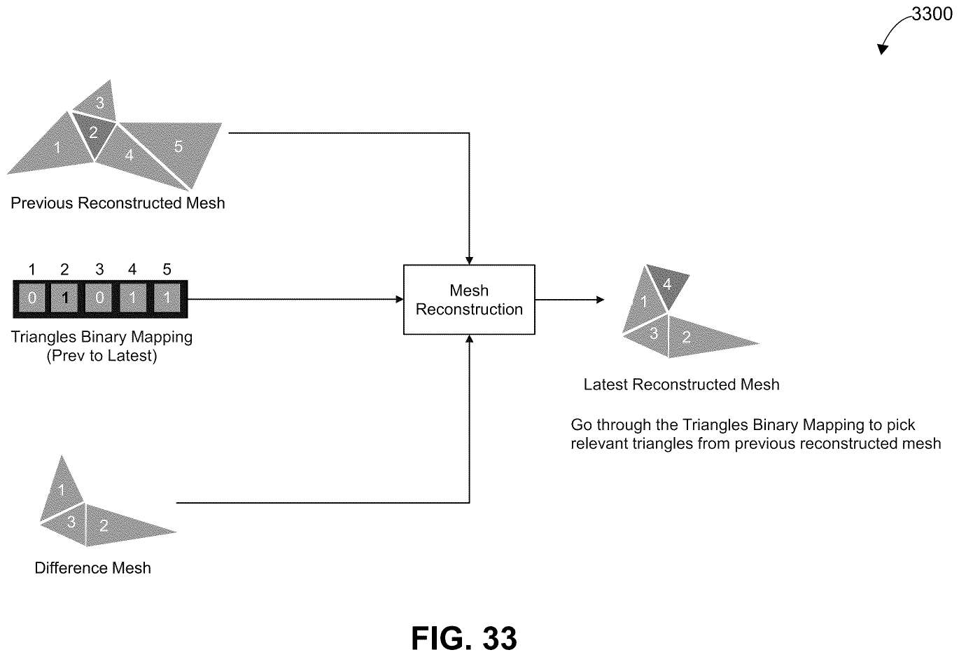

FIG. 33 is a diagram illustrating a step 3300 in an example process of reconstructing a mesh based on a previous mesh, a difference mesh, and metadata, according to various aspects of the present disclosure. Step 3300 may be a step in operations of mesh reconstructor 1426 of FIG. 14 and/or mesh reconstructor 1516 of FIG. 15. Step 3300 may follow step 3200 of FIG. 32.

At step 3300, mesh reconstructor 1426 or mesh reconstructor 1516 may add triangle 2 of reconstructed previous mesh 1432 or reconstructed previous mesh 1522 to the base mesh based on triangle 2 being indicated as being included in latest mesh 1402 by metadata 1408 or metadata 1514. Triangle 2 of reconstructed previous mesh 1432 or reconstructed previous mesh 1522 may be added to the base mesh as triangle 4 of the base mesh based on triangle 2 of reconstructed previous mesh 1432 or reconstructed previous mesh 1522 being added to the base mesh fourth.

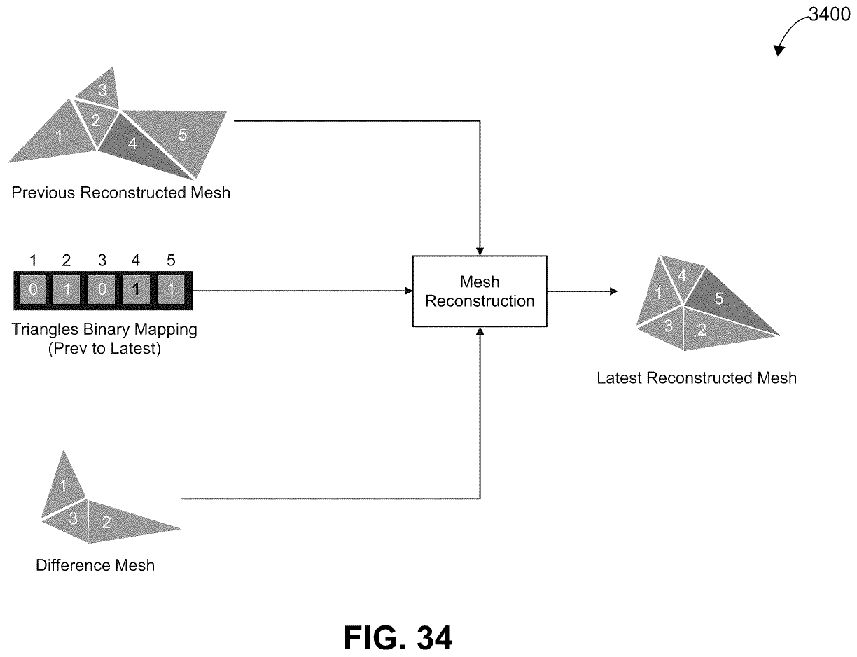

FIG. 34 is a diagram illustrating a step 3400 in an example process of reconstructing a mesh based on a previous mesh, a difference mesh, and metadata, according to various aspects of the present disclosure. Step 3400 may be a step in operations of mesh reconstructor 1426 of FIG. 14 and/or mesh reconstructor 1516 of FIG. 15. Step 3400 may follow step 3300 of FIG. 33.

At step 3400, mesh reconstructor 1426 or mesh reconstructor 1516 may add triangle 4 of reconstructed previous mesh 1432 or reconstructed previous mesh 1522 to the base mesh based on triangle 4 being indicated as being included in latest mesh 1402 by metadata 1408 or metadata 1514. Triangle 4 of reconstructed previous mesh 1432 or reconstructed previous mesh 1522 may be added to the base mesh as triangle 5 of the base mesh based on triangle 4 of reconstructed previous mesh 1432 or reconstructed previous mesh 1522 being added to the base mesh fifth.

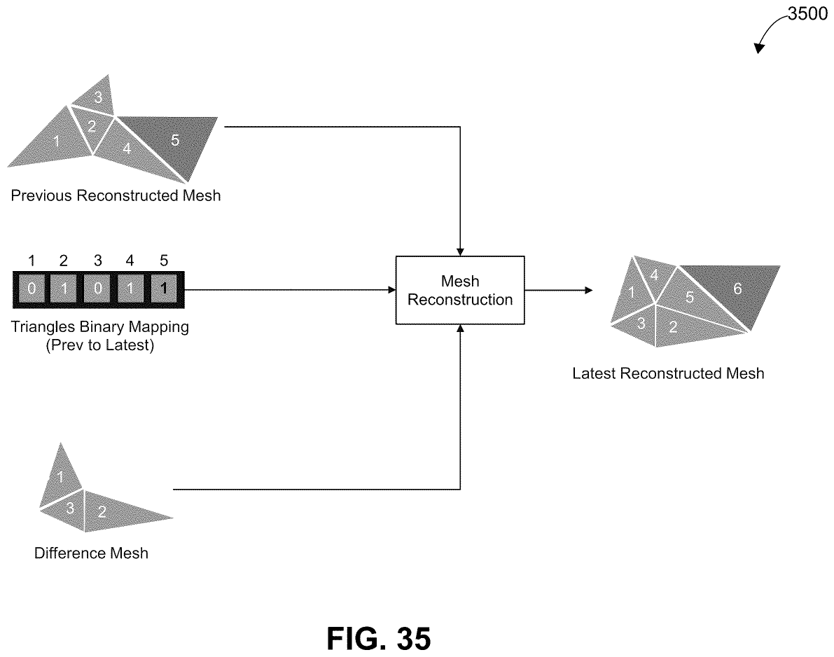

FIG. 35 is a diagram illustrating a step 3500 in an example process of reconstructing a mesh based on a previous mesh, a difference mesh, and metadata, according to various aspects of the present disclosure. Step 3500 may be a step in operations of mesh reconstructor 1426 of FIG. 14 and/or mesh reconstructor 1516 of FIG. 15. Step 3500 may follow step 3400 of FIG. 34.

At step 3500, mesh reconstructor 1426 or mesh reconstructor 1516 may add triangle 5 of reconstructed previous mesh 1432 or reconstructed previous mesh 1522 to the base mesh based on triangle 5 being indicated as being included in latest mesh 1402 by metadata 1408 or metadata 1514. Triangle 5 of reconstructed previous mesh 1432 or reconstructed previous mesh 1522 may be added to the base mesh as triangle 6 of the base mesh based on triangle 5 of reconstructed previous mesh 1432 or reconstructed previous mesh 1522 being added to the base mesh sixth.

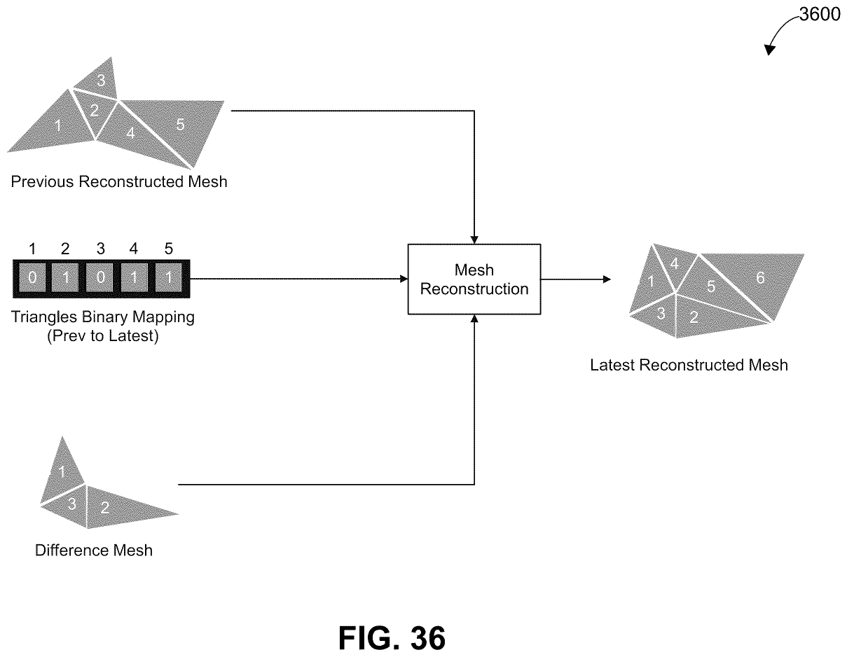

FIG. 36 is a diagram illustrating a step 3600 in an example process of reconstructing a mesh based on a previous mesh, a difference mesh, and metadata, according to various aspects of the present disclosure. Step 3600 may be a step in operations of mesh reconstructor 1426 of FIG. 14 and/or mesh reconstructor 1516 of FIG. 15. Step 3600 may follow step 3500 of FIG. 35.

Step 3600 may represent a state of reconstructed mesh 1428 and/or reconstructed mesh 1518 at a conclusion of step 3100 through step 3500.

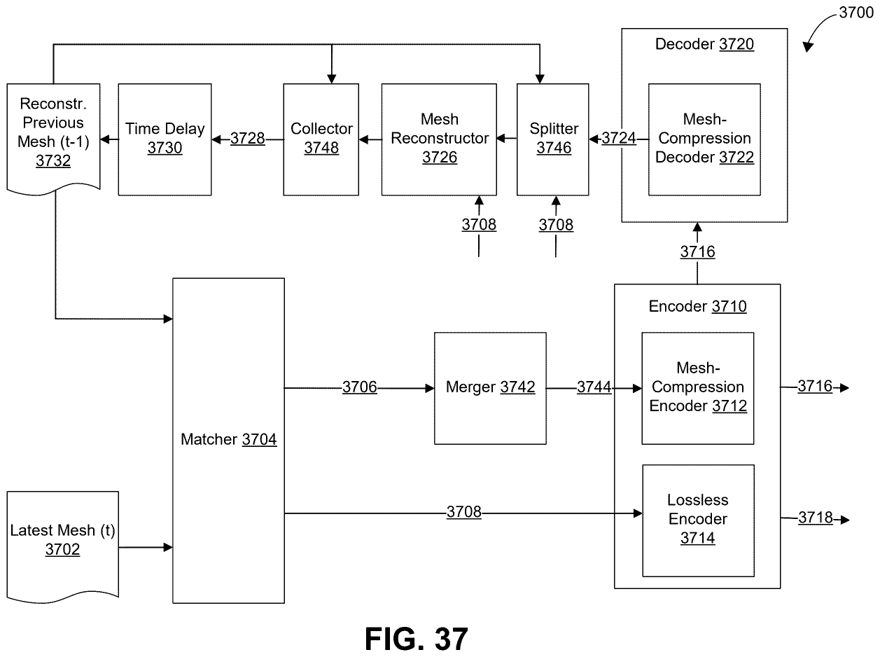

FIG. 37 is a block diagram illustrating an example system 3700 for processing, compressing, encoding, and/or transmitting 3D data, according to various aspects of the present disclosure. Similar to system 1000 of FIG. 10, system 1200 of FIG. 12, and system 1400 of FIG. 14, system 1400 may determine updates to a 3D mesh. System 3700 may generate data indicative of the updates and compress the data as encoded difference mesh 3716 and encoded metadata 3718 and send encoded difference mesh 3716 and encoded metadata 3718 to a server. System 3700 may be another example of an XR device, such as XR device 904 of FIG. 9.

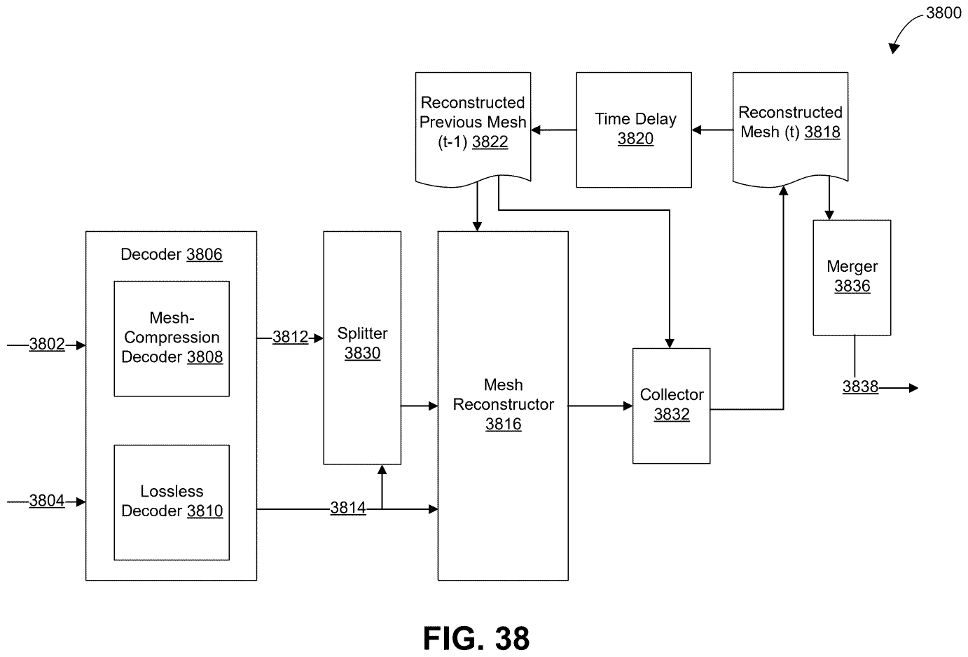

System 3800 of FIG. 38 may receive encoded difference mesh 3716 as encoded difference mesh 3802 and encoded metadata 3718 as encoded metadata 3804. System 3800 may decompress encoded difference mesh 3802 and encoded metadata 3804 to obtain the updates to the previous 3D mesh. Similar to system 1100 of FIG. 11, system 1300 of FIG. 13, and system 1500 of FIG. 15, system 3800 may apply the updates to a local instance of the previous 3D mesh to generate reconstructed mesh 3818. Downstream tasks may perform various operations on reconstructed mesh 3818. System 3800 may be an example of a server, such as server 906 of FIG. 9.

Turning to FIG. 37, system 3700 may be similar to system 1400 of FIG. 14. For example, matcher 3704 may be the same as, may be substantially similar to, and/or may perform the same, or substantially the same, operations as matcher 1404. Encoder encoder 3710 may be the same as, may be substantially similar to, and/or may perform the same, or substantially the same, operations as encoder 1410. Decoder decoder 3720 may be the same as, may be substantially similar to, and/or may perform the same, or substantially the same, operations as decoder 1420. Metadata 3708 may be the same as, or may be substantially similar to, metadata 1408. Lossless encoder 3714 may be the same as, may be substantially similar to, and/or may perform the same, or substantially the same, operations as, lossless encoder 1414. Mesh-compression decoder 3722 may be the same as, may be substantially similar to, and/or may perform the same, or substantially the same, operations as mesh-compression decoder 1422. Mesh reconstructor 3726 may be the same as, may be substantially similar to, and/or may perform the same, or substantially the same, operations as mesh reconstructor 1426. Reconstructed mesh 3728 may be the same as, or may be substantially similar to, reconstructed mesh 1428. Time delay 3730 may be the same as, may be substantially similar to, and/or may perform the same, or substantially the same, operations as time delay 1430. However, whereas system 1400 may receive latest mesh 1402 which may include an entire 3DR mesh, system 3700 may receive blocks of a mesh. For example, a 3DRU may provide a list of meshes per block and block IDs that changed relative to the previous mesh.

System 3700 may use state machines to keep track of last API call from each client application that request for 3DR mesh data. One benefit of system 3700 over system 1400 is a significant savings in processing time of matcher 3704. For example, matcher 3704 may have fewer 3D coordinates and triangles to search when matching 3D coordinates and triangles.

System 3700 may maintain block IDs, latest per block meshes after reconstruction. System 3700 may create a set of difference meshes using triangle matching for blocks that are updated. The block difference meshes are merged to form the overall difference mesh. This will improve the compression efficiency of mesh-compression encoder 3712 over doing multiple mesh-compression encoder 3712 compressions per block. Additional header information may be sent such as block IDs changed and range of each block. Such information may help in separating out the blocks (e.g., at decoder 3806).

System 3700 may be similar to system 1400 of FIG. 14. Additionally, merger 3742 may merge blocks where there are changes to generate difference mesh 3744. Mesh-compression encoder 3712 may compress difference mesh 3744 to generate encoded difference mesh 3716. Splitter 3746 may split difference mesh 3724 into blocks of difference meshes. Mesh reconstructor 3726 may reconstruct the blocks of differences meshes to a full mesh per block. Collector 3748 may update the list of block meshes with the latest mesh blocks. Further collector 3748 may delete a block from the list if one of the reconstructed mesh block becomes empty.

FIG. 38 is a block diagram illustrating an example system 3800 for decompressing, decoding, processing, and/or reconstructing 3D data, according to various aspects of the present disclosure. In general, system 3800 may receive encoded difference mesh 3802 and encoded metadata 3804. Decoder 3806 may decompress encoded difference mesh 3802 as difference mesh 3812 using mesh-compression decoder 3808. Decoder 3806 may decompress encoded metadata 3804 as metadata 3814 using lossless decoder 3810. Additional header information may be received (e.g., from system 3700) such as block IDs changed and range of each block. Such information will help decoder 3806 in separating out the blocks. Mesh reconstructor 3816 may apply updates indicated by difference mesh 3812 and metadata 3814 to reconstructed previous mesh 3822 to generate reconstructed mesh 3818.

System 3800 may be similar to system 1500 of FIG. 15. For example, decoder 3806 may be the same as, may be substantially similar to, and/or may perform the same, or substantially the same, operations as decoder 1506. Mesh reconstructor 3816 may be the same as, may be substantially similar to, and/or may perform the same, or substantially the same, operations as mesh reconstructor 1516. Time delay 3820 may be the same as, may be substantially similar to, and/or may perform the same, or substantially the same, operations as time delay 1520. Splitter 3830 may be the same as, may be substantially similar to, and/or may perform the same, or substantially the same, operations as 1530//. Additionally, collector 3832 may update the list of block meshes with the latest mesh blocks. Collector 3832 may delete a block from the list if one of the reconstructed mesh block becomes empty. Merger 3836 may merge blocks from the reconstructed mesh 3818 to generate the full mesh 3838 that will be used by the downstream functions.

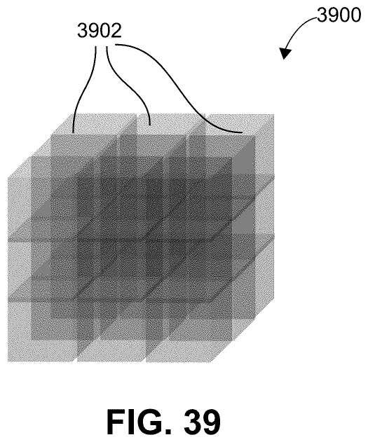

FIG. 39 is a diagram of a 3DR space 3900 subdivided into blocks 3902. For example, 3DRU 3DR space 3900 is divided into blocks 3902, which are represented as cubes in FIG. 39. Some of the cubes are blocks that are not changed during the update interval. Others of the cubes are blocks that are changed during the update interval.

The changed blocks are sent by 3DRU module per update interval. The changed blocks are encoded by system 3700. The encoded difference mesh, triangle binary mapping, along with block level meta data will be sent from client to server.

The descriptions of the example process related to FIG. 17 through FIG. 30 may be examples of operations of matcher 3704. Similarly, the description of the example process related to FIG. 31 through FIG. 36 may be examples of operations of mesh reconstructor 3726 and/or mesh reconstructor 3816.

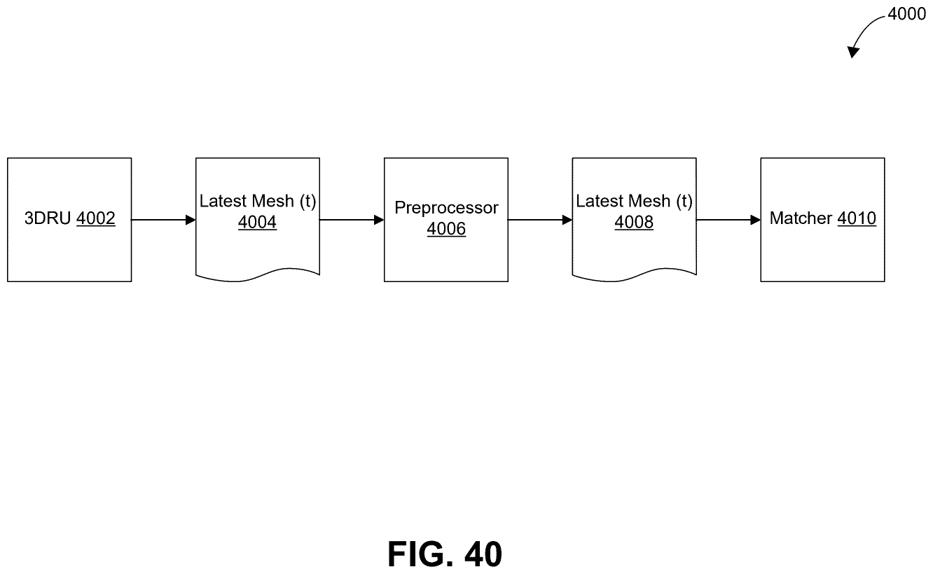

FIG. 40 is a diagram of an example system for preprocessing 3D data (e.g., 3DR mesh data), according to various aspects of the present disclosure. For example, a 3DRU 4002 may generate latest mesh 4004. A preprocessor 4006 may process latest mesh 4004 to generate latest mesh 4008. Preprocessor 4006 may provide latest mesh 4008 to a matcher 4010. Matcher 4010 may be an example of matcher 1404 of FIG. 14 or matcher 3704 of FIG. 37. In some aspects, system 4000, or preprocessor 4006, may be included in system 1400 or system 3700.

preprocessor 4006 may remove artefacts from latest mesh 4004. Preprocessor 4006 may remove artefacts such as isolated 3D points, degenerate triangles, duplicate 3D points, and/or duplicate triangles.

Latest mesh 4004 may include a list of 3D coordinates and a list of triangles. The list of 3D coordinates may include a list of 3D points that are part of triangles in the mesh. The list of triangles in the mesh includes the connectivity information (e.g., how 3D coordinates are connected to form triangles.)

Preprocessor 4006 may identify isolated 3D points as 3D points in the 3D coordinates list that are not associated with any triangles in the triangles list. Preprocessor 4006 may scan through the triangle connectivity information. The 3D points in the 3D coordinates list that are not present in the triangle list are isolated points. Preprocessor 4006 may identify degenerate triangles based on any two vertices of a triangle in the triangle list having the same 3D location. Preprocessor 4006 may identify duplicate 3D points by passing through the 3D coordinates list and checking for repetitions. Preprocessor 4006 may identify duplicate triangles by scanning through the triangles list and checking for repetitions.

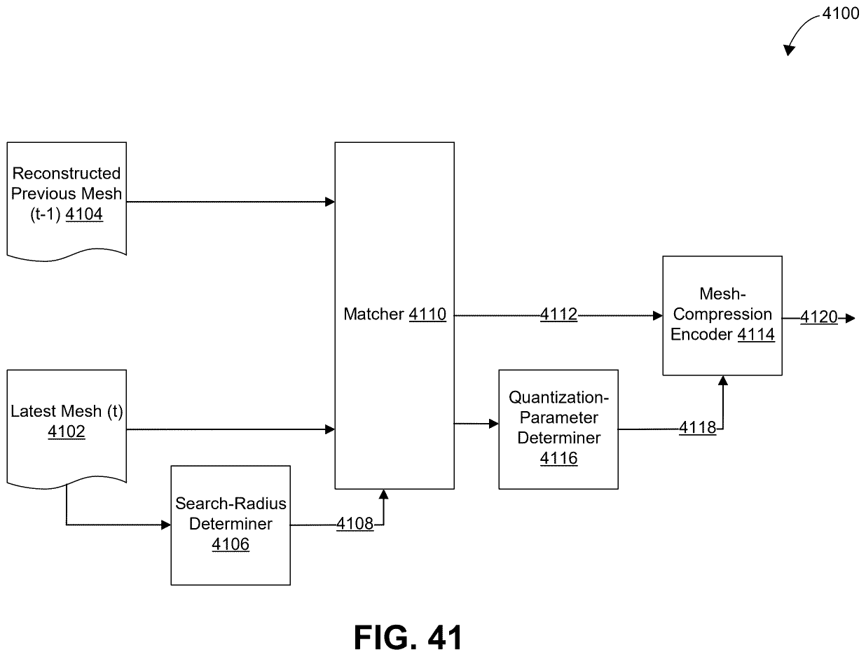

FIG. 41 is a block diagram illustrating an example system 4100 for processing, compressing, encoding, and/or transmitting 3D data, according to various aspects of the present disclosure. In general, system 4100 may obtain a latest mesh 4102 and a reconstructed previous mesh 4104 and match 3D coordinates and triangles of latest mesh 4102 with 3D coordinates and triangles of reconstructed previous mesh 4104. Matcher 4110 may generate mesh 4112 based on the matching and non-matching 3D coordinates and triangles. Mesh-compression encoder 4114 may compress mesh 4112 to generate encoded mesh data 4120.

Latest mesh 4102 may be an example of latest mesh 1402 of FIG. 14 and/or latest mesh 3702 of FIG. 37. Reconstructed previous mesh 4104 may be an example of reconstructed previous mesh 1432 of FIG. 14 and/or reconstructed previous mesh 3732 of FIG. 37. Matcher 4110 may be an example of matcher 1404 of FIG. 14 and/or matcher 3704 of FIG. 29. Mesh 4112 may be an example of difference mesh 1406 of FIG. 14 or difference mesh 3706 of FIG. 37.

As described with regard to FIG. 16A, matcher 4110 may, among other things, search within a search radius for matching 3D coordinates. For example, matcher 4110 may, for each vertex of each triangle of latest mesh 4102, search within a search radius for matching 3D coordinates of reconstructed previous mesh 4104. Search-radius determiner 4106 may determine search radius 4108 and matcher 4110 may search within search radius 4108 when matching 3D coordinates.

Mesh-compression encoder 4114 may be an example of mesh-compression encoder 1412 of FIG. 14 or mesh-compression encoder 3712 of FIG. 37. Mesh-compression encoder 4114 may compress mesh 4112 to generate encoded mesh data 4120. Encoded mesh data 4120 may be an example of encoded difference mesh 1416 of FIG. 14 or encoded difference mesh 3716 of FIG. 37. Mesh-compression encoder 4114 may compress mesh 4112 according to a quantization parameter 4118. Quantization-parameter determiner 4116 may determine quantization parameter 4118.

System 4100 may cause search radius 4108 and quantization parameter 4118 to be related. For example, in system 4100, search-radius determiner 4106 may generate search radius 4108 and quantization-parameter determiner 4116 may generate quantization parameter 4118 such that search radius 4108 and quantization parameter 4118 are related.

For example, for occlusion-based rendering it may be desirable to meet a target Hausdorff distance with minimal bit-rate for achieving desired user experience quantization. In such a scenario, adaptive processing is as follows: for latest mesh, compute the triangle matching search radius as

$${r}_{search} = C \cdot {log}_{2} \frac{max ( range of 3 D points in latest mesh )}{distortion {metric}_{target}}$$

where C>1

Accordingly, search-radius determiner 4106 may determine search radius 4108 using the equation above.

Additionally, quantization-parameter determiner 4116 may compute the quantization parameter 4118 according to:

$$QP = {log}_{2} \frac{max ( range of 3 D points in difference mesh )}{distortion {metric}_{target}}$$

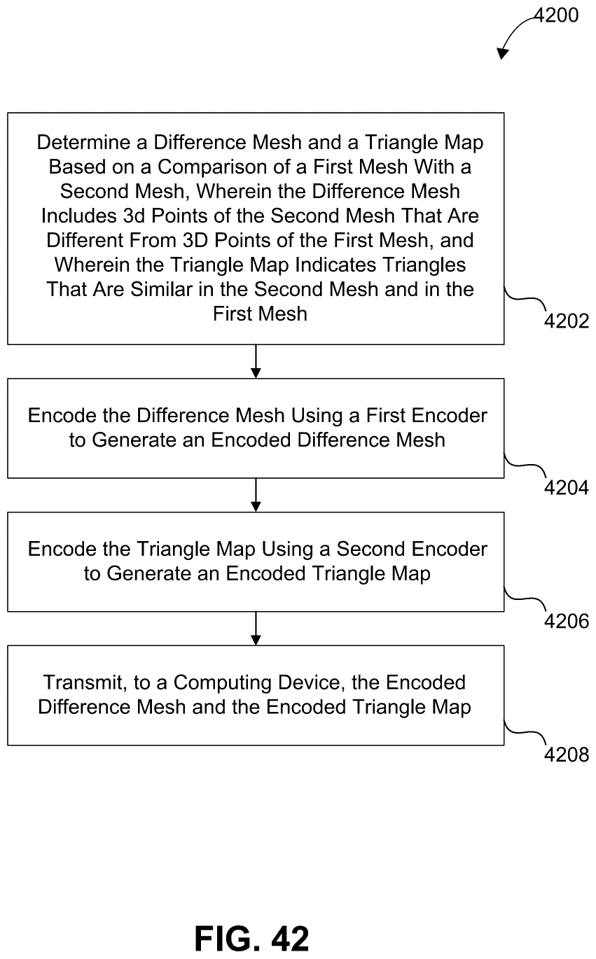

FIG. 42 is a flow diagram illustrating an example process 4200 for processing, compressing, encoding, and/or transmitting 3D data, in accordance with aspects of the present disclosure. One or more operations of process 4200 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 4200. The one or more operations of process 4200 may be implemented as software components that are executed and run on one or more processors.

At block 4202, a computing device (or one or more components thereof) may determine a difference mesh and a triangle map based on a comparison of a first mesh with a second mesh, wherein the difference mesh includes 3D points of the second mesh that are different from 3D points of the first mesh, and wherein the triangle map indicates triangles that are similar in the second mesh and in the first mesh. For example, matcher 1404 may generate difference mesh 1406 and metadata 1408 based on a comparison of latest mesh 1402 and reconstructed previous mesh 1432. Difference mesh 1406 may include 3D coordinates of latest mesh 1402 that are different from (or not included in) reconstructed previous mesh 1432. Metadata 1408 may include triangles that are substantially the same in latest mesh 1402 and in reconstructed previous mesh 1432.

In some aspects, the computing device (or one or more components thereof) may remove isolated 3D points from the second mesh; remove degenerate triangles from the second mesh; remove duplicate 3D points from the second mesh; and/or remove duplicate triangles from the second mesh. For example, preprocessor 4006 may remove isolated 3D points from DRU 4002, remove degenerate triangles from DRU 4002, remove duplicate 3D points from DRU 4002, and/or remove duplicate triangles from DRU 4002.

In some aspects, the difference mesh may be, or may include, 3D coordinates of the 3D points of the second mesh that are not in the first mesh. for example, difference mesh 1406 may include 3D coordinates of latest mesh 1402 that are not in reconstructed previous mesh 1432.

In some aspects, the difference mesh comprises a list of triangles of the second mesh that are not in the first mesh, wherein each triangle of the list of triangles comprises three vertices, and wherein each vertex comprises a 3D coordinate. For example, difference mesh 1406 may include a list of triangles of latest mesh 1402 that are not in reconstructed previous mesh 1432.

In some aspects, the difference mesh may be, or may include, a list of triangles of the second mesh that are not in the first mesh, and each vertex of a triangle of the list of triangles comprises a 3D coordinate. For example, difference mesh 1406 may include a list of triangles of latest mesh 1402 that are not in reconstructed previous mesh 1432. Each vertex of a triangle of the list of triangles may be a 3D coordinate (e.g., of the list of 3D coordinates of difference mesh 1406).

In some aspects, the triangle map comprises a map of triangles that are in the second mesh and in the first mesh. For example, metadata 1408 may include a list of triangles of latest mesh 1402 that are substantially the same as triangles that are in reconstructed previous mesh 1432.

In some aspects, the map may be, or may include, a binary map. For example, metadata 1408 may be, or may include, a binary map.

In some aspects, to determine the difference mesh and the triangle map the computing device (or one or more components thereof) may: compare 3D points of triangles of the second mesh with 3D points of the first mesh to identify matching points; compare triangles of the first mesh with the matching points to identify matching triangles; store the matching triangles in the triangle map; and store non-matching triangles and 3D coordinates of vertices of the non-matching triangles in the difference mesh. For example, point query 1610 may compare 3D coordinates of triangles of latest mesh 1602 with 3D coordinates of reconstructed previous mesh 1604 to identify matching points. Further, triangle query 1612 may compare triangles of latest mesh 1602 with triangles of reconstructed previous mesh 1604 to determine matching triangles. Further, update metadata 1616 may store matching triangles in metadata 1622 and update difference mesh 1618 may store 3D coordinates of non-matching triangles in difference mesh 1624.

In some aspects, the computing device (or one or more components thereof) may determine, based on a distortion target metric, a search radius to use when comparing 3D points of second mesh with 3D points of the first mesh; and determine, based on the distortion target metric, a quantization parameter for the first encoder to use when encoding the difference mesh. For example, search-radius determiner 4106 may determine, based on a distortion target metric, search radius 4108 for matcher 4110 to use when matching 3D coordinates of latest mesh 4102 with 3D coordinates of reconstructed previous mesh 4104. Further, quantization-parameter determiner 4116 may determine quantization parameter 4118 for mesh-compression encoder 4114 to use when compressing mesh 4112 based on the distortion target metric.

In some aspects, the computing device (or one or more components thereof) may organize 3D points of the first mesh prior to comparing the 3D points of the triangles of the second mesh with the 3D points of the first mesh. For example, reorganizer 1606 may organize reconstructed previous mesh 1604 to generate previous mesh 1608.

In some aspects, the computing device (or one or more components thereof) may organize the 3D points of the first mesh into a tree structure. For example, reorganizer 1606 may organize reconstructed previous mesh 1604 to generate previous mesh 1608 according to a tree structure.

In some aspects, the tree structure may be a K-D tree structure. For example, reorganizer 1606 may organize reconstructed previous mesh 1604 to generate previous mesh 1608 according to a KD tree structure.

In some aspects, the computing device (or one or more components thereof) may divide the first mesh into a plurality of sub-meshes; and determine whether at least one 3D point within each sub-mesh of the plurality of sub-meshes changed between the second mesh and the first mesh. For example, system 3700 may determine a plurality of sub-meshes and determine whether at least one 3D point within each sub-mesh of the plurality of sub-meshes changed between latest mesh 3702 and previous mesh 3732 to generate latest mesh 3702.

In some aspects, to compare the 3D points of the triangles of the second mesh with 3D points of the first mesh, the computing device (or one or more components thereof) may compare the 3D points of the triangles of the second mesh with a subset of the 3D points of the first mesh based on an indication that the subset of the 3D points of the first mesh included at least one 3D point that changed between the second mesh and the first mesh. For example, matcher 3704 may receive an indication of a subset of 3D points of latest mesh 3702 that changed between latest mesh 3702 and previous mesh 3732. Matcher 3704 may process the subset.

At block 4204, the computing device (or one or more components thereof) may encode the difference mesh using a first encoder to generate an encoded difference mesh. For example, mesh-compression encoder 1412 of encoder 1410 may encode difference mesh 1406 to generate encoded difference mesh 1416.

At block 4206, the computing device (or one or more components thereof) may encode the triangle map using a second encoder to generate an encoded triangle map. For example, lossless encoder 1414 of encoder 1410 may encode metadata 1408 to generate encoded metadata 1418.

In some aspects, the first encoder comprises a mesh-compression encoder and wherein the second encoder comprises a lossless encoder. For example, mesh-compression encoder 1412 may be, or may include, a mesh-compression encoder and lossless encoder 1414 may be, or may include, a lossless encoder.

At block 4208, the computing device (or one or more components thereof) may cause at least one transmitter to transmit, to a computing device, the encoded difference mesh and the encoded triangle map. For example, system 1400 may cause a transmitter to transmit encoded difference mesh 1416 and encoded metadata 1418.

In some aspects, the computing device (or one or more components thereof) may receive, from the computing device, virtual content based on a reconstructed mesh, wherein the reconstructed mesh is based on an instance of the first mesh, the difference mesh, and the triangle map; and displaying the virtual content. For example, XR device 904 may implement system 1400 and may perform the operations of process 4200. Further, XR device 904 may receive virtual content 912 from server 906 and display virtual content 912, for example, as displayed content 914.

In some aspects, the computing device (or one or more components thereof) may decode the encoded difference mesh using a first decoder; generate a reconstructed mesh based on the first mesh, the decoded difference mesh, and the triangle map; and store the reconstructed mesh for use as an instance of a first mesh when an instance of a second mesh is obtained. For example, mesh-compression decoder 1422 of decoder 1420 may decode encoded difference mesh 1416 to generate difference mesh 1424. Mesh reconstructor 1426 may generate reconstructed mesh 1428 based on difference mesh 1424, metadata 1408, and reconstructed previous mesh 1432. Further system 1400 may store reconstructed mesh 1428 as reconstructed previous mesh 1432, for example, for use as reconstructed previous mesh 1432 when a next instance of latest mesh 1402 is received.

In some aspects, to generate the reconstructed mesh the computing device (or one or more components thereof) may add triangles of the first mesh to the decoded difference mesh based on the triangle map. For example, mesh reconstructor 1426 may add triangles of reconstructed previous mesh 1432 to difference mesh 1424 based on metadata 1408 (e.g., as described with regard to FIG. 31 to FIG. 36).

In some aspects, the computing device (or one or more components thereof) may, when adding triangles of the first mesh to the decoded difference mesh, adjust 3D points of the triangles of the first mesh to correspond to corresponding points of the decoded difference mesh. For example, when adding triangles of reconstructed previous mesh 1432 to difference mesh 1424, mesh reconstructor 1426 may cause 3D coordinates of reconstructed previous mesh 1432 to adjust to match 3D coordinates of difference mesh 1424.

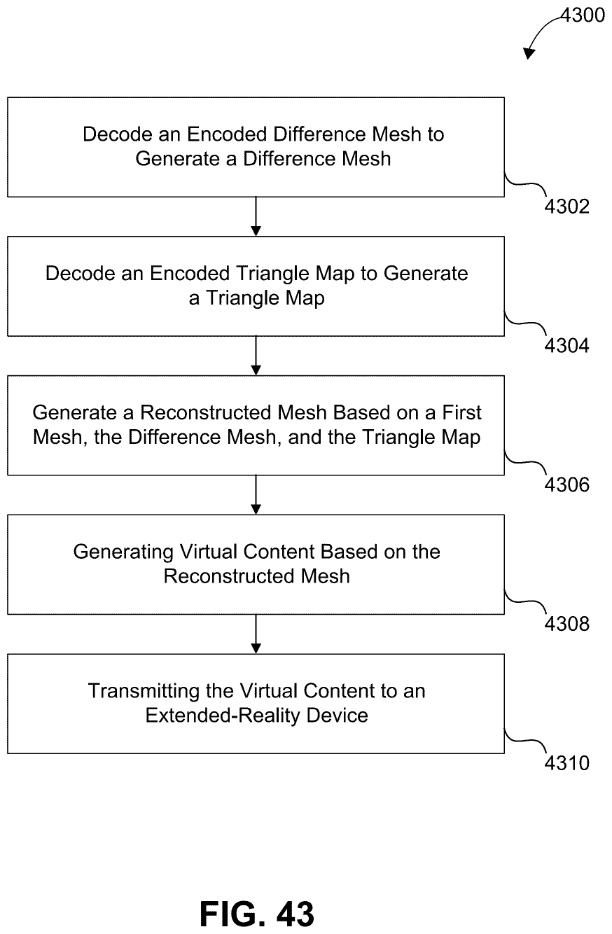

FIG. 43 is a flow diagram illustrating an example process 4300 for decompressing, decoding, processing, and/or reconstructing 3D data, in accordance with aspects of the present disclosure. One or more operations of process 4300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 4300. The one or more operations of process 4300 may be implemented as software components that are executed and run on one or more processors.

At block 4302, a computing device (or one or more components thereof) may decode an encoded difference mesh to generate a difference mesh. For example, mesh-compression decoder 1508 of decoder 1506 may decode encoded difference mesh 1502 to generate difference mesh 1512.

At block 4304, the computing device (or one or more components thereof) may decode an encoded triangle map to generate a triangle map. For example, lossless decoder 1510 of decoder 1506 may decode encoded metadata 1504 to generate metadata 1514.

In some aspects, the computing device (or one or more components thereof) may obtaining the encoded difference mesh and the encoded triangle map from the extended-reality device. For example, server 906 may perform process 4300. Server 906 may obtain encoded difference mesh 1502 and encoded metadata 1504 from XR device 904.

At block 4306, the computing device (or one or more components thereof) may generate a reconstructed mesh based on a first mesh, the difference mesh, and the triangle map. For example, mesh reconstructor 1516 may generate reconstructed mesh 1518 based on difference mesh 1512, metadata 1514, and reconstructed previous mesh 1522.

In some aspects, to generate the reconstructed mesh the computing device (or one or more components thereof) may add triangles of the first mesh to the decoded difference mesh based on the triangle map. For example, mesh reconstructor 1516 may add triangles of reconstructed previous mesh 1522 to difference mesh 1512 based on metadata 1514 (e.g., as described with regard to FIG. 31 to FIG. 36).

In some aspects, the computing device (or one or more components thereof) may, when adding triangles of the first mesh to the decoded difference mesh, adjust 3D points of the triangles of the first mesh to correspond to corresponding points of the decoded difference mesh. For example, when adding triangles of reconstructed previous mesh 1522 to difference mesh 1512, mesh reconstructor 1516 may cause 3D coordinates of reconstructed previous mesh 1522 to adjust to match 3D coordinates of difference mesh 1512.

In some aspects, the computing device (or one or more components thereof) may store the reconstructed mesh for use as an instance of a first mesh when an instance an encoded difference mesh and an instance of an encoded triangle map are received. For example, system 1500 may store reconstructed mesh 1518 as reconstructed previous mesh 1522, for example, for use as reconstructed previous mesh 1522 when a next instance of encoded difference mesh 1502 and encoded metadata 1504 are received.

At block 4308, the computing device (or one or more components thereof) may generate virtual content based on the reconstructed mesh. Server 906 may generate virtual content 912 based on reconstructed mesh 1518.

At block 4310, the computing device (or one or more components thereof) may cause at least one transmitter to transmit the virtual content to an extended-reality device. For example, server 906 may transmit virtual content 912 to XR device 904.

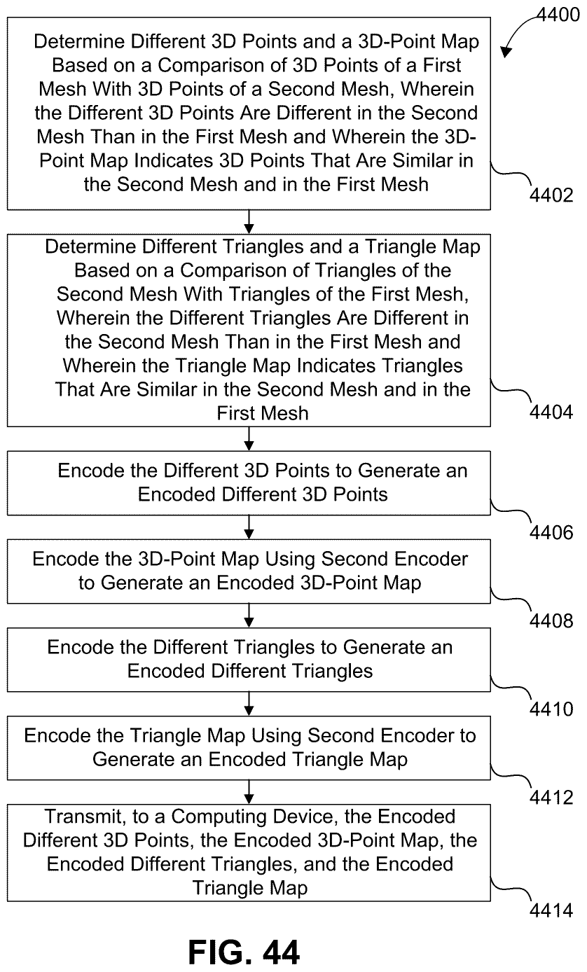

FIG. 44 is a flow diagram illustrating an example process 4400 for processing, compressing, encoding, and/or transmitting 3D data, in accordance with aspects of the present disclosure. One or more operations of process 4400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 4400. The one or more operations of process 4400 may be implemented as software components that are executed and run on one or more processors.

At block 4402, a computing device (or one or more components thereof) may determine different 3D points and a 3D-point map based on a comparison of 3D points of a first mesh with 3D points of a second mesh, wherein the different 3D points are different in the second mesh than in the first mesh and wherein the 3D-point map indicates 3D points that are similar in the second mesh and in the first mesh. For example, coordinate matcher 1030 may determine new coordinates 1032 and coordinates map 1034. New coordinates 1032 may include 3D coordinates of latest coordinates 1006 that are not in previous coordinates 1026. Coordinates map 1034 may indicate 3D coordinates of latest coordinates 1006 that are in previous coordinates 1026.

In some aspects, the different 3D points may be, or may include, 3D coordinates of the 3D points that are different in the second mesh than in the first mesh. For example, new coordinates 1032 may be, or may include, 3D coordinates of the 3D points that are different in latest mesh 1002 than in previous mesh 1022.

In some aspects, the 3D-point map may be, or may include, a map of the 3D points that are different in the second mesh than in the first mesh. For example, coordinates map 1034 may be, or may include, a map of the 3D points that are different in latest mesh 1002 than in previous mesh 1022.

In some aspects, the 3D-point map may be a binary map. for example, coordinates map 1034 may be a binary map.

At block 4404, the computing device (or one or more components thereof) may determine different triangles and a triangle map based on a comparison of triangles of the second mesh with triangles of the first mesh, wherein the different triangles are different in the second mesh than in the first mesh and wherein the triangle map indicates triangles that are similar in the second mesh and in the first mesh. For example, triangle matcher 1010 may generate new triangles 1012 and triangle map 1014. New triangles 1012 may include triangles that are in latest triangles 1008 but not in previous triangles 1028. Triangle map 1014 may indicate triangles of latest triangles 1008 that are in previous triangles 1028.

In some aspects, the different triangles may be, or may include, triplets indicating 3D points that make up the triangles that are different in the second mesh than in the first mesh. For example, new triangles 1012 may be, or may include, triplets indicating 3D points that make up the triangles that are different in latest mesh 1002 than in previous mesh 1022.

In some aspects, the triangle map may be, or may include, a map of the triangles that are similar in the second mesh and in the first mesh. For example, triangle map 1014 may be, or may include, a map of triangles that are similar in latest mesh 1002 and previous mesh 1022.

In some aspects, the triangle map may be, or may include, a binary map. For example, triangle map 1014 may be, or may include, a binary map.

In some aspects, prior to comparing the 3D points of the second mesh to the 3D points of the first mesh, the computing device (or one or more components thereof) may sort the 3D points of the second mesh and sorting the 3D points of the first mesh. For example, sorter 1024 may sort 3D coordinates of previous mesh 1022 and sorter 1004 may sort 3D coordinates of latest mesh 1002.

In some aspects, prior to comparing the triangles of the second mesh to the triangles of the first mesh, the computing device (or one or more components thereof) may sort the triangles of the second mesh and sorting the triangles of the first mesh. For example, sorter 1004 may sort triangles of latest mesh 1002 and sorter 1024 may sort triangles of previous mesh 1022.

At block 4406, the computing device (or one or more components thereof) may encode the different 3D points to generate an encoded different 3D points. For example, encoder 1036 may encode new coordinates 1032, coordinates map 1034, new triangles 1012, and triangle map 1014 to generate encoded data 1038.

At block 4408, the computing device (or one or more components thereof) may encode the 3D-point map using second encoder to generate an encoded 3D-point map. At block 4410, the computing device (or one or more components thereof) may encode the different triangles to generate an encoded different triangles. At block 4412, the computing device (or one or more components thereof) may encode the triangle map using second encoder to generate an encoded triangle map. At block 4414, the computing device (or one or more components thereof) may cause at least one transmitter to transmit, to a computing device, the encoded different 3D points, the encoded 3D-point map, the encoded different triangles, and the encoded triangle map. For example, system 1000 may cause a transmitter to transmit encoded data 1038.

In some aspects, the different 3D points, the 3D-point map, the different triangles, and the triangle map are encoded using a lossless encoder. For example, encoder 1036 may be, or may include, a lossless encoder.

In some aspects, the computing device (or one or more components thereof) may receive, from the computing device, virtual content based on a reconstructed mesh, wherein the reconstructed mesh is based on an instance of the first mesh, the difference mesh, and the triangle map; and displaying the virtual content. For example, XR device 904 may implement system 1400 and may perform the operations of process 4400. Further, XR device 904 may receive virtual content 912 from server 906 and display virtual content 912, for example, as displayed content 914.

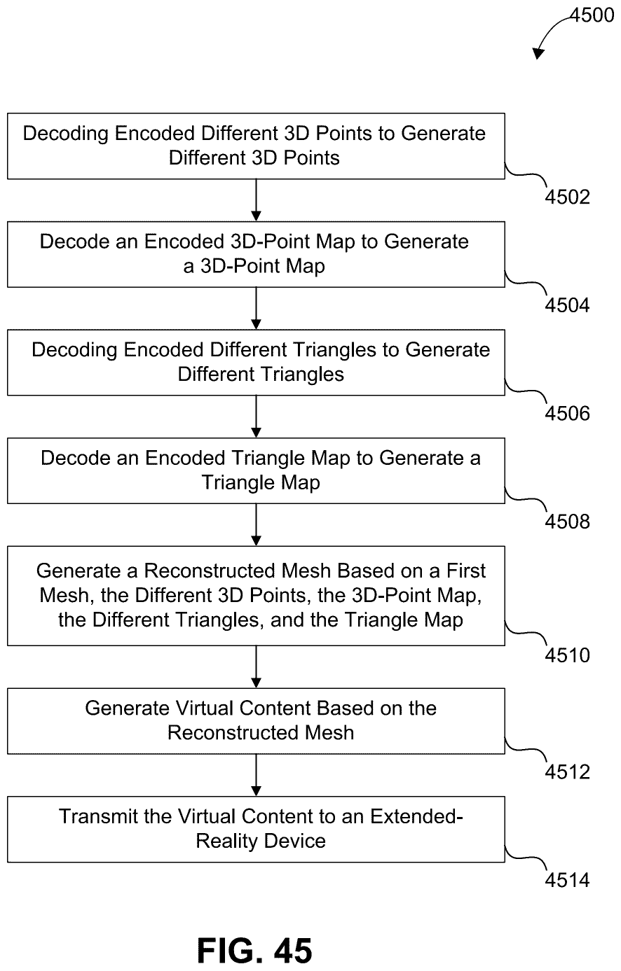

FIG. 45 is a flow diagram illustrating an example process 4500 for decompressing, decoding, processing, and/or reconstructing 3D data, in accordance with aspects of the present disclosure. One or more operations of process 4500 may be performed by a computing device (or apparatus) or a component (e.g., a chip set, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 4500. The one or more operations of process 4500 may be implemented as software components that are executed and run on one or more processors.

At block 4502, a computing device (or one or more components thereof) may decode encoded different 3D points to generate different 3D points. For example, decoder 1104 may decode encoded data 1102, which may include encoded different 3D points, to generate new coordinates 1106.

At block 4504, the computing device (or one or more components thereof) may decode an encoded 3D-point map to generate a 3D-point map. For example, decoder 1104 may decode encoded data 1102, which may include encoded a 3D-point map, to generate coordinates map 1108.

At block 4506, the computing device (or one or more components thereof) may decode encoded different triangles to generate different triangles. For example, decoder 1104 may decode encoded data 1102, which may include encoded different triangles, to generate new triangles 1110.

At block 4508, the computing device (or one or more components thereof) may decode an encoded triangle map to generate a triangle map. For example, decoder 1104 may decode encoded data 1102, which may include encoded triangle map, to generate triangle map 1112.

At block 4510, the computing device (or one or more components thereof) may generate a reconstructed mesh based on a first mesh, the different 3D points, the 3D-point map, the different triangles, and the triangle map. For example, coordinate reconstructor 1130 may generate reconstructed coordinates 1132 based on new coordinates 1106 and coordinates map 1108. Further triangle reconstructor 1120 may generate reconstructed triangles 1122 based on new triangles 1110 and triangle map 1112. Reconstructed coordinates 1132 and reconstructed triangles 1122 may make up reconstructed mesh 1142.

At block 4512, the computing device (or one or more components thereof) may generate virtual content based on the reconstructed mesh. For example, server 906 may perform process 4500 server 906 may generate virtual content 912 based on reconstructed mesh 1142.

At block 4514, the computing device (or one or more components thereof) may cause at least one transmitter to transmit the virtual content to an extended-reality device. For example, server 906 may transmit virtual content 912 to XR device 904.

In some aspects, the computing device (or one or more components thereof) may store the reconstructed mesh for use as an instance of a first mesh when an instance encoded different 3D points, an instance of an encoded 3D-point map, an instance of encoded different triangles, and an instance of an encoded triangle map are received. For example, system 1100 may store reconstructed coordinates 1132 as previous coordinates 1136 for use when a further instance of encoded data 1102 is received. Further system 1100 may store reconstructed triangles 1122 as previous triangles 1126 for use when a further instance of encoded data 1102 is received.

In some examples, as noted previously, the methods described herein (e.g., the process described with regard to FIG. 16A through FIG. 30, the process described with regard to FIG. 31 through FIG. 36, process 4200 of FIG. 42, process 4300 of FIG. 43, process 4400 of FIG. 44, process 4500 of FIG. 45, and/or other methods described herein) can be performed, in whole or in part, by a computing device or apparatus. In one example, one or more of the methods can be performed by XR device 102 of FIG. 1, XR device 202 and/or companion device 204 of FIG. 2, XR system 300 of FIG. 3, XR device 904 of FIG. 9, server 906 of FIG. 9, system 1000 of FIG. 10, system 1100 of FIG. 11, system 1200 of FIG. 12, system 1300 of FIG. 13, system 1400 of FIG. 14, system 1500 of FIG. 15, system 1600A of FIG. 16A, system 1600C of FIG. 16C, system 3700 of FIG. 37, system 3800 of FIG. 38, system 4000 of FIG. 40, system 4100 of FIG. 41, or by another system or device. In another example, one or more of the methods (e.g., the process described with regard to FIG. 16A through FIG. 30, the process described with regard to FIG. 31 through FIG. 36, process 4200 of FIG. 42, process 4300 of FIG. 43, process 4400 of FIG. 44, process 4500 of FIG. 45, and/or other methods described herein) can be performed, in whole or in part, by the computing-device architecture 4600 shown in FIG. 46. For instance, a computing device with the computing-device architecture 4600 shown in FIG. 46 can include, or be included in, the components of the XR device 102 of FIG. 1, XR device 202 and/or companion device 204 of FIG. 2, XR system 300 of FIG. 3, XR device 904 of FIG. 9, server 906 of FIG. 9, system 1000 of FIG. 10, system 1100 of FIG. 11, system 1200 of FIG. 12, system 1300 of FIG. 13, system 1400 of FIG. 14, system 1500 of FIG. 15, system 1600A of FIG. 16A, system 1600C of FIG. 16C, system 3700 of FIG. 37, system 3800 of FIG. 38, system 4000 of FIG. 40, and/or system 4100 of FIG. 41 and can implement the operations of process 4500, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process described with regard to FIG. 16A through FIG. 30, the process described with regard to FIG. 31 through FIG. 36, process 4200 of FIG. 42, process 4300 of FIG. 43, process 4400 of FIG. 44, process 4500 of FIG. 45, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process described with regard to FIG. 16A through FIG. 30, the process described with regard to FIG. 31 through FIG. 36, process 4200 of FIG. 42, process 4300 of FIG. 43, process 4400 of FIG. 44, process 4500 of FIG. 45, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 46 illustrates an example computing-device architecture 4600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 4600 may include, implement, or be included in any or all of XR device 102 of FIG. 1, XR device 202 and/or companion device 204 of FIG. 2, XR system 300 of FIG. 3, XR device 904 of FIG. 9, server 906 of FIG. 9, system 1000 of FIG. 10, system 1100 of FIG. 11, system 1200 of FIG. 12, system 1300 of FIG. 13, system 1400 of FIG. 14, system 1500 of FIG. 15, system 1600A of FIG. 16A, system 1600C of FIG. 16C, system 3700 of FIG. 37, system 3800 of FIG. 38, system 4000 of FIG. 40, system 4100 of FIG. 41 and/or other devices, modules, or systems described herein. Additionally or alternatively, computing-device architecture 4600 may be configured to perform the process described with regard to FIG. 16A through FIG. 30, the process described with regard to FIG. 31 through FIG. 36, process 4200 of FIG. 42, process 4300 of FIG. 43, process 4400 of FIG. 44, process 4500 of FIG. 45, and/or other process described herein.

The components of computing-device architecture 4600 are shown in electrical communication with each other using connection 4612, such as a bus. The example computing-device architecture 4600 includes a processing unit (CPU or processor) 4602 and computing device connection 4612 that couples various computing device components including computing device memory 4610, such as read only memory (ROM) 4608 and random-access memory (RAM) 4606, to processor 4602.

Computing-device architecture 4600 can include a cache of high-speed memory connected directly with, in close proximity to, or integrated as part of processor 4602. Computing-device architecture 4600 can copy data from memory 4610 and/or the storage device 4614 to cache 4604 for quick access by processor 4602. In this way, the cache can provide a performance boost that avoids processor 4602 delays while waiting for data. These and other modules can control or be configured to control processor 4602 to perform various actions. Other computing device memory 4610 may be available for use as well. Memory 4610 can include multiple different types of memory with different performance characteristics. Processor 4602 can include any general-purpose processor and a hardware or software service, such as service 1 4616, service 2 4618, and service 3 4620 stored in storage device 4614, configured to control processor 4602 as well as a special-purpose processor where software instructions are incorporated into the processor design. Processor 4602 may be a self-contained system, containing multiple cores or processors, a bus, memory controller, cache, etc. A multi-core processor may be symmetric or asymmetric.

To enable user interaction with the computing-device architecture 4600, input device 4622 can represent any number of input mechanisms, such as a microphone for speech, a touch-sensitive screen for gesture or graphical input, keyboard, mouse, motion input, speech and so forth. Output device 4624 can also be one or more of a number of output mechanisms known to those of skill in the art, such as a display, projector, television, speaker device, etc. In some instances, multimodal computing devices can enable a user to provide multiple types of input to communicate with computing-device architecture 4600. Communication interface 4626 can generally govern and manage the user input and computing device output. There is no restriction on operating on any particular hardware arrangement and therefore the basic features here may easily be substituted for improved hardware or firmware arrangements as they are developed.

Storage device 4614 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 4606, read only memory (ROM) 4608, and hybrids thereof. Storage device 4614 can include services 4616, 4618, and 4620 for controlling processor 4602. Other hardware or software modules are contemplated. Storage device 4614 can be connected to the computing device connection 4612. In one aspect, a hardware module that performs a particular function can include the software component stored in a computer-readable medium in connection with the necessary hardware components, such as processor 4602, connection 4612, output device 4624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method for determining three-dimensional (3D) data, the method comprising: determining a difference mesh and a triangle map based on a comparison of a first mesh with a second mesh, wherein the difference mesh includes 3D points of the second mesh that are different from 3D points of the first mesh, and wherein the triangle map indicates triangles that are similar in the second mesh and in the first mesh; encoding the difference mesh using a first encoder to generate an encoded difference mesh; encoding the triangle map using a second encoder to generate an encoded triangle map; and transmitting, to a computing device, the encoded difference mesh and the encoded triangle map.

Aspect 2. The method of aspect 1, further comprising: receiving, from the computing device, virtual content based on a reconstructed mesh, wherein the reconstructed mesh is based on an instance of the first mesh, the difference mesh, and the triangle map; and displaying the virtual content.

Aspect 3. The method of any one of aspects 1 or 2, further comprising: decoding the encoded difference mesh using a first decoder; generating a reconstructed mesh based on the first mesh, the decoded difference mesh, and the triangle map; and storing the reconstructed mesh for use as an instance of a first mesh when an instance of a second mesh is obtained.

Aspect 4. The method of aspect 3, wherein generating the reconstructed mesh comprises: adding triangles of the first mesh to the decoded difference mesh based on the triangle map.

Aspect 5. The method of aspect 4, further comprising, when adding triangles of the first mesh to the decoded difference mesh, adjusting 3D points of the triangles of the first mesh to correspond to corresponding points of the decoded difference mesh.

Aspect 6. The method of any one of aspects 1 to 5, wherein the difference mesh comprises 3D coordinates of the 3D points of the second mesh that are not in the first mesh.

Aspect 7. The method of any one of aspects 1 to 6, wherein the difference mesh comprises a list of triangles of the second mesh that are not in the first mesh, wherein each triangle of the list of triangles comprises three vertices, and wherein each vertex comprises a 3D coordinate.

Aspect 8. The method of any one of aspects 1 to 7, wherein the triangle map comprises a map of triangles that are in the second mesh and in the first mesh.

Aspect 9. The method of aspect 8, wherein the map comprises a binary map.

Aspect 10. The method of any one of aspects 1 to 9, wherein the first encoder comprises a mesh-compression encoder and wherein the second encoder comprises a lossless encoder.

Aspect 11. The method of any one of aspects 1 to 10, wherein determining the difference mesh and the triangle map comprises: comparing 3D points of triangles of the second mesh with 3D points of the first mesh to identify matching points; comparing triangles of the first mesh with the matching points to identify matching triangles; storing the matching triangles in the triangle map; and storing non-matching triangles and 3D coordinates of vertices of the non-matching triangles in the difference mesh.

Aspect 12. The method of aspect 11, further comprising organizing 3D points of the first mesh prior to comparing the 3D points of the triangles of the second mesh with the 3D points of the first mesh.

Aspect 13. The method of aspect 12, wherein the 3D points of the first mesh are organized into a tree structure.

Aspect 14. The method of aspect 13, wherein the tree structure comprises a K-D tree structure.

Aspect 15. The method of any one of aspects 11 to 14, wherein comparing the 3D points of the triangles of the second mesh with 3D points of the first mesh comprises comparing the 3D points of the triangles of the second mesh with a subset of the 3D points of the first mesh based on an indication that the subset of the 3D points of the first mesh included at least one 3D point that changed between the second mesh and the first mesh.

Aspect 16. The method of aspect 15, further comprising: dividing the first mesh into a plurality of sub-meshes; and determining whether at least one 3D point within each sub-mesh of the plurality of sub-meshes changed between the second mesh and the first mesh.

Aspect 17. The method of any one of aspects 1 to 16, further comprising at least one of: removing isolated 3D points from the second mesh; removing degenerate triangles from the second mesh; removing duplicate 3D points from the second mesh; or removing duplicate triangles from the second mesh.

Aspect 18. The method of any one of aspects 1 to 17, further comprising: determining, based on a distortion target metric, a search radius to use when comparing 3D points of second mesh with 3D points of the first mesh; and determining, based on the distortion target metric, a quantization parameter for the first encoder to use when encoding the difference mesh.

Aspect 19. A method for determining three-dimensional (3D) data, the method comprising: decoding an encoded difference mesh to generate a difference mesh; decoding an encoded triangle map to generate a triangle map; and generating a reconstructed mesh based on a first mesh, the difference mesh, and the triangle map.

Aspect 20. The method of aspect 19, further comprising: generating virtual content based on the reconstructed mesh; and transmitting the virtual content to an extended-reality device.

Aspect 21. The method of any one of aspects 19 or 20, wherein generating the reconstructed mesh comprises: adding triangles of the first mesh to the decoded difference mesh based on the triangle map.

Aspect 22. The method of aspect 21, further comprising, when adding triangles of the first mesh to the decoded difference mesh, adjusting 3D points of the triangles of the first mesh to correspond to corresponding points of the decoded difference mesh.

Aspect 23. The method of any one of aspects 19 to 22, further comprising obtaining the encoded difference mesh and the encoded triangle map from the extended-reality device.

Aspect 24. The method of any one of aspects 19 to 23, further comprising storing the reconstructed mesh for use as an instance of a first mesh when an instance an encoded difference mesh and an instance of an encoded triangle map are received.

Aspect 25. A method for determining three-dimensional (3D) data, the method comprising: determining different 3D points and a 3D-point map based on a comparison of 3D points of a first mesh with 3D points of a second mesh, wherein the different 3D points are different in the second mesh than in the first mesh and wherein the 3D-point map indicates 3D points that are similar in the second mesh and in the first mesh; determining different triangles and a triangle map based on a comparison of triangles of the second mesh with triangles of the first mesh, wherein the different triangles are different in the second mesh than in the first mesh and wherein the triangle map indicates triangles that are similar in the second mesh and in the first mesh; encoding the different 3D points to generate an encoded different 3D points; encoding the 3D-point map using second encoder to generate an encoded 3D-point map; encoding the different triangles to generate an encoded different triangles; encoding the triangle map using second encoder to generate an encoded triangle map; and transmitting, to a computing device, the encoded different 3D points, the encoded 3D-point map, the encoded different triangles, and the encoded triangle map.

Aspect 26. The method of aspect 25, further comprising: receiving, from the computing device, virtual content based on a reconstructed mesh, wherein the reconstructed mesh is based on an instance of the first mesh, the different 3D points, the 3D-point map, the different triangles, and the triangle map; and displaying the virtual content.

Aspect 27. The method of any one of aspects 25 or 26, wherein the different 3D points comprise 3D coordinates of the 3D points that are different in the second mesh than in the first mesh.

Aspect 28. The method of any one of aspects 25 to 27, wherein the 3D-point map comprises a map of the 3D points that are different in the second mesh than in the first mesh.

Aspect 29. The method of aspect 28, wherein the 3D-point map comprises a binary map.

Aspect 30. The method of any one of aspects 25 to 29, wherein the different triangles comprise triplets indicating 3D points that make up the triangles that are different in the second mesh than in the first mesh.

Aspect 31. The method of any one of aspects 25 to 30, wherein the triangle map comprises a map of the triangles that are similar in the second mesh and in the first mesh.

Aspect 32. The method of aspect 31, wherein the triangle map comprises a binary map.

Aspect 33. The method of any one of aspects 25 to 32, wherein the different 3D points, the 3D-point map, the different triangles, and the triangle map are encoded using a lossless encoder.

Aspect 34. The method of any one of aspects 25 to 33, further comprising, prior to comparing the 3D points of the second mesh to the 3D points of the first mesh, sorting the 3D points of the second mesh and sorting the 3D points of the first mesh.

Aspect 35. The method of any one of aspects 25 to 34, further comprising, prior to comparing the triangles of the second mesh to the triangles of the first mesh, sorting the triangles of the second mesh and sorting the triangles of the first mesh.

Aspect 36. A method for determining three-dimensional (3D) data, the method comprising: decoding encoded different 3D points to generate different 3D points; decoding an encoded 3D-point map to generate a 3D-point map; decoding encoded different triangles to generate different triangles; decoding an encoded triangle map to generate a triangle map; and generating a reconstructed mesh based on a first mesh, the different 3D points, the 3D-point map, the different triangles, and the triangle map.

Aspect 37. The method of aspect 36, further comprising: generating virtual content based on the reconstructed mesh; and transmitting the virtual content to an extended-reality device.

Aspect 38. The method of any one of aspects 36 or 37, further comprising storing the reconstructed mesh for use as an instance of a first mesh when an instance encoded different 3D points, an instance of an encoded 3D-point map, an instance of encoded different triangles, and an instance of an encoded triangle map are received.

Aspect 39. A method for determining three-dimensional (3D) data, the method comprising: determining a difference mesh and a polygon map based on a comparison of a first mesh with a second mesh, wherein the difference mesh includes 3D points of the second mesh that are different from 3D points of the first mesh, and wherein the polygon map indicates triangles that are similar in the second mesh and in the first mesh; encoding the difference mesh using a first encoder to generate an encoded difference mesh; encoding the polygon map using a second encoder to generate an encoded polygon map; and transmitting, to a computing device, the encoded difference mesh and the encoded triangle map.

Aspect 40. A method for determining three-dimensional (3D) data, the method comprising: decoding an encoded difference mesh to generate a difference mesh; decoding an encoded polygon map to generate a triangle map; and generating a reconstructed mesh based on a first mesh, the difference mesh, and the polygon map.

Aspect 41. A method for determining three-dimensional (3D) data, the method comprising: determining different 3D points and a 3D-point map based on a comparison of 3D points of a first mesh with 3D points of a second mesh, wherein the different 3D points are different in the second mesh than in the first mesh and wherein the 3D-point map indicates 3D points that are similar in the second mesh and in the first mesh; determining different polygons and a polygon map based on a comparison of polygons of the second mesh with polygons of the first mesh, wherein the different polygons are different in the second mesh than in the first mesh and wherein the polygon map indicates polygons that are similar in the second mesh and in the first mesh; encoding the different 3D points to generate an encoded different 3D points; encoding the 3D-point map using second encoder to generate an encoded 3D-point map; encoding the different polygons to generate an encoded different polygons; encoding the polygon map using second encoder to generate an encoded polygon map; and transmitting, to a computing device, the encoded different 3D points, the encoded 3D-point map, the encoded different polygons, and the encoded polygon map.

Aspect 42. A method for determining three-dimensional (3D) data, the method comprising: decoding encoded different 3D points to generate different 3D points; decoding an encoded 3D-point map to generate a 3D-point map; decoding encoded different triangles to generate different triangles; decoding an encoded triangle map to generate a triangle map; and generating a reconstructed mesh based on a first mesh, the different 3D points, the 3D-point map, the different triangles, and the triangle map.

Aspect 43. An apparatus for determining three-dimensional (3D) data, the apparatus comprising: at least one memory; and at least one processor coupled to the at least one memory and configured to: determine a difference mesh and a polygon map based on a comparison of a first mesh with a second mesh, wherein the difference mesh includes 3D points of the second mesh that are different from 3D points of the first mesh, and wherein the polygon map indicates triangles that are similar in the second mesh and in the first mesh; encode the difference mesh using a first encoder to generate an encoded difference mesh; encode the polygon map using a second encoder to generate an encoded polygon map; and cause at least one transmitter to transmit, to a computing device, the encoded difference mesh and the encoded triangle map.

Aspect 44. An apparatus for determining three-dimensional (3D) data, the apparatus comprising: at least one memory; and at least one processor coupled to the at least one memory and configured to: decode an encoded difference mesh to generate a difference mesh; decode an encoded polygon map to generate a triangle map; and generate a reconstructed mesh based on a first mesh, the difference mesh, and the polygon map.

Aspect 45. An apparatus for determining three-dimensional (3D) data, the apparatus comprising: at least one memory; and at least one processor coupled to the at least one memory and configured to: determine different 3D points and a 3D-point map based on a comparison of 3D points of a first mesh with 3D points of a second mesh, wherein the different 3D points are different in the second mesh than in the first mesh and wherein the 3D-point map indicates 3D points that are similar in the second mesh and in the first mesh; determine different polygons and a polygon map based on a comparison of polygons of the second mesh with polygons of the first mesh, wherein the different polygons are different in the second mesh than in the first mesh and wherein the polygon map indicates polygons that are similar in the second mesh and in the first mesh; encode the different 3D points to generate an encoded different 3D points; encoding the 3D-point map using second encoder to generate an encoded 3D-point map; encode the different polygons to generate an encoded different polygons; encode the polygon map using second encoder to generate an encoded polygon map; and cause at least one transmitter to transmit, to a computing device, the encoded different 3D points, the encoded 3D-point map, the encoded different polygons, and the encoded polygon map.

Aspect 46. An apparatus for determining three-dimensional (3D) data, the apparatus comprising: at least one memory; and at least one processor coupled to the at least one memory and configured to: decode encoded different 3D points to generate different 3D points; decode an encoded 3D-point map to generate a 3D-point map; decode encoded different triangles to generate different triangles; decode an encoded triangle map to generate a triangle map; and generate a reconstructed mesh based on a first mesh, the different 3D points, the 3D-point map, the different triangles, and the triangle map.

Aspect 47. An apparatus for determining three-dimensional (3D) data, the apparatus comprising at least one memory; and at least one processor coupled to the at least one memory and configured to operations according to any of aspects 1 to 40.

Aspect 48. A non-transitory computer-readable storage medium having stored thereon instructions that, when executed by at least one processor, cause the at least one processor to perform operations according to any of aspects 1 to 40.

Aspect 49. An apparatus for providing virtual content for display, the apparatus comprising one or more means for perform operations according to any of aspects 1 to 40.

What is claimed is:

1. An apparatus for determining three-dimensional (3D) data, the apparatus comprising:
at least one memory; and
at least one processor coupled to the at least one memory and configured to:
determine a difference mesh and a polygon map based on a comparison of a first mesh with a second mesh, wherein the difference mesh includes 3D points of the second mesh that are different from 3D points of the first mesh, and wherein the polygon map indicates polygons that are similar in the second mesh and in the first mesh;
encode the difference mesh using a first encoder to generate an encoded difference mesh;
encode the polygon map using a second encoder to generate an encoded polygon map; and
transmit, to a computing device, the encoded difference mesh and the encoded polygon map.

2. The apparatus of claim 1, wherein the at least one processor is configured to:
receive, from the computing device, virtual content based on a reconstructed mesh, wherein the reconstructed mesh is based on an instance of the first mesh, the difference mesh, and the polygon map; and
display the virtual content.

3. The apparatus of claim 1, wherein the at least one processor is configured to:
decode the encoded difference mesh using a first decoder;
generate a reconstructed mesh based on the first mesh, the decoded difference mesh, and the polygon map; and
store the reconstructed mesh for use as an instance of a first mesh when an instance of a second mesh is obtained.

4. The apparatus of claim 3, wherein, to generate the reconstructed mesh, the at least one processor is configured to: add polygons of the first mesh to the decoded difference mesh based on the polygon map.

5. The apparatus of claim 4, wherein the at least one processor is configured to, when adding polygons of the first mesh to the decoded difference mesh, adjust 3D points of the polygons of the first mesh to correspond to corresponding points of the decoded difference mesh.

6. The apparatus of claim 1, wherein the difference mesh comprises 3D coordinates of the 3D points of the second mesh that are not in the first mesh.

7. The apparatus of claim 1, wherein the difference mesh comprises a list of polygons of the second mesh that are not in the first mesh, and each vertex of a polygon of the list of polygons comprises a 3D coordinate.

8. The apparatus of claim 1, wherein the polygon map comprises a map of polygons that are in the second mesh and in the first mesh.

9. The apparatus of claim 1, wherein the first encoder comprises a mesh-compression encoder and wherein the second encoder comprises a lossless encoder.

10. The apparatus of claim 1, wherein, to determine the difference mesh and the polygon map, the at least one processor is configured to:
compare 3D points of polygons of the second mesh with 3D points of the first mesh to identify matching points;
compare polygons of the first mesh with the matching points to identify matching polygons;
store the matching polygons in the polygon map; and
store non-matching polygons and 3D coordinates of vertices of the non-matching polygons in the difference mesh.

11. The apparatus of claim 10, wherein the at least one processor is configured to organize 3D points of the first mesh prior to comparing the 3D points of the polygons of the second mesh with the 3D points of the first mesh.

12. The apparatus of claim 10, wherein, to compare the 3D points of the polygons of the second mesh with 3D points of the first mesh, the at least one processor is configured to compare the 3D points of the polygons of the second mesh with a subset of the 3D points of the first mesh based on an indication that the subset of the 3D points of the first mesh included at least one 3D point that changed between the second mesh and the first mesh.

13. The apparatus of claim 12, wherein the at least one processor is configured to:
divide the first mesh into a plurality of sub-meshes; and
determine whether at least one 3D point within each sub-mesh of the plurality of sub-meshes changed between the second mesh and the first mesh.

14. The apparatus of claim 1, wherein the at least one processor is configured to at least one of:
remove isolated 3D points from the second mesh;
remove degenerate polygons from the second mesh;
remove duplicate 3D points from the second mesh; or
remove duplicate polygons from the second mesh.

15. The apparatus of claim 1, wherein the at least one processor is configured to:
determine, based on a distortion target metric, a search radius to use when comparing 3D points of second mesh with 3D points of the first mesh; and
determine, based on the distortion target metric, a quantization parameter for the first encoder to use when encoding the difference mesh.

16. An apparatus for determining three-dimensional (3D) data, the apparatus comprising:
at least one memory; and
at least one processor coupled to the at least one memory and configured to:
decode an encoded difference mesh to generate a difference mesh;
decode an encoded polygon map to generate a polygon map; and
generate a reconstructed mesh based on a first mesh, the difference mesh, and the polygon map.

17. The apparatus of claim 16, wherein the at least one processor is configured to:
generate virtual content based on the reconstructed mesh; and
transmit the virtual content to an extended-reality device.

18. The apparatus of claim 16, wherein, to generate the reconstructed mesh, the at least one processor is configured to: add polygons of the first mesh to the decoded difference mesh based on the polygon map.

19. The apparatus of claim 18, wherein the at least one processor is configured to, when adding polygons of the first mesh to the decoded difference mesh, adjust 3D points of the polygons of the first mesh to correspond to corresponding points of the decoded difference mesh.

20. The apparatus of claim 16, further comprising obtaining the encoded difference mesh and the encoded polygon map from an extended-reality device.
